(19) United States
(12) Patent Application Publication
(10) Pub. No.: US 2024/0083123 A1
(43) Pub. Date: Mar. 14, 2024

(54) REINFORCE CARBON FIBER STRUCTURES AND MANUFACTURING PROCESSES

(71) Applicants: Alex Jacome, Knoxville, TN (US); Greg Lemond, Knoxville, TN (US); Lemond Bicycles, Inc., Knoxville, TN (US)

(72) Inventors: Alex Jacome, Knoxville, TN (US); Greg Lemond, Knoxville, TN (US)

(21) Appl. No.: 18/551,348

(22) PCT Filed: Mar. 21, 2022
(86) PCT No.: PCT/US2022/021154

§ 371 Date: Sep. 19, 2023

Related U.S. Application Data
(60) Provisional application No. 63/163,729, filed on Mar. 19, 2021.
(60) Provisional application No. 63/233,654, filed on Aug. 16, 2021.
(60) Provisional application No. 63/315,002, filed on Feb. 28, 2022.

(51) Int. Cl. B29C 70/70

(52) U.S. Cl. CPC B29C 70/70; B29L 2031/3091

(57) ABSTRACT

Processes, systems, and methods described herein can be used for manufacturing reinforced carbon fiber structures. For example, processes can include forming a plurality of foam substructures. The foam substructures can be made of heat expanding foam that further expands when heated to a first threshold temperature. Processes can also include positioning carbon fiber on at least a portion of surfaces of the foam substructures, assembling the plurality of foam substructures with the carbon fiber into a superstructure, wrapping an outer surface of the superstructure with additional carbon fiber to form a wrapped superstructure, and curing the wrapped superstructure within a mold to form a reinforced carbon fiber structure. The reinforced carbon fiber structures can include internal truss structures within the foam. The reinforced carbon fiber structures can be used to form reinforced carbon fiber bicycle frame components.

### RELATED APPLICATIONS

This application is related to U.S. Provisional Application No. 63/163,729, filed Mar. 19, 2021, U.S. Provisional Application No. 63/233,654, filed Aug. 16, 2021, and U.S. Provisional Application No. 63/315,002, filed Feb. 28, 2022.

### TECHNICAL FIELD

This document generally describes reinforced carbon fiber structures, such as consumer products (e.g., sporting equipment) and other components (e.g., airplane components, automotive components), and manufacturing processes to form such reinforced carbon fiber structures.

### BACKGROUND

Carbon fiber materials have been used to produce consumer products and other components because of their advantageous properties, including high stiffness, high tensile strength, low weight, high chemical resistance, high temperature tolerance and low thermal expansion. For example, due to these properties, carbon fiber has frequently been used in aerospace, civil engineering, military, and motorsports, along with other competition sports. Carbon fiber materials often include a combination of carbon fibers (i.e., fiber strands of carbon atoms) with other materials to form a composite that, when permeated with a resin or fluid matrix and cured, can form a carbon-fiber-reinforced polymer (referred to as “carbon fiber”) that has a high strength-to-weight ratio. However, such carbon fiber, while being strong and rigid, can be somewhat brittle and can be susceptible to breaking, cracking, or other structural failures in the event that a sufficient force is applied to the carbon fiber structure. For example, carbon fiber structures can handle significant stress in certain directions, but impact from a direction in which fibers of the structure are not optimized can cause the carbon fiber to crack, fracture, or break. Once carbon fiber fractures, the carbon fiber lose its structural integrity and may be prone to further fracture.

### SUMMARY

The document generally describes reinforced carbon fiber structures and processes for making such structures through the use of heat-expanding foam, such as double expanding foam that is capable of undergoing two separate heat expansion events when different levels of heat are applied (e.g., first expansion when heated to a first target temperature and then a second expansion when heated to a second target temperature). The disclosed carbon fiber structures can include one or more reinforcements to provide additional strength and structural integrity to the carbon fiber structures, such as through the use of foam expanded to fill internal cavities inside the carbon fiber structures to provide a “sandwich panel” type reinforcement, carbon fiber trusses and sub-structures that extend between and reinforce carbon fiber surfaces, carbon fiber components integrated within the carbon fiber surfaces and structures to provide mating surfaces for additional components, and/or other reinforcement structures. The disclosed reinforced carbon fiber structures can be stronger than traditional carbon fiber structures while adding minimal extra weight, if any (and in some instances permitting for the carbon fiber structures to be lighter), and can be manufactured in a manner that permits for more complex carbon fiber structures to be produced.

For example, traditional techniques for making carbon fiber structures have involved using positive air pressure (i.e., inflated airbag) or negative air pressure (i.e., sealed within vacuum bag) to maintain carbon fiber sheets in position within a form or mold that is then heated for a period of time so that take on and retain the shape defined by the form or mold when removed. However, such techniques leave internal cavities within the resulting structure that, depending on the size and shape of the internal cavity, can be structurally weak, particular to forces that are transverse or otherwise orthogonal to the direction of the grain of the carbon fiber. To mitigate such weaknesses, additional layers of carbon fiber have been added to the structure to increase the thickness of the carbon fiber layer that defines the internal cavity, but this can add extra weight while, at the same point, only providing marginal improvement in the strength of the structure.

The disclosed innovation can resolve these issues (and/or others, as described in this document) by providing internal reinforcements within areas of carbon fiber structures that would otherwise be internal cavities, which can strengthen the resulting carbon fiber structure with minimal impact on the resulting weight, if not a reduced aggregate weight. For example, carbon fiber truss structures can be positioned within internal cavities to strengthen the resulting carbon fiber structure with minimal additional weight. Carbon fiber structures with internal trusses can be stronger overall (i.e., in both directions aligned with the fibers and directions orthogonal to the fibers) and, in many instances, can be manufactured without multiple outer layers of carbon fiber that are traditionally used with carbon fiber structures with internal cavities, which can result in a lighter and stronger carbon fiber structure.

The disclosed manufacturing processes can use heat-expanding foam to provide for the precise placement of internal carbon fiber truss structures at specific and desired locations inside of carbon fiber structures, and with specific configurations and arrangements, to reliably and predictably achieve the desired reinforcement structures. For instance, in one example of several manufacturing processes described in this document, double expanding foam can undergo a first expansion (heated to first threshold temperature) within a mold to achieve a near net shape (approximate shape of the resulting carbon fiber structure). The near net shape can then be cut into one or more segments (e.g., longitudinally cut, laterally cut) that are then individually wrapped with carbon fiber. The wrapped individual segments can then be reassembled into the near net shape and the group of wrapped segments can, collectively, be wrapped with additional carbon fiber. The wrapped foam can then be placed back in the mold (or in a different mold of a slightly larger dimension) and expanded a second time by applying heat to a second threshold temperature, which can create a resulting reinforced carbon fiber structure with internal trusses that are provided and specifically located by the cured carbon fiber wrapped around the internal segments. Any of a variety of different processes are also possible, as described throughout this document, for example, instead of cutting a near net shape into individual segments, individual foam segments can be formed in separate, individual molds that are configured to each form a portion of a collective near net shape. In another example, pieces of carbon fiber can be placed between foam segments (instead of being wrapped), additional pieces and/or layers of carbon fiber can be applied to certain subsurfaces of individual foam segments to provide for specific, enhanced reinforcement, and/or other selective application of carbon fiber between individual foam segments can be performed. Additionally, any of a variety of complex internal carbon fiber truss/reinforcement structures can be achieved by forming foam segments into different shapes and configurations, applying carbon fiber to portions of those shapes, and then combining those shapes into a collective structure that is heated and cured to form a reinforced carbon fiber structure.

Foam can remain inside of the resulting carbon fiber structures with trusses, and can provide additional reinforcement to the carbon fiber structure (in addition to the truss structures). For example, the expanded foam inside the carbon fiber structure can make the resulting carbon fiber structure into a sandwich panel type structure in which the foam receives and translates forces from one surface to one or more other surfaces of the carbon fiber structure, thereby reinforcing the surface to which the forces are being applied. The foam remaining within the resulting carbon fiber structures can provide additional benefits, as well, such as dampening vibrations through the carbon fiber structure, reducing the accumulation and/or presence of debris or dirt within the carbon fiber structure, and/or other benefits.

The disclosed innovation can permit for a variety of complex carbon fiber reinforcements to be formed within enclosed carbon fiber structures that, using traditional carbon fiber production techniques, have not been practicable or otherwise possible to reliably and consistently form. For example, a collection of internal and interconnected trusses can be formed using the disclosed innovation to provide for reinforcement against multiple different forces applied to the structure (e.g., different directional forces, different types of forces, such as torsional forces, tensile forces, compressive forces, etc.). In another example, lattices of carbon fiber trusses can be constructed and specifically positioned within an enclosed carbon fiber structure using the disclosed innovation to provide for reinforcement from a variety of different forces.

As described throughout this document, by using expanding foam to retain and place trusses in specific arrangements within a carbon fiber structure, structures can be engineered to provide reinforcement in particular ways and to accommodate for specific demands on a particular structure (e.g., greater lateral reinforcement over longitudinal reinforcement due to expected loads and strains on structure), which can help ensure that structures do not crack, fracture, or break. For example, carbon fiber bicycle frames can fracture if force is applied to the frame in a direction where the carbon fiber is not optimized. Such a fracture can compromise performance and safety of the bicycle. The disclosed innovation, therefore, can provide for wrapping carbon fiber structures with dual expansion foam, or sandwiching carbon fiber layers, which can strengthen and reinforce the carbon fiber to reduce risk of fracturing. The disclosed innovation can apply to not only carbon fiber bicycles and their component parts (e.g., frame, fork), but to any other type of frame, tubes, or structures using similar materials and/or techniques of construction whether used in sporting equipment or in other industries (e.g., automotive parts, aviation).

As an illustrative example, a round foam mandrel can be cut in half longitudinally and then each half can be wrapped with carbon fiber. The wrapped halves can then be assembled back into the original mandrel shape (e.g., cut surfaces of each half can be mated to each other) and one or more additional layers of carbon fiber can be wrapped around assembled halves. The combined and wrapped mandrel can then be heated and cured within a mold, which can cause the foam to expand and apply outward force so that the outer carbon fiber layer takes on and retains the form of the mold. Similarly, the expansion of the foam during this heating and curing process can retain the internal layers of carbon fiber positioned in the middle of the structure—creating a carbon fiber truss running longitudinally and providing reinforcement along the length of the resulting carbon fiber structure. As another example, the round foam mandrel could instead be cut longitudinally into quarters, each of the quarters could be wrapped individually, and then combined together with an additional carbon fiber wrap. The mandrel could then be cured and the internal carbon fiber wraps can form a cross-sectional ‘x’ configuration of trusses running the length of the structure, which can provide for increased strength and reduce a risk of failure or fracturing of the tube.

Any of a variety of types of materials and tools can be used to create reinforced carbon fiber structures, as described throughout this document. Dual expanding foam in powder, pellet, thin sheet, or other forms can be placed within a mold (also referred to as a “tool”) that is heated to expand the foam. Heat can be applied to the unexpanded foam material by applying heat to the tool, which can be made of heat conductive materials (e.g., metals, aluminum, steel, composites). Such heating can be applied, for example, by placing the tool in an oven or autoclave, using heating inserts (e.g., heating rods), using heating plates, through induction heating, and/or other heating techniques. The resulting foam mandrel can then be cut it into sections to achieve desired reinforcement and/or other properties (e.g., strength, stiffness) for the structure, and then the sections can be wrapped with carbon fiber. Any of a variety of carbon fiber and/or fabrics can be used, such as pre-preg carbon fiber fabric (“pre-preg” refers to carbon fiber pre-impregnated with a resin system, such as an epoxy, that includes a curing agent), pre-preg carbon fiber tape, pre-preg woven carbon fiber fabric, carbon fiber sheet molding compound (“SMC”) mats, non-pre-preg carbon fiber fabrics, tapes, and sheets (e.g., carbon fiber materials to which resin and curing agent is to be applied), and/or other carbon fiber materials. The wrapped carbon fiber sections can be combined and wrapped again with another layer of carbon fiber material (e.g., pre-preg carbon fiber fabric) around the individually wrapped sections, and placed into a mold that is then heated (i.e., heated in oven, heating inserts, induction heating the tool, etc.), which activates the chemical reaction of the resin while activating the second expansion of the foam. The foam expands outwards, generating pressure in all directions outwards, which consolidates all of the smaller foam pieces together and locks in the structure of the carbon fiber wrapped foam as part of the curing process.

Particular embodiments described herein include a process for manufacturing reinforced carbon fiber structures. The process can include forming a plurality of foam substructures, wherein the foam substructures are made of heat expanding foam that is configured to further expand when heated to at least a first threshold temperature, positioning carbon fiber on at least a portion of surfaces of the foam substructures, assembling the plurality of foam substructures with the carbon fiber into a superstructure, wrapping an outer surface of the superstructure with additional carbon fiber to form a wrapped superstructure, and heating the wrapped superstructure to at least the first threshold temperature within a first mold to form a reinforced carbon fiber structure. Heating the wrapped superstructure can cause the foam substructures to further expand so that the additional carbon fiber can adopt and retain a shape of the first mold.

In some implementations, embodiments described herein can include any one or more of the following optional features. Forming the plurality of foam substructures can include cutting an initial foam structure into at least a portion of the plurality of foam substructures. Forming the plurality of foam substructures further can include heating unexpanded foam material to form the initial foam structure. The unexpanded foam material can undergo multiple heat-based expansions when heated to different threshold temperatures, the unexpanded foam material can be heated to a second threshold temperature to form the initial foam structure, and the second threshold temperature can be different from the first threshold temperature. The second threshold temperature can be lower than the first threshold temperature. The unexpanded foam material can include double expanding foam material. The unexpanded foam material can be heated within the first mold to form the initial foam structure, and the initial foam structure can have a near net shape of the reinforced carbon fiber structure.

In the embodiments described herein, the initial foam structure can have less volume than the reinforced carbon fiber structure. The initial foam structure can be formed in the first mold without the presence of any carbon fiber materials. The initial foam structure can be formed in the first mold with one or more carbon fiber substructures being included in the first mold. The one or more carbon fiber substructures can include rigid carbon fiber structures that can retain a three-dimensional shape within first mold as the unexpanded foam material expands around and throughout the three-dimensional shape during expansion of the unexpanded foam material. The one or more carbon fiber substructures can include a lattice structure made of carbon fiber.

In some implementations, the unexpanded foam material can be heated within a second mold to form the initial foam structure, the second mold can be different from and can define a smaller volume structure than the first mold, and the initial foam structure can have a near net shape of the reinforced carbon fiber structure.

In some implementations, forming the plurality of foam substructures can include separately forming at least a portion of the plurality of foam substructures from one or more second molds that are different from the first mold. Separately forming the plurality of foam substructures further can include heating unexpanded foam material in the one or more second molds to form the at least a portion of the plurality of foam substructures. The unexpanded foam material can undergo multiple heat-based expansions when heated to different threshold temperatures, the unexpanded foam material can be heated to a second threshold temperature to form the at least a portion of the plurality of foam substructures, and the second threshold temperature can be different from the first threshold temperature. The second threshold temperature can be lower than the first threshold temperature. The unexpanded foam material can include double expanding foam material.

The at least a portion of the plurality of foam substructures can be formed in the one or more second molds without the presence of any carbon fiber materials. The at least a portion of the plurality of foam substructures can be formed in the one or more second molds with one or more carbon fiber substructures being included in the one or more second molds. The one or more carbon fiber substructures can include rigid carbon fiber structures that can retain a three-dimensional shape within one or more second molds as the unexpanded foam material expands around and throughout the three-dimensional shape during expansion of the unexpanded foam material. The one or more carbon fiber substructures can include a lattice structure made of carbon fiber.

The embodiments described herein can also include positioning the carbon fiber on at least the portion of the foam substructures, which can include wrapping one or more of the foam substructures with the carbon fiber. Positioning the carbon fiber on at least a portion of the foam substructures can also include affixing the carbon fiber to the portion of the surfaces of the foam substructures. The carbon fiber can be affixed to surfaces of the foam substructures so that, when the foam substructures are assembled into the superstructure, the carbon fiber extends through the superstructure from a first outer surface of the superstructure to a second outer surface of the superstructure. The first outer surface of the superstructure can be an opposing surface of the second outer surface of the superstructure.

Moreover, the plurality of foam substructures can each include one or more mating surfaces that can be contoured to mate with one or more surfaces of others of the plurality of foam substructures, and assembling the plurality of foam substructures into the superstructure can include pairing mating surfaces of the plurality of foam substructures with the carbon fiber. The carbon fiber can be retained between the foam substructures in a particular arrangement, and the particular arrangement of the carbon fiber can be retained in and can provide, at least in part, reinforcement for the reinforced carbon fiber structure. The foam substructures that expanded to form the reinforced carbon fiber structure can be retained within the reinforced carbon fiber structure. The foam substructures that expanded to form the reinforced carbon fiber structure can provide additional reinforcement for the reinforced carbon fiber structure.

The embodiments described herein can also include positioning, as part of the assembling of the foam substructures into the superstructure, one or more additional structures within the superstructure. The one or more additional structures can include a tube that defines a channel extending through, at least a part, of the superstructure. The tube can include a carbon fiber tube. The carbon fiber tube can be rigid and preconfigured before being placed into the superstructure. The carbon fiber tube can be formed by wrapping carbon fiber around a removable media that can be removed from the reinforced carbon fiber structure. The one or more additional structures can include a wire or a cable.

Such embodiments can also include wherein at least a portion of the foam substructures include one or more additional structures. The one or more additional structures can also include a tube that defines a channel extending through, at least a part, of the foam substructures. The tube can include a carbon fiber tube. The carbon fiber tube can be rigid and preconfigured before being placed into the foam substructures. The carbon fiber tube can be formed by wrapping carbon fiber around a removable media that can be removed from the reinforced carbon fiber structure.

Moreover, the reinforced carbon fiber structure can include at least a portion of a sporting equipment product. The sporting equipment product can include a bike and the reinforced carbon fiber structure can include a component of the bike. The reinforced carbon fiber structure can include a component of an automobile, an airplane, or another motorized vehicle.

Embodiments described herein can also include a process for manufacturing reinforced carbon fiber structures to include one or more embedded structures. The process can include forming a foam structure that includes an embedded structure that extends, at least partially, though the foam structure, wherein the foam structure is made of heat expanding foam that is configured to further expand when heated to at least a first threshold temperature, wrapping an outer surface of the foam structure with carbon fiber to form a wrapped foam structure, and heating the wrapped foam structure to at least the first threshold temperature within a first mold to form a reinforced carbon fiber structure. Heating the wrapped foam structure can cause the foam structure to further expand so that the carbon fiber adopts and retains a shape of the first mold.

Such embodiments described herein can include one or more of the following features. For example, forming the foam structure can include positioning the embedded structure in a particular arrangement in three-dimensional space using one or more positioning structures, positioning unexpanded foam material around the embedded structure and the one or more positioning structures, and heating the unexpanded foam material to form the foam structure. The unexpanded foam material can undergo multiple heat-based expansions when heated to different threshold temperatures, the unexpanded foam material can be heated to a second threshold temperature to form the initial foam structure, and the second threshold temperature can be different from the first threshold temperature. The second threshold temperature can be lower than the first threshold temperature. The unexpanded foam material can include double expanding foam material.

Moreover, the embedded structure can be positioned in the particular arrangement in the first mold, the unexpanded foam material can be positioned around the embedded structure and the one or more positioning structures in the first mold, and the unexpanded foam material can be heated within the first mold to form the foam structure. The foam structure can have a near net shape of the reinforced carbon fiber structure. The foam structure can have less volume than the reinforced carbon fiber structure. The embedded structure can be positioned in the particular arrangement in a second mold, wherein the second mold can be different from and defines a smaller volume than the first mold, the unexpanded foam material can be positioned around the embedded structure and the one or more positioning structures in the second mold, and the unexpanded foam material can be heated within the second mold to form the foam structure. The foam structure can have a near net shape of the reinforced carbon fiber structure.

In some implementations, the one or more positioning structures can include one or more stands that can retain the embedded structure in the particular arrangement during expansion of the unexpanded foam material. The particular arrangement can include the embedded structure being spaced apart from one or more outer surfaces of the foam structure. The one or more stands can be made of carbon fiber.

The embedded structure can include a tube that defines a channel extending through, at least a part, of the foam structure. The tube can include a carbon fiber tube. The carbon fiber tube can be rigid and preconfigured before being placed into the foam structures. The carbon fiber tube can be formed by wrapping carbon fiber around a removable media that can be removed from the foam structure.

In some implementations, the reinforced carbon fiber structure can include at least a portion of a sporting equipment product. The sporting equipment product can include a bike and the reinforced carbon fiber structure can include a component of the bike. In some implementations, the reinforced carbon fiber structure can include a component of an automobile, an airplane, or another motorized vehicle.

Embodiments described herein can also include a reinforced carbon fiber structure providing additional reinforcement against external forces. The structure can include an outer carbon fiber housing with one or more carbon fiber walls that enclose an interior volume, the carbon fiber walls including outer surfaces and inner surfaces that define the interior volume, one or more carbon fiber trusses that are positioned within the interior volume, wherein each of the carbon fiber trusses is connected to one or more of the interior surfaces of the carbon fiber walls and extend through at least a portion of the interior volume, and one or more foam segments that fill the interior volume and that are positioned between the inner surfaces of the carbon fiber walls and the carbon fiber trusses.

The embodiments described herein can include one or more of the following features. For example, the foam segments can be made of foam that can undergo multiple heat-based expansions when heated to different threshold temperatures. The foam can be double expanding foam. The outer carbon fiber housing can have a longitudinal dimension that can be greater than a lateral dimension, and at least a portion of the carbon fiber trusses can include one or more lateral carbon fiber trusses that extend between the interior surfaces along the lateral dimension. The one or more lateral carbon fiber trusses can include a plurality of lateral carbon fiber trusses that can be spaced apart along the longitudinal dimension.

As another example, the outer carbon fiber housing can have a longitudinal dimension that can be greater than a lateral dimension, and at least a portion of the carbon fiber trusses can include one or more longitudinal carbon fiber trusses that can extend between the interior surfaces along the longitudinal dimension. The one or more longitudinal carbon fiber trusses can include a plurality of longitudinal carbon fiber trusses that can be spaced apart along the lateral dimension. The one or more longitudinal carbon fiber trusses can include a plurality of longitudinal carbon fiber trusses that each can connect to one or more of the interior surfaces and to one or more others of the plurality of longitudinal carbon fiber trusses. The plurality of longitudinal carbon fiber trusses can connect to each other at or near a lateral center point along the lateral dimension. As another example, the one or more longitudinal carbon fiber trusses can be formed by the foam segments each being wrapped by carbon fiber about the longitudinal dimension and the foam segments being combined within the outer carbon fiber housing.

Embodiments described herein can include a method for manufacturing reinforced carbon fiber structures having one or more embedded support structures, with the method including forming a carbon fiber support structure by curing carbon fiber within a mold; forming a foam structure that includes the carbon fiber support structure that extends, at least partially, though the foam structure, wherein the foam structure is made of heat expanding foam that is configured to further expand when heated to at least a first threshold temperature; wrapping an outer surface of the foam structure with carbon fiber wrapping to form a wrapped foam structure; and heating the wrapped foam structure to at least the first threshold temperature within a first mold to form a reinforced carbon fiber structure, wherein heating the wrapped foam structure causes the foam structure to expand so that the carbon fiber adopts and retains a shape of the first mold.

Such embodiments can optionally include one or more of the following features. The method can further include heating the foam structure to a second threshold temperature within a second mold prior to the wrapping step. The method can further include removing a portion of the foam structure covering an edge of the carbon fiber support structure to expose the edge of the carbon fiber support structure at an outer surface of the foam structure. Exposing the carbon fiber support structure can cause the carbon fiber wrapping to contact the edge of the carbon fiber support structure. The method can further include depositing a material over the exposed edge of the carbon fiber support structure prior to the wrapping step. The material can be pre-cured carbon fiber. Forming the carbon fiber support structure can further include placing pre-cured carbon material into a mold; heating the mold to a desired temperature for a predetermined amount of time; and removing the carbon material from the mold. The method can further include cutting the carbon fiber support structure to a desired length and/or size. Forming the carbon fiber support structure can further include forming one or more support trusses extending from a meeting point. Forming the foam structure can further include depositing foam about the one or more support trusses to form a substantially cylindrical structure. Forming the foam structure can further include positioning the one or more support trusses to extend longitudinally through the foam structure. The method can further include forming at least one aperture through at least one of the support trusses of the carbon fiber support structure. Forming the foam structure can further include placing foam through the at least one aperture. The method can further include inserting a conduit adjacent to the carbon fiber support structure prior to forming the foam structure, wherein the inserted conduit preserves a channel through the foam structure. The conduit can be formed from one of a carbon fiber conduit, a silicon tube, or a hard conduit of another material. The method can further include exposing a portion of foam at a first end of the reinforced carbon fiber structure, and removing foam from a second end of the reinforced carbon fiber structure to form a cavity, the exposed portion of foam and cavity enabling coupling of the reinforced carbon fiber structure with another structure.

Embodiments described herein can include a method of joining first and second reinforced carbon fiber structures. The method can include exposing a foam outer surface at a first male end of the first reinforced carbon fiber structure; providing a cavity at a first female end of the second reinforced carbon fiber structure, the cavity sized to receive the first male end of the first reinforced carbon fiber structure; inserting the first male end of the first reinforced carbon fiber structure into the first female end of the second reinforced carbon fiber structure, the exposed foam outer surface substantially enclosed within the cavity; and heating at least a joining region of the first reinforced carbon fiber structure and the second reinforced carbon fiber structure to a predetermined temperature for a predetermined period of time, the heating causing the foam outer surface at the first male end to expand within the cavity.

Such embodiments can optionally include one or more of the following features. The method can further include covering the exposed foam outer surface at the first male end in carbon fiber before the inserting step. The heating step can cause the foam outer surface at the first male end to expand, forcing the carbon fiber into contact with an internal wall of the cavity. The predetermined temperature can be sufficient to expand the foam outer surface and to cure the carbon fiber to provide a bond between the first reinforced carbon fiber structure and the second reinforced carbon fiber structure. The method can further include covering an exposed portion of a first internal support structure of the first reinforced carbon fiber structure with carbon fiber; and positioning the exposed first internal support structure adjacent to a second internal support structure of the second reinforced carbon fiber structure. The exposed first internal support structure can extend into the cavity and adjacent the second internal support structure when the first male end of the first reinforced carbon fiber structure is inserted into the first female end of the second reinforced carbon fiber structure.

Embodiments described herein can include a reinforced carbon fiber structure that includes an outer carbon fiber housing with one or more carbon fiber walls that enclose an interior volume, the carbon fiber walls including outer surfaces and inner surfaces that define the interior volume; a plurality of carbon fiber trusses positioned within the interior volume, wherein each of the carbon fiber trusses is connected to one or more of the inner surfaces of the carbon fiber walls and extend longitudinally through at least a portion of the interior volume; and one or more foam segments positioned within the interior volume between the inner surfaces of the carbon fiber walls and the carbon fiber trusses.

Such embodiments can optionally include one or more of the following features. The reinforced carbon fiber structure can further include at least one aperture formed through at least one of the plurality of carbon fiber trusses. One or more foam segments can extend through the at least one apertures. At least a portion of the outer carbon fiber housing can be substantially cylindrical. The plurality of carbon fiber trusses can be arranged such that at least two carbon fiber trusses are perpendicular to each other. A first width of a first carbon fiber truss where the first carbon fiber truss is connected to an inner surface can be greater than a second width of a second carbon fiber truss where the second carbon fiber truss is connected to the inner surface. The reinforced carbon fiber structure can include a component of an automobile, an airplane, or another motorized vehicle. The reinforced carbon fiber structure can include at least a portion of a sporting equipment product. The sporting equipment product can include a bike and the reinforced carbon fiber structure comprises a component of the bike. The component of the bike can include one of a head tube, a down tube, a top tube, a headset, a bottom bracket, a chain stay, a fork, or a steerer tube.

Embodiments described herein can include a method for manufacturing a reinforced carbon fiber bicycle frame that includes producing one or more bicycle components having an outer carbon fiber housing defining an interior volume and at least one carbon fiber truss positioned within the interior volume, wherein at least one foam segment is positioned within the interior volume between inner surfaces of the carbon fiber housing and the carbon fiber trusses; assembling the one or more bicycle components together to form the bicycle frame; and heating at least one joint between the one or more bicycle components to bond the one or more bicycle components together.

Such embodiments can optionally include one or more of the following features. Producing the one or more bicycle components can further include establishing a channel through the bicycle components by inserting a conduit adjacent to at least a portion of the at least one carbon fiber trusses to preserve a passage through the at least one foam segment. The method can further include coupling a first channel of a first component to a second channel of a second component. The method can further include routing wire or cable through the first channel and the second channel. Producing the one or more bicycle components can further include forming a substructure of carbon fiber trusses; depositing foam surrounding the substructure of carbon fiber trusses to form a foam structure; placing the foam structure into a first mold; heating the foam within the first mold to a first predetermined temperature, the heating to the first predetermined temperature causing the foam to expand to retain the shape of the first mold; removing a portion of the expanded foam to expose at least one edge of the substructure of carbon fiber trusses; wrapping the expanded foam structure in a carbon fiber wrapping, the carbon fiber wrapping in contact with the at least one edge of the substructure of carbon fiber trusses; placing the carbon fiber wrapped structure into a second mold; and heating the carbon fiber wrapped structure within the second mold to a second predetermined temperature, the heating to the second predetermined temperature causing a second expansion of the foam to force the carbon fiber wrapping to take the shape of the second mold. A first component of the one or more bicycle components can be a bicycle fork. Forming a substructure of carbon fiber trusses of the bicycle fork can include forming a substructure of carbon fiber trusses including a steerer tube substructure formed from four longitudinal trusses connected at a center point and a leg substructure formed as a first truss forming a horseshoe shape with a second truss extending perpendicularly from the first truss at a center line of the first truss on an exterior surface of the horseshoe shape, wherein the steerer tube substructure and the two leg substructures are connected at a shoulder. The steerer tube substructure and the two leg substructures can be formed as separate structures and are bonded together before the depositing step. The steerer tube substructure and the two leg substructures can be formed as a unitary structure using a mold. A first component of the one or more bicycle components can be one of a top tube, down tube, or head tube. Forming a substructure of carbon fiber trusses can include forming a substructure of carbon fiber trusses formed from two vertically oriented trusses and two horizontally oriented trusses connected at a center point. The method can further include forming at least one aperture in at least one of the two vertically oriented trusses or two horizontally oriented trusses. The method can further include forming a plurality of apertures along the length of at least one of the two vertically oriented trusses or two horizontally oriented trusses.

The disclosed innovation may provide one or more of the following advantages. For example, the disclosed innovation provides for increased strength of carbon fiber structures, such as tubes and frames. Wrapping dual expansion foam with layers of carbon fiber can increase the strength and stiffness of the resulting carbon fiber structure. Load can be distributed without adding weight to the structure. Additionally, if an outer layer of carbon fiber is fractured, the fracture may not break through the entire structure since the structure can be made up of multiple layers of carbon fiber wrapped dual expansion foam. As a result, a potential compromise to an outer layer of the structure may not diminish an integrity, strength, performance, safety, or functionality of the overall structure or layers therein. The overall structure can have greater integrity and strength, even in the face of potential fractures and cracks.

Moreover, cutting the foam shape (e.g., mandrel) into multiple pieces, rather than one contiguous shape, and then individually wrapping each piece can increase strength of the final structure since any stress or fracture to any single point can be isolated from the entire structure. Cutting the foam into more shapes or pieces where load or force is expected can make those areas of the structure stronger. This added strength can reduce a risk of fracturing any portion of the structure. Further, since the final structure can have increased strength and stiffness, fractures to any portion of the structure may not lead to failure of the entire structure. The entire structure can include differently cut shapes in different portions of the structure, based on expected loads or force. Using differently cut shapes throughout the structure can provide for optimum performance of the entire structure. Strength can be increased in a portion of the structure that can be expected to have significant force or load by increasing a number of cut pieces in that portion of the structure. Another portion of the structure, which may not experience significant load or force, can have fewer cut shapes or pieces, which can balance out any weight that the layers of carbon fiber and/or dual expansion foam may add to the final structure.

As another example, using dual expansion foam in creating mandrels or other structures can eliminate or reduce a need for using expanding bladders. The dual expansion foam can be first expanded to a near net shape of the final structure. Once expanded to the near net shape, the foam can be wrapped in plies of carbon fiber and then expanded for a second time, until the foam expands to the full shape of the final structure. This process can be easier and faster than using an expanding bladder in the process. An expanding bladder would have to be inserted into the structure such that pressure can be applied inside the structure to cause expansion of the foam therein. Dual expansion foam, on the other hand, may not require use of additional tools to expand the foam into the full shape of the final structure.

As yet another example, layering dual expansion foam with carbon fiber may add minimal to no extra weight to the overall structure. Therefore, in the example of carbon fiber bicycles, performance of the overall structure can be maintained and/or optimized. The disclosed innovation may not increase weight of the overall structure because the same amount of carbon fiber that would typically make up the structure (e.g., for a bicycle, the carbon fibers on the outside or skin of the bicycle) can now be redistributed. In other words, the same amount of carbon fiber can merely be distributed throughout different layers of an internal structure of the overall structure (e.g., inside the bicycle frame).

As another example, using dual expansion foam to create the overall structure can reduce vibrations and stabilize the structure. Alternative carbon fiber structures can be hollow inside, which may make the structure less stable. In the example of a bicycle frame, vibrations can be felt through the frame as well as any bumps in a road or other uneven surface. In contrast, the use of dual expanding foam may have inconsequential weight and act as a cushion for absorbing impacts that would otherwise destabilize the structure. Because the dual expanding foam can be expanded to be flush against layers of carbon fiber making up the overall structure, vibrations, bumps, or other external conditions can be absorbed and not felt by the bicycle rider. The absorption of external conditions can also make the bicycle stronger, which can deter or reduce risk of potential fractures or other failures of the overall bicycle frame.

Embodiments described herein can include a method of forming a reinforced carbon fiber structure by forming a first structure from an expandable foam, separating the first structure into multiple foam substructures, wrapping each of the multiple foam substructures in a carbon fiber material, positioning the multiple wrapped foam substructures relative to one another as in the first structure, and curing the multiple wrapped foam substructures together. Such embodiments can optionally or additionally include forming the first structure from the expandable foam by placing the expandable foam into a mold and heating the expandable foam within the mold. The method can further include internal trusses formed at locations where the wrapped carbon fiber material of first and second substructures are in contact.

In some implementations, the reinforced carbon fiber structure is a component of a bicycle. For example, the component can be one of a steerer tube, a top tube, a downtube, a headtube, a fork, a bottom bracket, a seatpost, and a chain stay, or other components of a bicycle.

In some implementations, the component is a bottom bracket incorporating a helically shaped truss structure. In some implementations, the first foam structure is a bottom bracket structure, the bottom bracket structure is separated into at least two foam structures, and the helically shaped truss structure is incorporated horizontally through the two foam structures prior to curing to form a truss structure. In some implementations, the bottom bracket structure is separated vertically into two foam structures, and the truss structure is a vertical truss structure. In some implementations, the bottom bracket structure is separated into four foam structures by quartering the structure vertically and horizontally, and the truss structure is a vertical truss structure and a horizontal truss structure.

In some implementations, the component is a downtube. In some implementations, the first foam structure is a downtube structure, the downtube structure is separated into at least two foam structures prior to curing to form a truss structure. In some implementations, the downtube structure is separated vertically into two foam structures, and the truss structure is a vertical truss structure. In some implementations, the downtube structure is separated horizontally into two foam structures, and the truss structure is a horizontal truss structure. In some implementations, the downtube structure incorporates a helically shaped truss structure. In some implementations, the downtube structure is separated into four foam structures by quartering the structure vertically and horizontally, and the truss structure is a vertical truss structure and a horizontal truss structure. In some implementations, the downtube structure is vertically separated into three foam structures, and the truss structure is a first vertical truss structure and a second vertical truss structure. In some implementations, the downtube structure is separated into four foam structures by diagonally separating the downtube structure into quarters, and the truss structure is a first diagonal truss structure and a second diagonal truss structure.

In some implementations, the component is a fork including a steerer tube and two blades. In some implementations, the first foam structure is a fork structure, the fork structure is separated into at least two foam structures prior to curing to form a truss structure. In some implementations, the fork structure is separated into first and second blade structures and a steerer tube structure, the steerer tube structure being vertically separated into four foam structures, and the truss structure of the steerer tube is a first vertical truss structure and a second vertical truss structure. In some implementations, the first vertical truss structure and the second vertical truss structure intersect at a line through a center of the steerer tube structure, and the steerer tube structure includes a coupling cavity formed at a first end of the first vertical truss structure and the second vertical truss structure.

In some implementations, the component is a headtube. In some implementations, the first foam structure is a headtube structure, the headtube structure is separated into at least two foam structures prior to curing to form a truss structure. In some implementations, the headtube is vertically separated into two foam structures, and the truss structure is a vertical truss structure. In some implementations, the headtube is separated into four foam structures by quartering the structure vertically and horizontally, and the truss structure is a vertical truss structure and a horizontal truss structure. In some implementations, the headtube incorporates a helically shaped truss structure.

The method can include assembling one or more of the bottom bracket, downtube, fork, and headtube, as well as additional bicycle components formed by similar processes to have internal truss structures, into a bicycle.

The details of one or more implementations are set forth in the accompanying drawings and the description below. Other features and advantages will be apparent from the description and drawings, and from the claims.

### BRIEF DESCRIPTION OF THE DRAWINGS

FIG. 1A is an example tube having longitudinal trusses that is made using techniques described herein.

FIG. 1B depicts foam expansion in the tube of FIG. 1A.

FIGS. 1C-D depict an example foam mandrel with lateral trusses.

FIG. 1E depicts expansion of the foam mandrel of FIGS. 1C-D.

FIG. 2A-C are conceptual diagrams of making a mandrel using dual expansion foam.

FIG. 2D is a conceptual diagram of making a mandrel with a conduit embedded therein using dual expansion foam.

FIG. 2E depicts an example view of a reinforced carbon fiber structure formed within a mold using dual expanding foam segments individually wrapped in carbon fiber and combined with an additional carbon fiber wrap.

FIG. 2F depicts example views of a reinforced carbon fiber structure formed using dual expanding foam.

FIGS. 3A-B depict example fork mandrels made up of different dual expansion foam segments.

FIG. 4A depicts a mandrel having lateral dual expansion foam segments.

FIG. 4B depicts a mandrel having longitudinal dual expansion foam segments.

FIG. 4C depicts example portions of a mandrel having differently shaped dual expansion foam segments.

FIGS. 5A-C depict expansion of foam segments when an airbladder is inserted into a portion of a mandrel.

FIG. 6A depicts components used in creating a mandrel having lateral trusses.

FIG. 6B depicts components used in creating a mandrel having longitudinal trusses.

FIGS. 7A-D are conceptual diagrams of creating a mandrel with a formed dual expansion foam mandrel.

FIGS. 8A-B are example cross sectional views of mandrels having different truss structures.

FIG. 8C depicts components used in creating a tubular mandrel with dual expansion foam.

FIG. 8D depicts example cross sectional views of mandrels having different longitudinal truss structures.

FIG. 8E is a conceptual diagram of creating a mandrel by removing dual expansion foam therein.

FIG. 8F depicts an example cross sectional view of a mandrel having a truss structure reinforced with layers of dual expansion foam.

FIG. 8G depicts another example cross sectional view of a mandrel having a truss structure reinforced with dual expansion foam.

FIG. 9 depicts example mandrel pieces having different dual expansion foam segments.

FIG. 10A is an example unitary mandrel having different dual expansion foam segments.

FIG. 10B is an example mandrel separated into pieces having different dual expansion foam segments.

FIGS. 11A-B is a flowchart of a process for building a mandrel with dual expansion foam segments.

FIGS. 12A-B is a flowchart of another process for building a mandrel with dual expansion foam segments.

FIGS. 13A-C is a flowchart of another process for building a mandrel with dual expansion foam segments.

FIG. 14A is an example mold for producing carbon fiber support structures.

FIG. 14B is an example carbon fiber support structure produced by the mold of FIG. 14A.

FIG. 14C is an example internally supported carbon fiber object produced using the carbon fiber support structure of FIG. 14B.

FIG. 15 is a flowchart of a process for producing a supported carbon-fiber objects.

FIG. 16 depicts the stages of a process for production of an internally supported carbon fiber bicycle fork.

FIG. 17A depicts a side-angled view of the stages of production of an example internally supported carbon fiber bicycle fork.

FIG. 17B depicts a side-view of stage of production of an example internally supported carbon fiber bicycle fork.

FIG. 18 depicts an example method of joining internally supported carbon fiber structures.

FIG. 19 depicts an example method of joining tubular internally supported carbon fiber structures.

FIG. 20A is a view of an internal carbon fiber structure for use as a bicycle bottom bracket shell.

FIG. 20B is a view of the internal carbon fiber structure of FIG. 20A with dual expansion foam segments providing the shape of the bicycle bottom bracket shell.

FIG. 21A depicts an angled top-view of an example carbon fiber support structure providing an internal support for a carbon fiber bicycle frame.

FIG. 21B depicts side-view of the example carbon fiber support structure providing an internal support for a carbon fiber bicycle frame of FIG. 21A.

FIG. 22A depicts an exploded view of carbon fiber support structure components of a road bicycle and additional bicycle components.

FIG. 22B depicts an exploded view of the carbon fiber support structure components of FIG. 22A with dual expansion foam covering and additional bicycle components.

FIG. 22C depicts an exploded view of the dual expansion foam covered carbon fiber support structure of FIG. 22B coated with a carbon fiber wrapping and additional bike components.

FIG. 23 shows example cross sectional views of carbon fiber support structures having different truss structures for use in various bicycle components.

FIG. 24 shows a perspective view of a bicycle fork including a threaded component in the steerer tube.

FIG. 25 shows a front view of a bicycle fork.

FIG. 26 shows an example of a bicycle frame including multiple components.

FIG. 27A shows a perspective view of example water bottle mounting boss components formed in an example bicycle frame tube.

FIG. 27B shows a cross-sectional view of example water bottle mounting boss components formed in an example bicycle frame tube.

FIG. 28A, 28B, 28C, 28D, 28E show views of an example bottom bracket with lattice construction.

FIGS. 29A, 29B, and 29C show views of an example bottom bracket component including the example bottom bracket of FIG. 28.

FIGS. 30A, 3B, and 30C show views of an example bottom bracket component including the bottom bracket of FIG. 28.

FIGS. 31A and 31B show views of an example downtube including a vertical truss.

FIGS. 32A, 32B, and 32C show views of an example downtube including a horizontal truss.

FIGS. 33A and 33B show views of an example downtube including a helical lattice truss.

FIGS. 34A and 34B show views of an example downtube including vertical and horizontal trusses.

FIGS. 35A and 35B show views of an example downtube including multiple vertical trusses.

FIGS. 36A, 36B, and 36C show views of an example downtube including diagonal trusses.

FIGS. 37A, 37B, 37C, and 37D show views of an example steerer tube formed from four foam components.

FIGS. 38A, 38B, and 38C show views of an example headtube formed from four foam components.

FIGS. 39A and 39B show views of an example headtube including a helical lattice truss extending toward the downtube.

FIGS. 40A and 40B show views of a coupling component integrated into a steerer tube of a fork.

Like reference symbols in the various drawings indicate like elements.

### DETAILED DESCRIPTION OF ILLUSTRATIVE EMBODIMENTS

The document generally describes reinforced carbon fiber structures and process for making such structures through the use of heat-expanding foam, such as dual expansion foam. The document describes examples of reinforced carbon fiber structures, such as mandrels for bicycle frames, however these examples are merely illustrative and do not limit the scope of this innovation. The disclosed carbon fiber structures and processes for manufacturing them can, instead, be applied to making any type of reinforced carbon fiber structure across any of a variety of different industries and intended uses, ranging from sports (e.g., bicycles, tennis, hockey, football, skiing), to automotive (e.g., car parts), to aviation (e.g., airplane components), and/or any of a variety of other industries and/or uses.

As an example process, dual expansion foam material in its unexpanded/pre-expanded form can be initially expanded into individual sections or into a near net shape—meaning a shape that is approximate (or smaller) the target structure to be formed—that is then cut into individual sections. The individual sections can be wrapped in carbon fiber, and the individual sections can then be wrapped together with carbon fiber and placed within a mold or similar tool, and heat can be applied. Such a tool can be made of any of a variety of heat conductive materials, such as metal, aluminum, steel, and/or composites. Heating can be applied to the mold by any of a variety of heat sources, such as an oven, autoclave, inserted heating rods, heating platens, and/or induction heating. When heat is applied to the foam wrapped in carbon fiber, the foam can expand into different desired shapes within the carbon fiber. Expanding foam can create outward pressure, which can press plies of carbon fiber against the mold or similar tool, thereby helping to consolidate the carbon fiber plies and resin of the foam material.

Moreover, varying levels of carbon fiber material (e.g., different number of layers of carbon fiber fabric) applied to foam that is combined into a near net shape can result in a reinforced carbon fiber product with different structural properties and strengths. For example, a first end of a near net shape can be wrapped in multiple layers of carbon fiber, whereas a second end may be wrapped in a single layer of carbon fiber. Once heat is applied, the foam can further expand to achieve a finished shape and the carbon fiber layers can be cured. The resulting reinforced carbon fiber structure can have greater strength in the first end of the structure, where more stresses may be expected to be greater when the structure is used for its intended purpose, in comparison to the second end of the structure, where less stresses are likely.

Any of a variety of different types of carbon fiber and fabrics can be used for wrapping the foam material, such as pre-preg carbon fiber tapes, pre-preg carbon fiber fabrics, pre-preg woven carbon fiber fabric, other woven fabrics, SMC mats, and plies or sheets of carbon fiber. Pre-preg can mean that the carbon fiber fabric has been permeated with a fluid matrix, and is ready for curing. This process can be used with other carbon fiber molding processes, as well, such as a resin transfer molding (RTM) process.

The dual expanding foam can be heat-activated. In other words, the dual expanding foam can expand from near net shapes to full desired shapes when heat is applied. Forming a reinforced carbon fiber structure with dual expanding foam that is a combination of different near net shape segments that, when heat is applied, can form a unitary structure with added reinforcement, durability, and strength. By using dual expanding foam (and/or other types of expanding foam capable of multiple expansion events) and wrapping individual segments of expanded foam with carbon fiber, resulting carbon fiber structures can be generated that have internal truss structures (e.g., supports, struts, internal carbon fiber supports) providing added reinforcement, durability, and strength to the final structure. For example, carbon fiber bicycle frames made using this process can be less prone to cracking, fractures, or failure of the frame. Additionally, specific and targeted reinforcement, strength, and/or stiffness can be added to a final structure by the way that sections are shaped, configured, and wrapped in carbon fiber, including the number of layers of carbon fiber applied to individual surfaces of the sections. For example, one or more sections of foam can be wrapped multiple times to add extra strength for trusses formed by the carbon fiber wrapping those sections, which can be performed depending on expected load demands to the final structure. Furthermore, trusses can be oriented in different directions within the final structure (e.g., horizontally, vertically, in quarters, in eighths, etc.) to provide, for example, fine tuning of individual portions of the final structure for stiffness, strength, support, durability, and/or performance.

Additionally, the expanded foam material can remain within the final carbon fiber structure and can provide additional structural reinforcement (e.g., as a structural bladder). For example, the foam material can permit the resulting carbon fiber structure to act as a sandwich panel, which uses the foam filling cavities within the carbon fiber structure to provide additional reinforcement to each of the carbon fiber surfaces that defines the structure. As a result, the reinforced carbon fiber structure can be stronger and less prone to fractures, cracking, or other failures that may compromise a purpose, performance, and/or integrity carbon fiber structure.

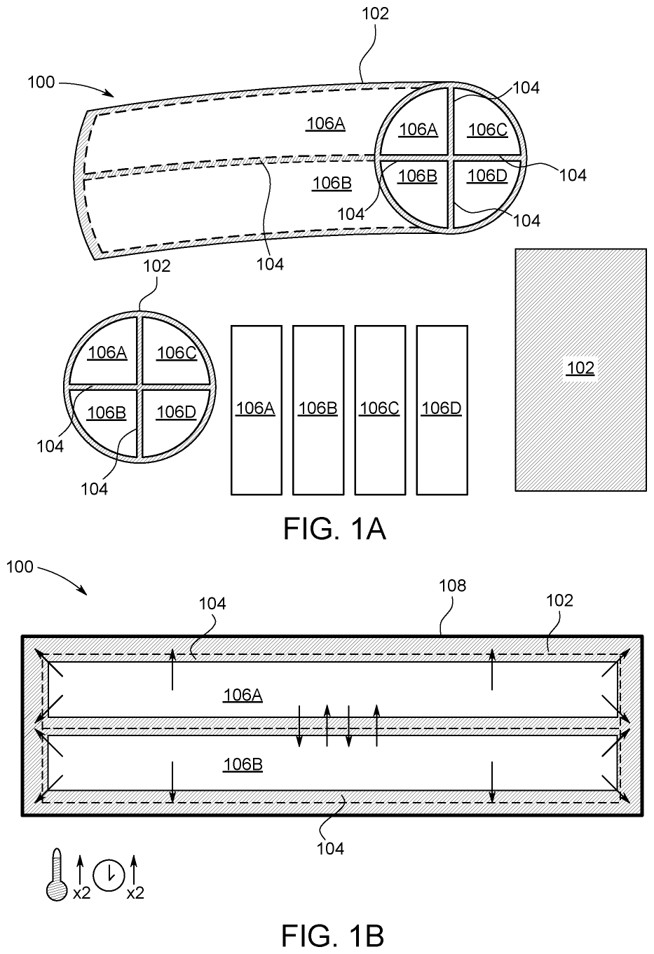

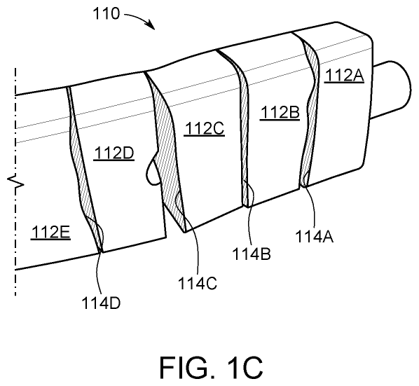

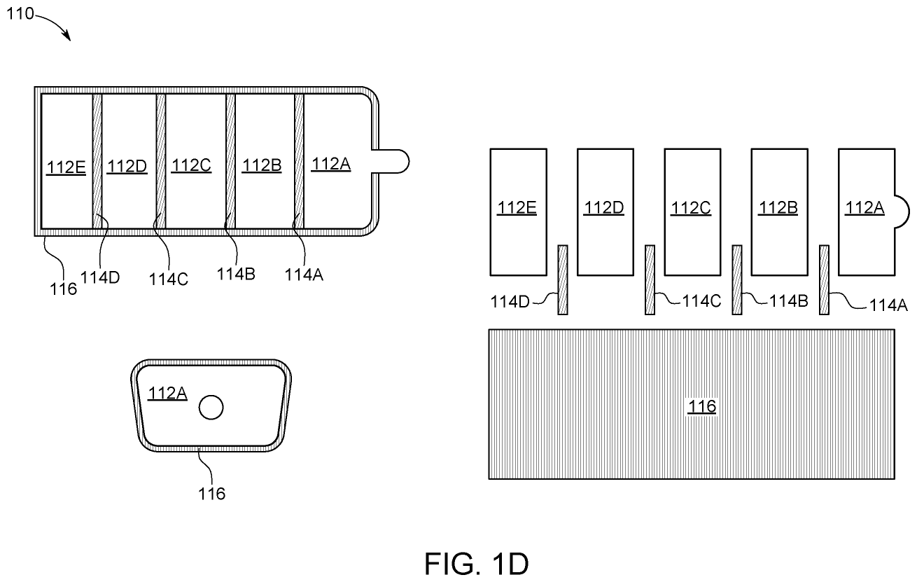

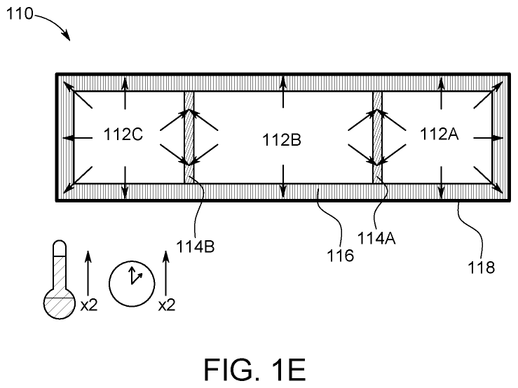

Referring to the figures, FIG. 1A is cross-sectional view of an example reinforced carbon fiber structure 100 having longitudinal trusses 104 that is made using processes described herein. The example reinforced carbon fiber structure 100 depicted in this example is a tube, but can be any of a variety of shapes. As depicted, the reinforced carbon fiber structure 100 has four longitudinal foam segments 106A-D. The foam segments 106A-D can be dual expansion foam. In some implementations, the foam segments 106A-D can be cut pieces of foam, where that foam was expanded to a near net shape of the reinforced carbon fiber structure 100 before the foam segments 106A-D were cut. The foam segments 106A-D can then expanded to a full shape of the reinforced carbon fiber structure 100. In other implementations, the foam segments 106A-D can be separate pieces of dual expansion foam that, when brought together and expanded, form the full shape of the reinforced carbon fiber structure 100.

Each of the foam segments 106A-D can be individually wrapped and/or affixed with plies of carbon fiber 104, which can form trusses extending through an interior of the structure 100 to provide reinforcement. In some implementations, once the foam segments 106A-D are individually wrapped in the carbon fiber 104, they can be brought together and collectively wrapped in plies of carbon fiber 102. The foam segments 106A-D wrapped in carbon fiber 104 and 102 can then be put back into the tool and expanded to the full shape of the reinforced carbon fiber structure 100.

The carbon fiber 102 and 104 can be a same or different carbon fiber materials (e.g., pre-preg carbon fiber fabric, pre-preg carbon fiber tape, and/or other carbon fiber materials) and/or can be the same or varied number of layers of carbon fiber material. Varied levels of carbon fiber can be applied to different portions of the structure 100, as well. For example, the foam segments 106A-D may be individually wrapped in carbon fiber 104 and an additional layer of carbon fiber may be applied to the internal surfaces of the foam segments 106A-D to provide additional reinforcement for the resulting trusses 104. Then carbon fiber 102 can be wrapped around all the foam segments 106A-D, and then the resulting combination can be put in the tool such that the foam segments 106A-D can expand to the full shape of the reinforced carbon fiber structure 100.

FIG. 1B depicts an example cross-sectional view of foam expansion in the reinforced carbon fiber structure 100 of FIG. 1A within a mold 108. Since this is a cross-sectional view, only foam segments 106A-B are shown. As mentioned above, foam segments 106A-B can be dual expansion foam. Carbon fiber 104 can be wrapped around each of the foam segments 106A-B (e.g., sandwiched between the foam segments 106A-B). The carbon fiber 102 can be wrapped around both foam segments 106A-B, holding them together to form the shape of the reinforced carbon fiber structure 100. Heat can be applied to the reinforced carbon fiber structure 100 for a predetermined amount of time. In some implementations, the heat can be applied twice—once to expand the foam segments 106A-B to the near net foam shape that can be segmented into the individual foam segments 106A-B, and a second time to expand the wrapped foam segments 106A-B to the full shape of the reinforced carbon fiber structure 100.

When heat is applied, the foam segments 106A-B expand, creating outward pressure against any cavities between the foam segments 106A-B and the carbon fiber 102 and/or 104. The foam segments 106A-B therefore exert outer pressure, causing the foam segments 106A-B to compress against each other and fill out an interior of the reinforced carbon fiber structure 100 as defined by the mold 108. As depicted in FIG. 1B, the outward pressure created by the foam segments 106A-B causes the foam segments 106A-B to expand towards corners of the carbon fiber 102 layer, along longitudinal and lateral sides of the carbon fiber 102 layer, as well as against the carbon fiber 104 layer. Although not depicted, the foam segments 106A-B expand in three-dimensional space, in x, y, and z directions. This heating process can be performed to expand the foam segments 106A-B to the full shape of the reinforced carbon fiber structure 100 to create the final reinforced carbon fiber structure 100 structure, as depicted in FIG. 1A.

FIGS. 1C-D depict an example foam mandrel 110 with foam segments 112A-E and lateral carbon fiber trusses 114A-D. The mandrel 110 can be, for example, a tube, like the reinforced carbon fiber structure 100 of FIGS. 1A-C. The mandrel 110 can be any other structure that is made with similar materials and/or techniques. As described in reference to FIGS. 1A-B, the foam segments 112A-E can be dual expansion foam. In FIGS. 1C-D, the foam mandrel 110 can be laterally cut up into foam segments 112A-E. Carbon fiber plies 114A-D can be affixed or placed between each lateral foam segment 112A-E. In some implementations, the carbon fiber plies 114A-D can be placed between the foam segments 112A-E and then this combination can be heated in the tool previously described. In other implementations, the carbon fiber plies 114A-D can be placed between each foam segment 112A-E and then this combination can be wrapped in the carbon fiber 116 layer. Then, this combination can be heated in the tool to the full shape of the mandrel 110.

FIG. 1E depicts an example expansion of the foam mandrel 110 of FIGS. 1C-D within a mold 118. FIG. 1E is a cross-sectional view of the mandrel 110. For example purposes, only the foam segments 112A-C are depicted. Heat can be applied to the mandrel 110 for a predetermined amount of time. In some implementations, the heat can be applied twice—once to expand the foam segments 112A-C to the near net shape of the mandrel 110 and a second time to expand the foam segments 112A-C with the carbon fiber 114A-B and 116 to the full shape of the mandrel 110.

When heat is applied, the foam segments 112A-C expand, creating outward pressure against any cavities between the foam segments 112A-C, the carbon fiber 114A-B, and/or the carbon fiber 116 layer. The foam segments 112A-C therefore exert outer pressure, causing the foam segments 112A-C to compress against each other and fill out an interior of the mandrel 110 shape as defined by the mold 118. As depicted in FIG. 1D, the outward pressure created by the foam segments 112A-C as heat is applied causes the foam segments 112A-C to expand towards corners of the carbon fiber 116 layer, along longitudinal and lateral sides of the carbon fiber 116 layer, as well as against all sides and corners of the carbon fiber 114A-B. Although not depicted, the foam segments 112A-C expand in three-dimensional space, in x, y, and z directions. This heating process can be performed to expand the foam segments 112A-C to the full shape of the mandrel 110 and to create the final mandrel 110 structure, as depicted in FIGS. 1C-D.

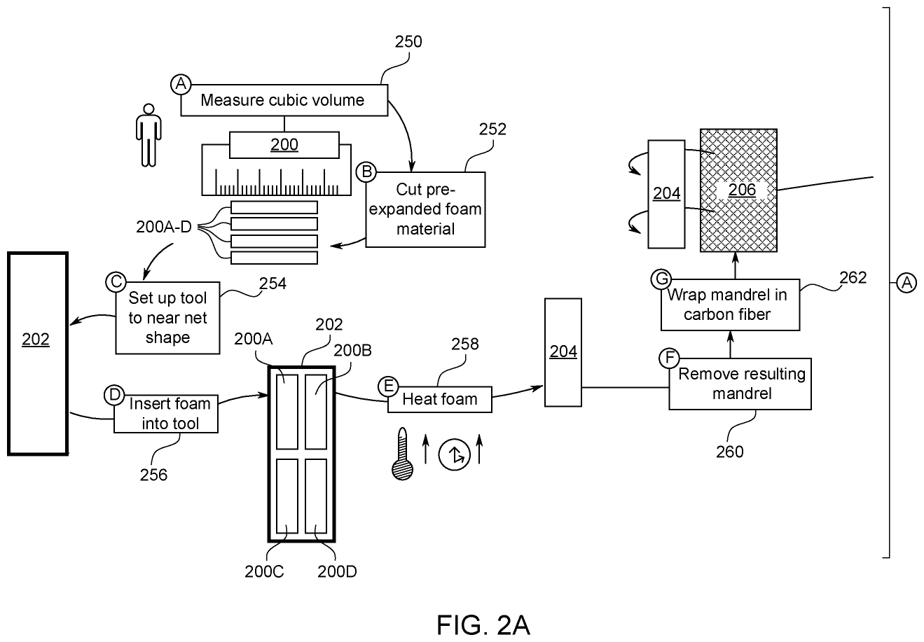

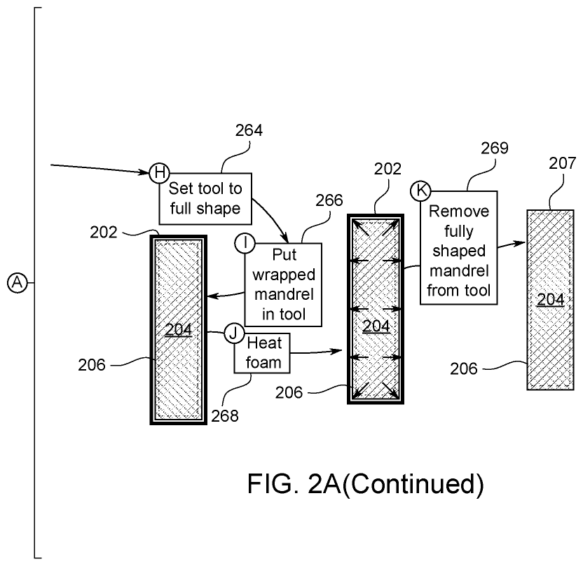

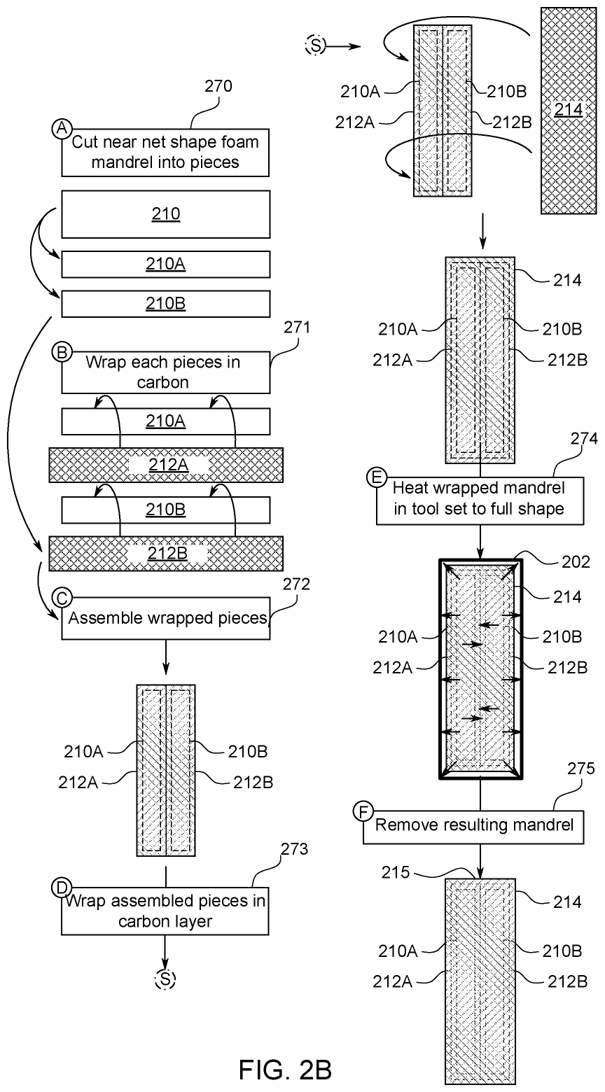

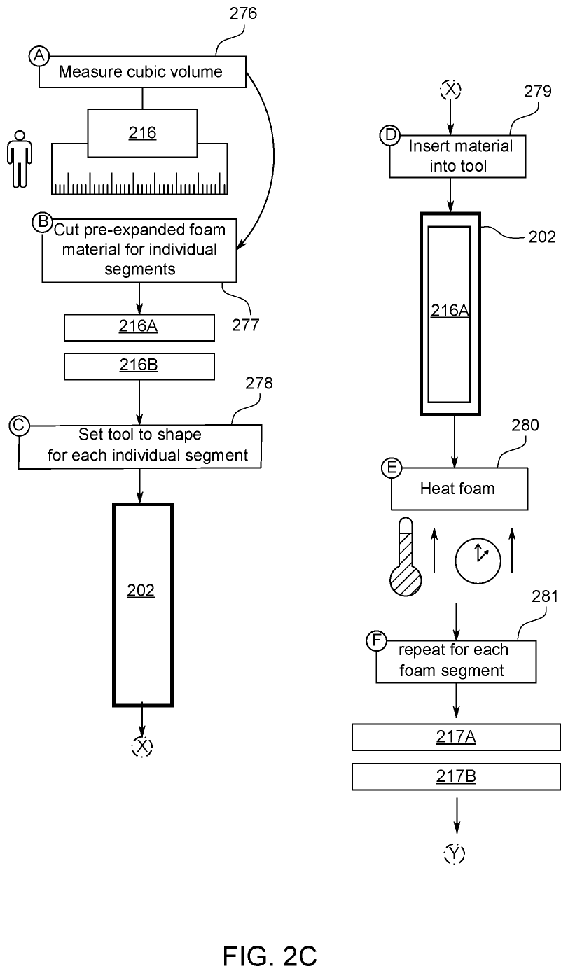

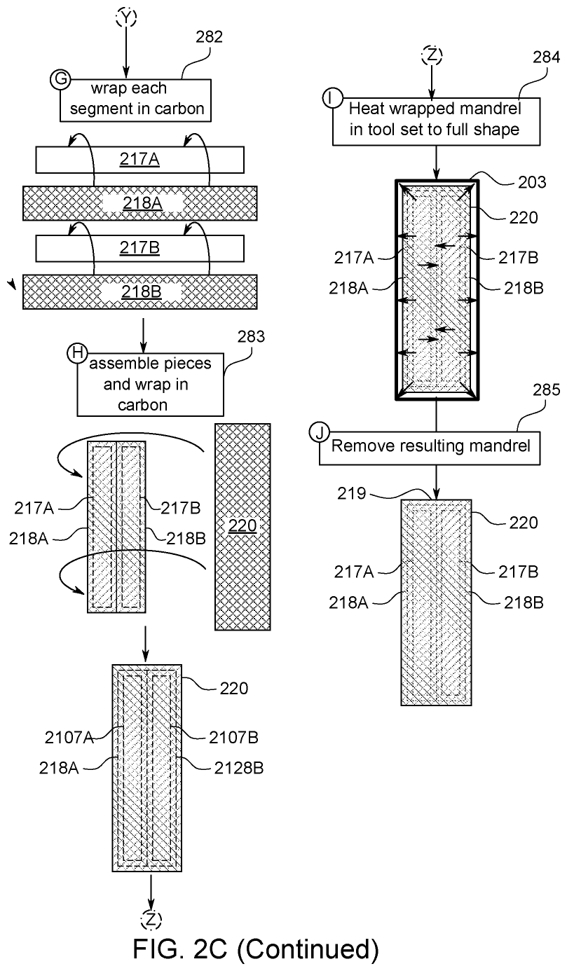

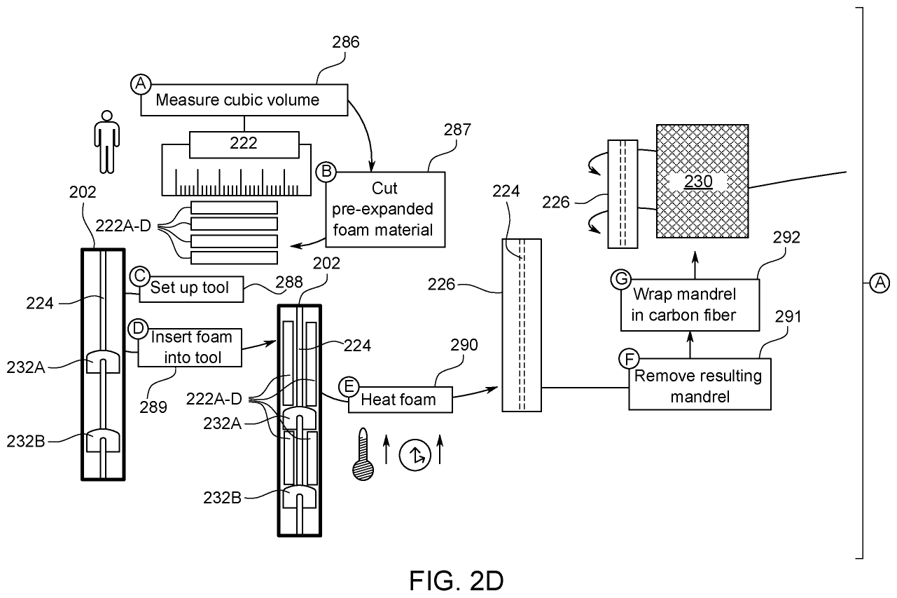

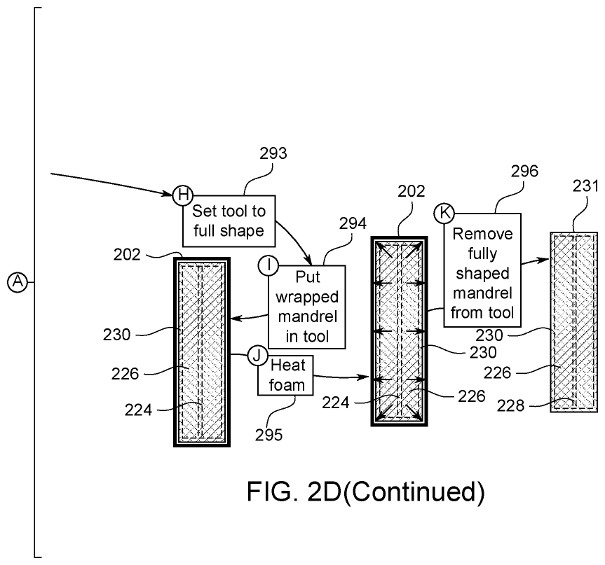

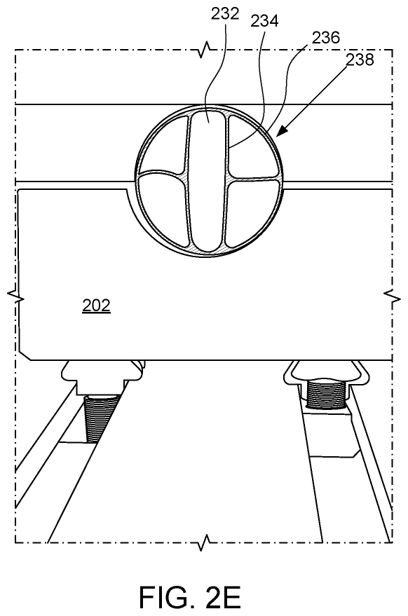

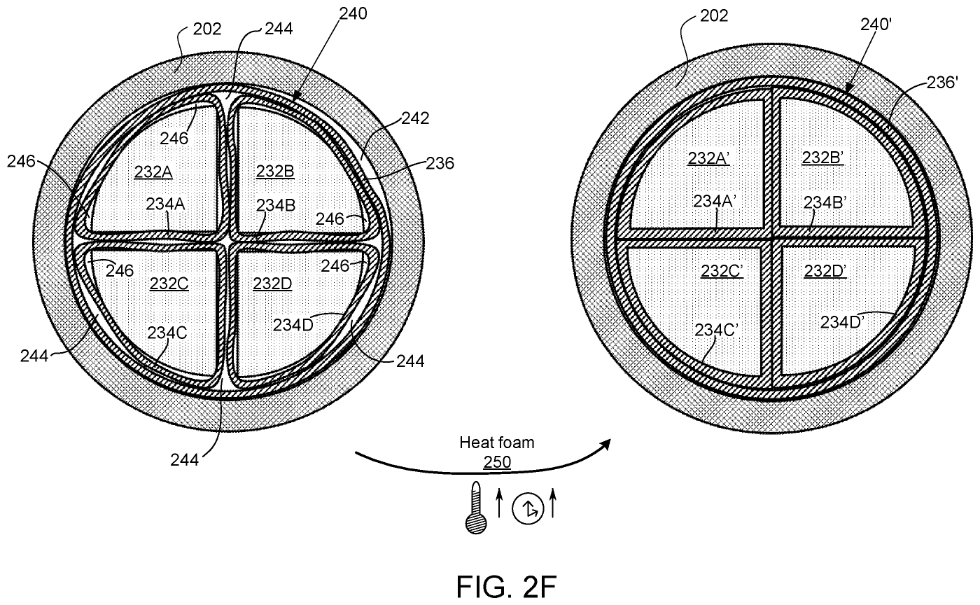

FIG. 2A-C are conceptual diagrams of making a mandrel using dual expansion foam. FIG. 2A is a conceptual diagram of using dual expansion foam in a near net shape to make the mandrel, which is then wrapped in carbon fiber and expanded to a full shape of the mandrel. A user can measure a desired cubic volume for a final mandrel 207 (step A, 250). The user can determine how much carbon fiber and/or foam material may be required to form a final, full shape of the mandrel. Equal distribution of the foam material can allow for an equal volume, weight, and expansion within each portion of the final mandrel. Therefore, the user can measure out how many grams of carbon fiber can be applied to form the final mandrel (e.g., weight per cub centimeters per section of the final mandrel or a final structure comprising the final mandrel and one or more other structures, such as mandrels). As an example, the user can determine that a near net shaped mandrel should be slightly smaller than a full shape of the final mandrel so that once the near net shaped mandrel is wrapped in carbon fiber and heat is applied, the near net shaped mandrel can expand to the desired full shape of the final mandrel.

Pre-expanded foam material 200 can be cut into pre-expanded foam pieces 200A-D based on the measured cubic volume (step B, 252). A tool 202 with a mold can be set up to provide a near net shape for the final mandrel 207 based on the measured cubic volume (step C, 254). The tool 202 can be used to apply heat for a predetermined amount of time to the pre-expanded foam pieces 200A-D, thereby causing the pre-expanded foam pieces 200A-D to expand within the mold of the set-up tool 202. In other words, the pre-expanded foam pieces 200A-D cannot expand beyond the mold of the tool 202. The pre-expanded foam pieces 200A-D can be set inside the tool 202 (step D, 256) and heat can then be applied to the tool 202 (step E, 258). The heat can be applied at a predetermined temperature and/or for a predetermined amount of time. During application of the heat, the foam pre-expanded foam pieces 200A-D can expand within the mold of the tool 202. Application of the heat can cause the foam pre-expanded foam pieces 200A-D to blend or mold together into a near net shaped foam mandrel 204. This resulting mandrel 204 can be removed from the tool 202 (step F, 260). The mandrel 204 can then be wrapped in one or more plies of carbon fiber 206 (step G, 262). For example, the carbon fiber 206 can be wrapped along longitudinal sides of the mandrel 204 as well as over ends of the mandrel 204. Wrapping all sides and ends of the mandrel 204 can be advantageous to make the final mandrel 207 stronger and less prone to fracturing along any sides or ends.

The same tool 202 (or a different tool) can then be set to the full shape of the final carbon fiber mandrel 207 (step H, 264). Such the mold for the full shape of the final carbon fiber mandrel 207 may define a larger volume than the mold used to generate the near net shape—meaning that the molds used for the near net shape and the final shape may be different from each other. Alternatively, the same mold may be used, but combinations of heating and duration may be adjusted to achieve the near net shape (slightly smaller volume than the final shape) without using a separate mold (and/or a separate tool). Other configurations are also possible.

The foam mandrel 204 wrapped in carbon fiber 206 can be positioned within the tool 202 (step I, 266). Heat can be applied to the tool 202 for a second time, and the level of heat applied during this second heating iteration may be greater than the first heating iteration (step J, 268). As mentioned above, the heat can be applied for a predetermined amount of time and/or at a predetermined temperature, and the target temperature during the second heating event may be greater (hotter) than the first heating event. During the heating process, the foam mandrel 204 can expand within the carbon fiber 206 layer and to the full shape of the final mandrel 207. As described herein, the foam mandrel 204 can expand by filling out any cavities or other open spaces between the mandrel 204 and sides, edges, and corners of the carbon fiber 206 layer, and forcing the carbon fiber 206 layer to expand outward to conform to the mold provided by the tool 202. This type of expansion can be advantageous to ensure that an interior of the final mandrel 207 is solid, stronger, and more stable, and also so that the outer shape of the final mandrel 207 adopts, conforms to, and retains the shape of mold (negative of the mold's internal shape). As a result, the mandrel 207 may be less susceptible to fracturing, cracks, or other forms of failure that can compromise the optimization, purpose, and/or performance of the final mandrel 207. Moreover, dual expansion foam is advantageous because pressure does not need to be applied using an external device or mechanism, such as an air bladder or other similar tool, to fill out the foam mandrel 204 to the full shape of the final mandrel 207, which can simplify the manufacturing process and make it less prone to error. Instead, the dual expansion foam can create its own pressure, thereby causing the foam to expand to the full shape of the mandrel 207 without use of an external source, such as an air bladder.

Once expansion is complete, the fully shaped final mandrel 207 can be removed from the tool 202 (step K, 269). The final mandrel 207, therefore, is at a full size (e.g., based on the desired cubic volume measured in A) and is made of the fully expanded foam mandrel 204 wrapped flush in the carbon fiber 206 layer.

FIG. 2B is a conceptual diagram of cutting a near net shape dual expansion foam mandrel into individually segments that are wrapped in carbon fiber, then the individually wrapped segments are wrapping together in carbon fiber, and the collectively wrapped shape is heated to form a reinforced carbon fiber structure. As depicted, a near net shape dual expansion foam mandrel 210 can be cut into pieces 210A-B (step A, 270). The initial forming of the near net shape can be performed similar to the description above regarding steps A-F (250-260) in FIG. 2A. The mandrel 210 may be cut into any of a number of pieces, and those pieces may be non-uniform in number, shape, and/or size. For example, the mandrel 210 can be cut into differently sized or shaped pieces, depending on a desired support and strength. Each of the pieces 210A-B can be individually wrapped in carbon fiber plies 212A-B (step B, 271). As described herein, the carbon fiber 212A-B can also be wrapped around ends of each of the pieces 210A-B to increase a strength of the individual pieces 210A-B.

The individual pieces of foam 210A-B wrapped in carbon fiber 212A-B can then be assembled into a superstructure (step C, 272), which can then be wrapped in carbon fiber 214 (step D, 273). Assembling the individual pieces of wrapped foam 210A-B/212A-B into the superstructure can involve, for example, fitting the individual pieces back together so that they reform the near net shape 210 from which they were cut.

The collectively wrapped foam can then be placed in tool 202 with a mold defining the full shape for the final mandrel 215, and heat can be applied to the foam for a second time by the tool 202 (step E, 274). The heat can be applied at a target temperature and for a predetermined amount of time, which causes the foam pieces 210A-B to expand within the carbon layers 212A-B and 214, thereby filling out any cavities or gaps between the foam pieces 210A-B, the carbon layers 212A-B, and/or the outer carbon layer 214—causing the outer carbon layer 214 to conform to and cure so it retains the shape of the mold for the tool 202, and causing the internal carbon fiber layers 212A-B to cure and retain their arrangement within the structure. The final mandrel 215 can be removed from the tool 202 (step F, 252). The final mandrel 215 can be a composite of the foam pieces 210A-B individually wrapped in carbon layers 212A-B and collectively wrapped in the external carbon layer 214. Such a configuration of multiple layers of wrapped carbon can be advantageous, for example, in that it can improve the strength of the final mandrel 215 to reduce fractures, cracks, or failures to an overall structure.

FIG. 2C is a conceptual diagram of forming individual foam pieces in separate tools/molds that are then individually wrapped with carbon fiber and combined in a carbon fiber wrap to form full shape of a final mandrel. As depicted, a user can measure a desired cubic volume for a foam material 216, as described in reference to FIG. 2A (step A, 276). The pre-expanded foam material 216 can be separate into one or more portions 216A-B that are used to form separate foam pieces (step B, 277).

The tool 202 can be set to a shape for each individual foam segment that formed separately (instead of being cut from a near net shape for the final carbon fiber structure) (step C, 278) and a first portion of the pre-expanded foam material 216A can be set inside the tool 202 (step D, 279). Heat can be applied for a predetermined amount of time to the piece 216A in the tool 202 (step E, 280), which can cause the material 216A to expand to form an individual foam segment 217A. Steps D (279) and E (280) can be performed to form the other individual foam segments 217B (and others) using other portions of the material 216A-B (step F, 281). Although the same tool 202 is depicted as being used for each individual segment 217A-B, different tools and molds can be used, and differently shaped individual segments 217A-B can be formed.

Once all of the individual segments 217A-B are formed, the remaining steps G-J (282-285) are similar to steps B-F (271-275) described above with regard to FIG. 2B. For example, each individual foam segment 217A-B can be individually wrapped in carbon fiber plies 218A-B (step G, 282), and then the individually wrapped segments 217A-B/218A-B can be assembled and collectively wrapped in a carbon fiber layer 220 (step H, 283). Since the individual segments 217A-B were not cut form a common near net shape, they can be designed to have complementary surfaces/shapes so that they fit together with little if any gaps between the complementary and corresponding opposing surfaces. As described throughout this document, varying amounts of carbon fiber can be applied to the individual segments 217A-B, including applied to different portions/surfaces of each segment 217A-B in differing quantities (e.g., differing number of layers), and applied to segments 217A-B in different quantities (e.g., multiple layers applied to segment 217A and single layer applied to segment 217B). The individual segments 217A-B wrapped together in the carbon layer 220 can be placed in a tool 203 (including different mold from tool 202 for forming individual segments) for the final and full shape of the final mandrel 219, and heat can be applied to the tool 203 (step I, 284). The heat (which can be at a target temperature greater than the target temperature during the first expansion) can cause the foam segments 217A-B to undergo a second expansion, thereby expanding into any cavities or gaps between the foam pieces 217A-B, the carbon layers 218A-B, and/or the outer carbon layer 220. Once the pieces 217A-B expand to the full shape, the final mandrel 219 can be removed from the tool 202 (step J, 285).

FIG. 2D is a conceptual diagram of making a mandrel with a conduit embedded therein using dual expansion foam. As described above, the user can measure a cubic volume for the pre-expanded foam material 222 (step A, 286). The material 222 can be separated into one or more portions 222A-D, based on the measured cubic volume (step B, 287). The tool 202 can then be set to a near net shape for a final mandrel 231 (step C, 288). As depicted, the tool 202 can be set with a conduit 224 arranged in three-dimensional space within the tool 202 using supports 232A-B, which may be made of either a heat-expanding material (e.g., expanded foam) and/or non-expanding material (e.g., cured carbon fiber). The supports 232A-B can be configured to retain and hold the conduit 224, which is just an example of a structure that can be embedded within a carbon fiber structure using these techniques (other structures include, for example, wires, cables, electronics, batteries, reservoirs, and/or other structures). For example, the supports 232A-B can configured to retain the conduit 224 so that it is spaced apart from the edges of the mold 202, so that it has a straight trajectory through the volume of the tool, and/or other configurations. The supports 232A-B can be used to make sure the conduit 224 is positioned within a specific arrangement within the final carbon fiber mandrel 231 that is being formed. Setting and positioning the conduit 224 before the foam has been expanded (and having the foam expand around it) can be advantageous such that once the final mandrel 231 is formed, cables, wires, or other materials or objects can be run down through an opening in the final mandrel 231 that is formed from the conduit 224. Furthermore, setting the conduit 224 in the correct position before the foam is even formed can be less labor intensive and can permit for more complex conduit structures to be formed instead of trying to drill out or otherwise position conduits in the final mandrel 231 after it has been formed. For example, the conduit 224 can be positioned in one or more different locations or directions, including curving and winding through more complex three-dimensional shapes, within the tool 202, based on a desired structure.

The conduit 224 may be made out of a solid material that can either avoid collapsing during foam expansion (e.g., pre-cured carbon fiber conduit) and/or can be made of a material that can be removed from the final mandrel 231 (e.g., silicon tube). For example, the conduit 224 can be removed or pulled out of the final mandrel 231 once it is formed, which can result in formation of a hollow channel through the final mandrel 231.

The material 222A-D can be positioned in the tool and around the conduit 224 (step D, 289) and heat can be applied (step E, 290), which can cause the material 222A-D to expand. The supports 232A-B can retain conduit in its desired position as the foam material 222A-B expands in the tool 202 and then the foam can expand around the conduit 224 to form a resulting mandrel 226, which can be removed from the tool 202 (step F, 291). For example, the material 222A-D can be blended or molded together to form the mandrel 226, where the mandrel 226 is in the near net shape of the final mandrel 231. The conduit 224 can remain in its desired position within the mandrel 226.

The mandrel 226 can be wrapped in a carbon fiber layer 230 (step G, 292). In some implementations, the mandrel 226 can be wrapped in multiple layers of carbon fiber. In some implementations, the carbon fiber 230 can be wrapped around ends of the mandrel 226. In yet other implementations, the carbon fiber 230 can be wrapped around ends of the mandrel 226 with cutouts where the channel 224 is located. As a result, the final mandrel 231 can have increased strength and support, but the channel 224 can still be accessible and used for running cables, wires, or other components down a length of the mandrel 231 through the channel 224. In yet other implementations, one end of the mandrel 226 can be wrapped with carbon fiber 230 and another end of the mandrel 226 can remain unwrapped, such that the channel 224 can be accessed.

The tool 202 can then be set to a full shape of the final mandrel 231 (step H, 293), the mandrel 226 with the conduit 224 and wrapped in the carbon fiber 230 can be set inside the tool 202 (step I, 294), and heat can be applied (step J, 295). As depicted, the foam mandrel 226 can expand to a full shape of the tool 202 such that the foam fills out any cavities or gaps around the channel 228 and presses the carbon fiber layer 230 outward so that it conforms to and, once cured, retains the shape of the mold 202. Once the foam mandrel 226 expands to the full shape, the final mandrel 231 can be removed from the tool 202 (step K, 296).

In instances where the conduit 224 is removable (e.g., silicon tube or sleeve), it can be removed after the final mandrel 231 is formed. For example, when heat is applied, the silicon sleeve can expand. When it cools down, the sleeve can shrink such that the sleeve can be pulled out of a resulting mold or foam mandrel—leaving a channel in the foam. As another example, carbon fiber can be wrapped around the silicon sleeve (e.g., layer, tube) and when the silicon sleeve is removed, a carbon fiber conduit suspended within the foam can remain. This process can be advantageous to provide for lightweight installation of a channel for running cables or materials through a center of the final structure. Moreover, the carbon fiber wrapped channel in the center of the final structure can increase rigidity of the final structure as well as strength and/or durability.

The example process described with regard to FIG. 2D could be used to form individual segments of foam that are then wrapped and combined into a superstructure, such as individual segments 210A-B and 217A-B described above with regard to FIGS. 2B-C. Additionally and/or alternatively, conduit structures (and/or other embedded structures) like conduit 224 could be placed between individual segments of foam (e.g., segments 210A-B and 217A-B) as they are being combined into a superstructure.

FIG. 2E depicts an example view of a reinforced carbon fiber structure 238 formed within a mold 202 using dual expanding foam segments 232 individually wrapped in carbon fiber 234 and combined with an additional carbon fiber wrap 236. The reinforced carbon fiber structure 238 can be formed using, for example, the processes described above with regard to FIGS. 2B and/or 2C.

FIG. 2F depicts example views of a reinforced carbon fiber structure 240 formed using dual expanding foam 232A-D. The reinforced carbon fiber structure 240 is depicted when the dual expanding foam 232A-D is in near net shape, before heat is applied (250) in the tool 202. Once heat is applied (250), the dual expanding foam 232A′-D′ expands to fill the volume within the tool 202, thereby forming a resulting reinforced carbon fiber structure 240′.

As shown in the reinforced carbon fiber structure 240, each of the dual expanding foam segments 232A-D, which have already undergone a first heat-based expansion to form the segments 232A-B, can be individually wrapped in carbon fiber layers 234A-D, respectively. Each of the individually wrapped dual expanding foam segments 232A-D can then be combined with an additional carbon fiber wrap 236. The carbon fiber layers 234A-D wrapped around the foam segments 232A-D and the outer carbon fiber layer 236 can both be pre-cured carbon fiber materials, such as pre-preg carbon fiber. As a result, the carbon fiber layers 234A-D and the carbon fiber layer 236 can be pliable and readily positioned around or between the shapes defined by the foam segments 232A-D—permitting for the carbon fiber layers 234A-D and the carbon fiber layer 236 to be positioned in particular arrangements in 3D space that may not be possible to readily form via other carbon fiber forming and curing techniques.

Since the dual expanding foam segments 232A-D have already undergone a first heat-based expansion and, as a result, are initially in near net shape of the final structure 240′, and the carbon fiber layers 234A-D and 236 are pliable pre-cured carbon fiber materials (e.g., pre-preg carbon fiber fabric), unoccupied voids (e.g., gaps) can form between one or more layers of carbon fiber layers and the foam. For example, unoccupied voids 242 can form between the tool 202 and the outer carbon fiber wrap 236. Unoccupied voids 244 can also form between the outer carbon fiber wrap 236 and each of the carbon fiber layers 234A-D. Unoccupied voids 246 can also form between each of the dual expanding foam 232A, 232B, 232C, and 232D and their corresponding carbon fiber layer wraps 234A, 234B, 234C, and 234D.

Once heat is applied (250) in the tool 202, the foam 232A-D can undergo a second expansion that causes the foam 232A-D to apply pressure against the carbon fiber layers 232A-D and 236. This pressure can compress the adjacent carbon fiber layers 232A-D and 236 against each other and against the mold provided by the tool 202, which results in the reinforced carbon fiber structure 240′ with further expanded foam segments 232A′-D′ and compressed (and cured) carbon fiber layers 234A′-D′ and 236′, which no longer include the unoccupied voids 242, 244, and 246. For example, the dual expanding foam 232A-D can expanded to its full shape provided by the tool 202, thereby pushing against the carbon fiber layers 242A-D and the carbon fiber wrap 236, and filling out any of the unoccupied voids 242, 244, and 246 that may have existed when the dual expanding foam 232A-D was in its near net shape. While the heat 250 is applied and the foam 232A-D expands, the carbon fiber layers 234A-D and 236 can be cured (i.e., hardening resin and/or fluid matrix combined/applied to carbon fiber layers 234A-D and 236, such as through the use of pre-preg carbon fiber fabric containing resin)—resulting in a rigid, strong, and reinforced final carbon fiber structure 240′.

Once the foam segments 232A-D are wrapped and placed in the tool, the segments 232A-D are in the near net shape of the final carbon fiber structure 240′. In near net shape, the foam segments 232A-D, which have already undergone an initial expansion, can have a volume ranging anywhere from 50%, 75%, 80%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99%, to 99.5% of the finished volume of the foam 232A′-D′ (after second heat-based expansion) and/or of the finished volume of the total final carbon fiber structure 240′ (combination of foam 232A′-D′ and carbon fiber 234A′-D′ and 236′). The unoccupied voids 242, 244, and 246 can be anywhere in a range of less than 1% to 10%, 15%, 20%, 25%, or 33% of the finished volume of the final carbon fiber structure 240′ when the dual expanding foam segments 232A-D are formed to near net shape before heat is applied (250).

The near net shape of the dual expanding foam structures 232A-D can be very close in volume to the full shape of the final carbon fiber structure 240′, where a difference in unoccupied voids 242, 244, and 246 can be minimal. Forming the dual expanding foam structures 232A-D to the near net shape can be advantageous since the carbon fiber layers 234A-D and wrap 236 do not expand and/or may expand by a minimal amount before they harden during the curing process. Since the carbon fiber layers 234A-D and wrap 236 do not expand (or expand by a minimal amount), forming the foam structures 232A-D to near net shape can allow for the foam structures 232A-D to expand out to the full shape of the final carbon fiber structure 240′, and for the resulting carbon fiber structures 234A′-D′ and 236′ to remain in effectively the same arrangement and position as they were initially placed in the near net shape (pre-cured carbon fiber layers 234A-D and 236)—providing for greater accuracy and precision in forming interior carbon fiber structures.

Once heat is applied (250), the dual expanding foam segments 232A-D expand to the full shape and finished volume of the final carbon fiber structure 240′, thereby filling any of the unoccupied voids 242, 244, and 246. For instance, in an illustrative example, during a first expansion process (not depicted in FIG. 2F, but described above) the dual expanding foam structures 232A-D can be formed to a near net shape that is 96% of the total volume of the final carbon fiber structure 240′. The foam structures 232A-D can also be wrapped in the carbon fiber layers 234A-D and 236, which in this illustrative example can occupy 2% of the total volume, such that a resulting near net shape of the foam structures 232A-D with the carbon fiber layers 234A-D and 236 is 98%. In a second expansion process, once heat is applied the foam structures 232A-D can further expand to a remaining 2% of the total volume by applying pressure against the carbon fiber layers 234A-D and 236, such that the final carbon fiber structure 240′ results in the desired full shape. As a result of the two expansion processes, any unoccupied voids 242, 244, and 246 that may have existed as differences between the near net shape volume and the final shape volume can be reduced or eliminated by the dual expanding foam structures 232A-D.

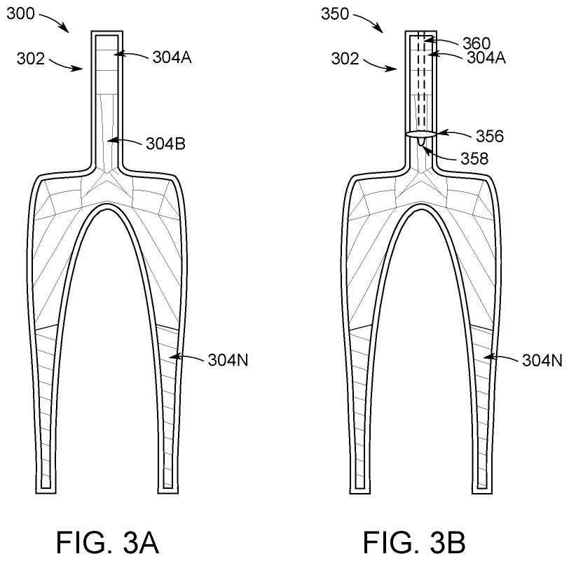

FIGS. 3A-B depict example arrangements of foam segments that can be used to form reinforced carbon fiber bicycle forks 300 and 350 with dual expansion foam. The forks can be formed using, for example, the example processes described above with regard to FIGS. 2A-D.

Referring to FIG. 3A, the example fork 300 has foam sections 304A-N that are each wrapped in carbon fiber and/or otherwise have carbon fiber affixed to one or more of their surfaces to provide carbon fiber reinforcements within the fork 300. As depicted, the foam sections 304A-N can be differently shaped, sized, and configured (and carbon fiber can be applied to these sections 304A-N in different configurations and quantities) throughout different parts of the fork 300 to reinforce the fork 300 to handle different forces and strains that may be exerted upon different parts of the fork 300. For example, section 304A can be a lateral foam section and carbon fiber wrapped around it can provide lateral reinforcement, section 304B can be a longitudinal foam second and carbon fiber wrapped around it can provide longitudinal reinforcement, and section 304N can be a diagonally shaped and wrapped with carbon fiber to provide angular reinforcement. An outer layer of carbon 302 can be wrapped around all the sections 304A-N to form the final shape of the mandrel 300.

FIG. 3B depicts example mandrel 350 that includes similar sections 304A-N as the mandrel 300, but includes a disc 356 with threaded attachment mechanism 358 that can be positioned with the sections 304A-N inside of the mandrel 350. The disc 356 can be a lateral layer of carbon fiber that is coupled to and retained in its position by the foam sections 304A-N, the carbon fiber positioned between the sections 304A-N, and the carbon fiber wrap 302. The attachment mechanism 358 can include threads, and can be accessible via a conduit 360 that can be formed in the neck of the fork 350 to provide an anchor point that can be used for mounting the fork and handle bars on a bicycle. The disc 356, the attachment mechanism 358, and the conduit 360 can be formed, positioned, and retained within the fork 350, for example, using the process described above with regard to FIG. 2D.

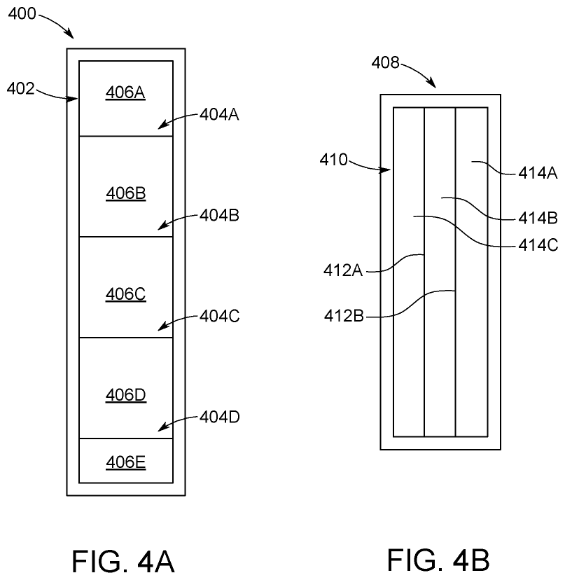

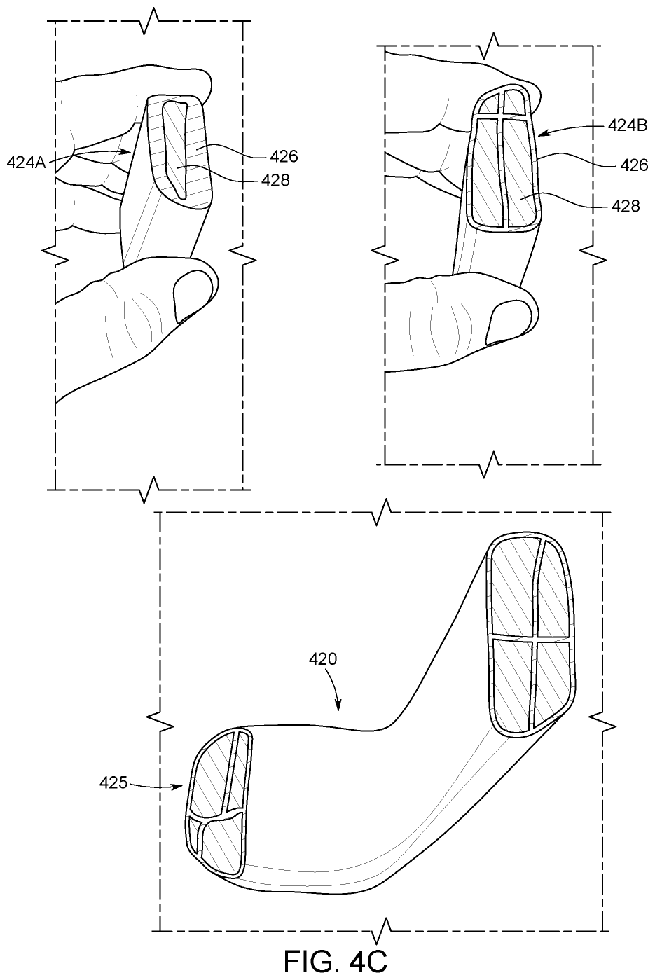

FIG. 4A depicts an example reinforced carbon fiber structure 400 having lateral carbon fiber trusses 404A-D that are positioned between foam segments 406A-E. The reinforced carbon fiber structure 400 can also include one or more longitudinal carbon fiber trusses, and/or one or more other positioned or arranged carbon fiber trusses. A carbon fiber layer 402 can wrap around all the foam segments 406A-E and carbon fiber plies 404A-D.

In some implementations, additional and/or differing layers of carbon fiber can be wrapped around different portions of the foam segments 406A-E. For example, some of the foam segments 406A-E can be wrapped together in carbon fiber and then then carbon fiber layer 402 can be wrapped around all groupings of wrapped foam segments 406A-E. For instance, the foam segments 406A-C can be wrapped together in carbon fiber, the foam segments 406D-E can be wrapped together in carbon fiber, and then these two wrapped groups can then be wrapped together in the carbon fiber layer 402 to form the final carbon fiber structure 400. In yet other implementations, the foam segments 406A-E can be individually and collectively wrapped in a single sheet of carbon fiber. The carbon fiber can be cut into one or more continuous shapes such that wrapping the single sheet around each of the foam segments 406A-E as well as around all the foam segments 406A-E can be possible with the single sheet.

FIG. 4B depicts another example reinforced carbon fiber structure 408 having longitudinal carbon fiber reinforcements 412A-B positioned between foam segments 414A-C. As described in reference to FIG. 4A, one or more fewer or additional foam segments 414A-C can form the final reinforced carbon fiber structure 408. Each of the foam segments 414A-C can be individually wrapped in carbon fiber 412A-B. In other implementations the carbon fiber 412A-B can be sandwiched or placed between each of the foam segments 414A-C. In yet other implementations, the foam segments 414A-C can be individually wrapped in carbon fiber and the carbon fiber 412A-B can also be placed between each of the foam segments 414A-C. The foam segments 414A-C and the carbon fiber 412A-B can then be collectively wrapped in a carbon fiber layer 410. The carbon fiber layer 410 can be an external surface or side of the final mandrel structure 408. As described above, the carbon fiber layer 410 can also be wrapped around ends and opposing long sides of the mandrel 408 to increase strength, support, and/or durability of the final mandrel structure 408.

FIG. 4C depicts example portions of a reinforced carbon fiber structure 420 having differently shaped dual expansion foam sections 428 that are surrounded by carbon fiber 426. The structure 420 can be part of a bicycle frame fork, for example, and the different views presented in FIG. 4C show different cross-sections 425, 424A, and 424B of the structure 420. As depicted in FIG. 4C, the dimensions, configurations, and arrangements of the carbon fiber 426 and foam sections 428 can vary throughout the structure 420. For example, the first end 424A has less expansion of foam material 428 and more carbon fiber 426. This may be thicker layer of carbon fiber 426 to accommodate and handle greater force, such as near where bicycle wheel and axel is attached.

There can be a transition of thickness of the carbon fiber 426 from the first end 424A to the second end 424B, and can be variance in the arrangement of foam segments 428 and corresponding carbon fiber trusses between the segments. The difference in thickness and arrangement of carbon fiber can be advantageous and arranged to accommodate different loads and forces applied to different portions of the structure 420. For example, the first end 424A of the lower fork portion 422 can experience more force or load when axel is positioned therein. Thus, increased thickness of carbon fiber 426 in the first end 424A can reduce risk of breaking or fracturing of the lower fork portion 422 when the through axel is positioned therein. Moreover, the consolidation of carbon fiber 426 in the second end 424B of the lower fork portion 422 can mirror or mimic a consolidation of carbon fiber 426 in the fork structure 420, when the second end 424B is attached to the end 425 of the structure 420. In other implementations, the consolidation of carbon fiber 426 in the second end 424B may not mirror the consolidation of carbon fiber 426 in the fork structure 420 where the second end 424B of the lower fork portion 422 attaches to the end 425 of the fork structure 420.

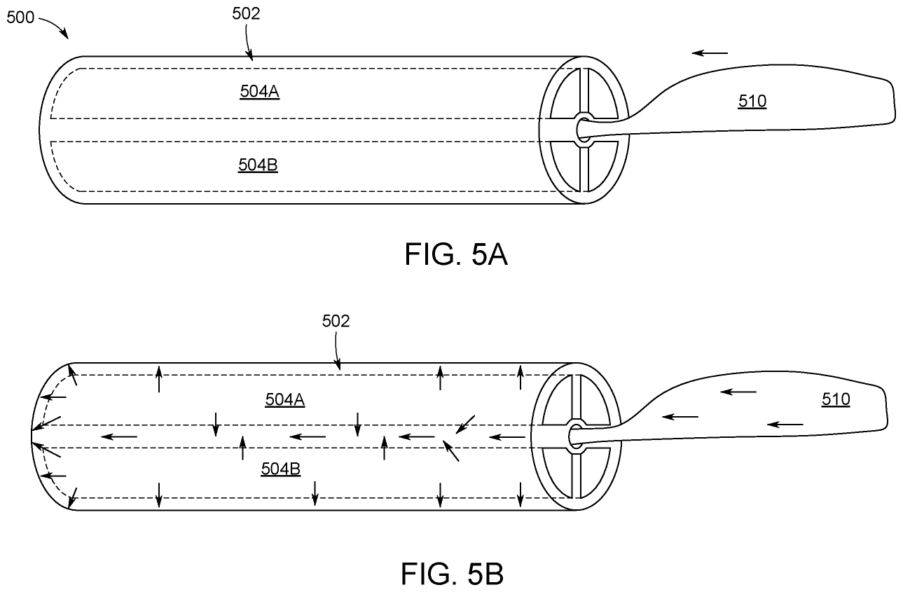

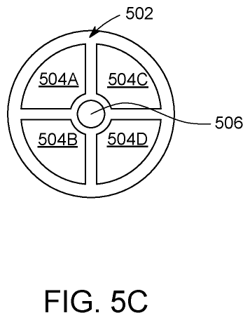

FIGS. 5A-C depict expansion of foam segments 504A-D when an airbladder 506 is inserted into a portion of a carbon fiber structure 500. The airbladder 510 can be inserted between the foam segments 504A-D during heating and curing of the carbon fiber structure 500 to define a channel or void in the structure 500. Air pressure can be maintained within the air bladder 510 (as depicted in FIG. 5B) during the heating and curing process to avoid collapsing as the foam segments 504A-D expand. Once the foam segments 504A-D are expanded to a desired shape, the airbladder 510 can be removed from the carbon fiber structure 500 and a void 506 can remain within the structure.

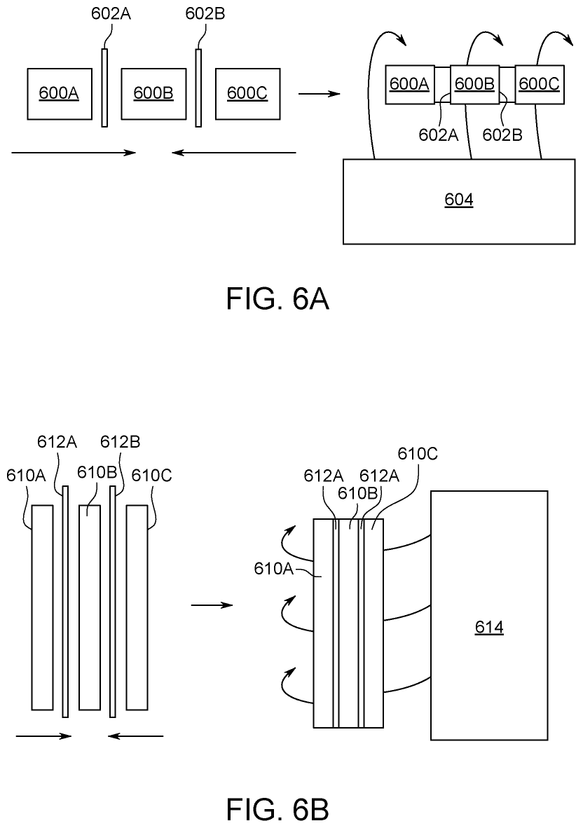

FIG. 6A depicts components used in creating a reinforced carbon fiber structure having lateral foam sections 600A-C. As depicted and described throughout, dual expansion foam material can be cut into multiple lateral foam sections 600A-C. A number of lateral foam sections 600A-C can be determined based on a desired final structure, expected load on the final structure, and/or one or more other factors or conditions. Carbon fiber plies 602A-B can be sandwiched or placed between each of the lateral foam sections 600A-C. In some implementations, the foam sections 600A-C can be individually wrapped in the carbon fiber plies 602A-B. The foam sections 600A-C and carbon fiber plies 602A-B can then be brought together and collectively wrapped in a carbon fiber layer 604.

As described throughout this disclosure, heat can be applied after the carbon fiber 602A-B is sandwiched between the foam sections 600A-C or the foam sections 600A-C are individually wrapped in carbon fiber 602A-B. This can be a first expansion process wherein the foam sections 600A-C mold together to form a near net shape of the final structure. A second expansion process can then be applied once the molded together foam sections 600A-C are wrapped in the carbon fiber layer 604. During the second expansion process, the foam sections 600A-C can expand to a full shape of the final structure. As another example, heat can be applied after the foam sections 600A-C and carbon fiber 602A-B are wrapped collectively in the carbon fiber layer 604 rather than before being wrapped collectively in the carbon fiber layer 604. Moreover, in some implementations, the foam sections 600A-C can be heated to expand to a near net shape before the carbon fiber 602A-B are sandwiched between the foam sections 600A-C. One or more additional expansion processes can occur thereafter, as described above.

FIG. 6B depicts components used in creating a reinforced carbon fiber structure having longitudinal foam segments 610A-C. As depicted and described throughout, dual expansion foam material can be cut into multiple longitudinal foam segments 610A-C. A number of longitudinal foam segments 610A-C can be determined based on a desired final structure, expected load on the final structure, and/or one or more other factors or conditions. Carbon fiber plies 612A-B can be sandwiched or placed between each of the foam segments 610A-C. In some implementations, the foam segments 610A-C can be individually wrapped in the carbon fiber plies 612A-B. The foam segments 610A-C and carbon fiber plies 612A-B can then be brought together and collectively wrapped in a carbon fiber layer 614.

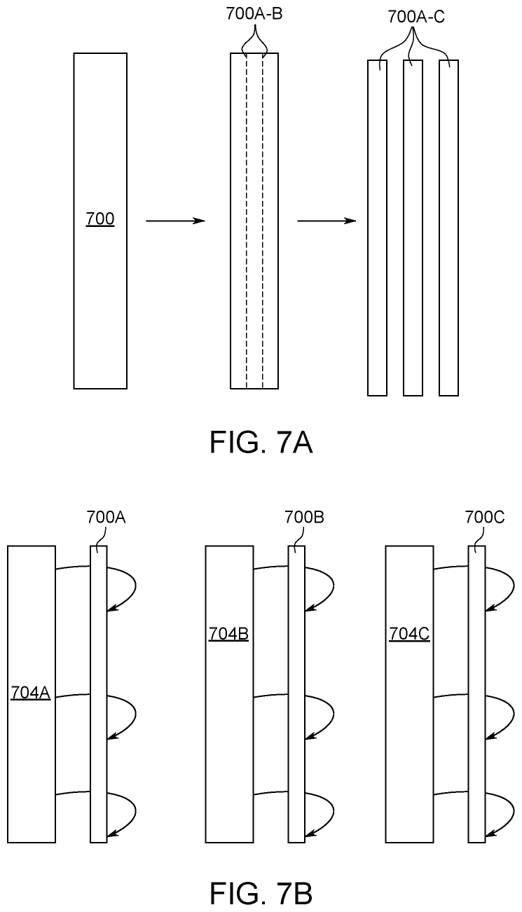

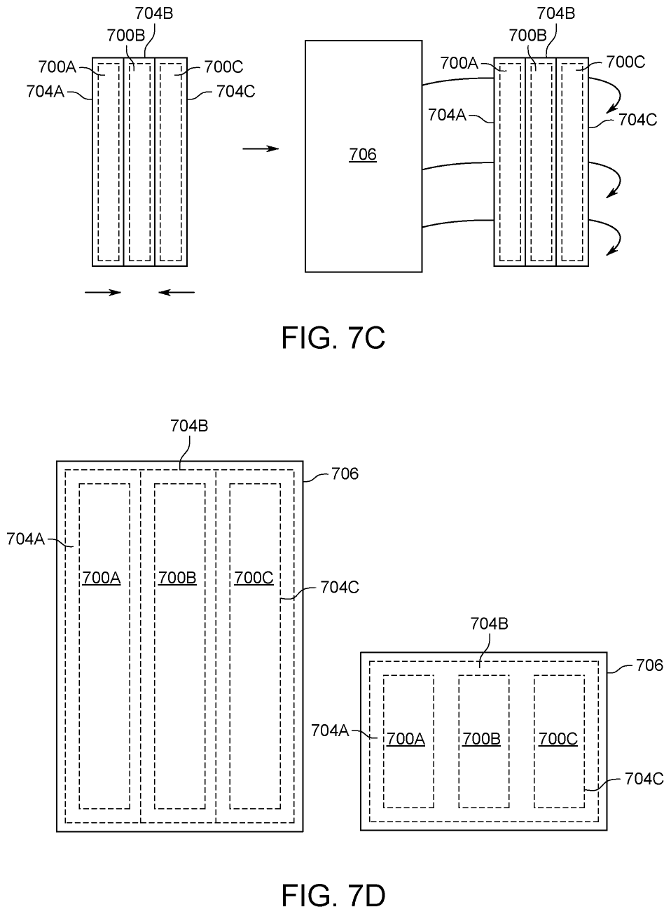

FIGS. 7A-D are conceptual diagrams of creating a mandrel with a formed dual expansion foam mandrel. FIG. 7A depicts a pre-formed foam mandrel 700. The mandrel 700 can be formed by setting dual expansion foam material inside a mold or tool and applying heat. The mandrel 700 can be expanded to a near net shape of a final mandrel. The mandrel 700 can then be cut along lines 702A-B to form pieces 700A-C. As described throughout this disclosure, the mandrel 700 can be cut along one or more additional lines into one or more different, fewer, or additional pieces 700A-C. For example, the mandrel 700 can be cut into lateral, longitudinal, and/or other configurations. The mandrel 700 can also be cut into one or more other shapes or structures, including but not limited to honeycombs, bricks, circles, spirals, and/or lattice structures.

FIG. 7B depicts individually wrapping each of the foam pieces 700A-C in carbon fiber layers 704A-C. As described herein, opposing sides and/or ends of the pieces 700A-C can be wrapped in the carbon fiber 704A-C. Wrapping all portions of the pieces 700A-C can be advantageous to improve or increase, strength, support, and/or durability of the pieces 700A-C as well as the collect mandrel 700. In some implementations, only some of the pieces 700A-C can be wrapped in carbon fiber 704A-C. In yet other implementations, one or more carbon fiber can be sandwiched between the pieces 700A-C with or without individually wrapping each of the pieces 700A-C.

FIG. 7C depicts wrapping together all the pieces 700A-C. The pieces 700A-C can be individually wrapped in carbon fiber 704A-C before being aligned/brought together. A carbon fiber layer 706 can then be wrapped around all the wrapped pieces 700A-C. As described herein, the carbon fiber layer 706 can be wrapped along opposing sides and/or ends of the collective pieces 700A-C to improve strength, support, and/or durability of the final mandrel structure.

FIG. 7D depicts a cross sectional side view and a cross sectional top view of the final mandrel structure. One heat is applied in one or more expansion processes, the foam pieces 700A-C can expand outward along x, y, and z directions towards the carbon fiber layers 704A-C and 706. The final mandrel structure can be formed with these consolidated materials and as a result can have increase strength, support, and/or durability.

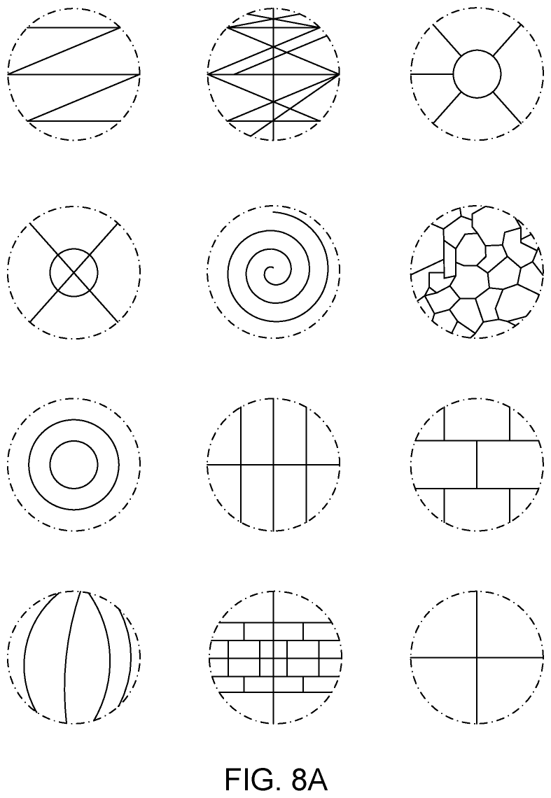

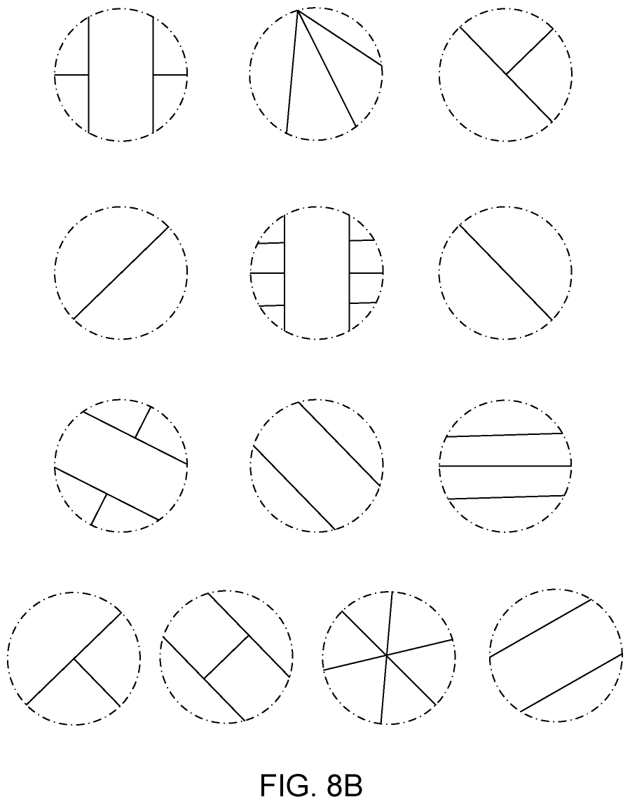

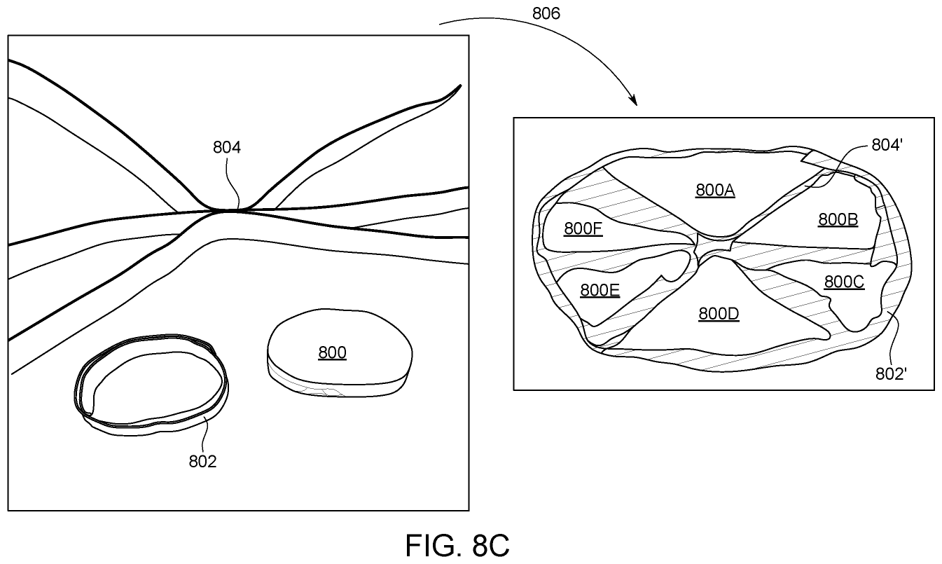

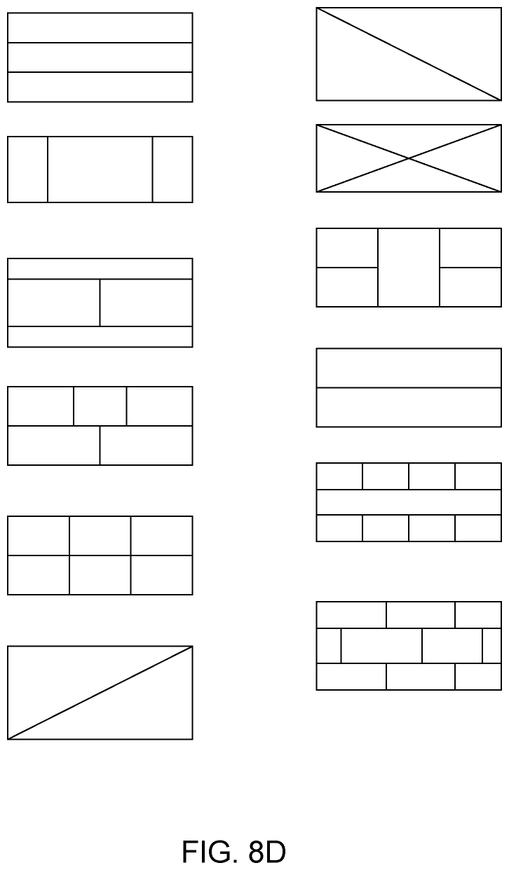

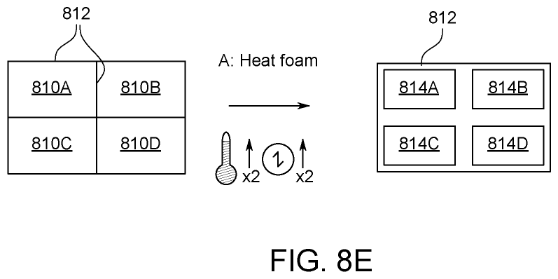

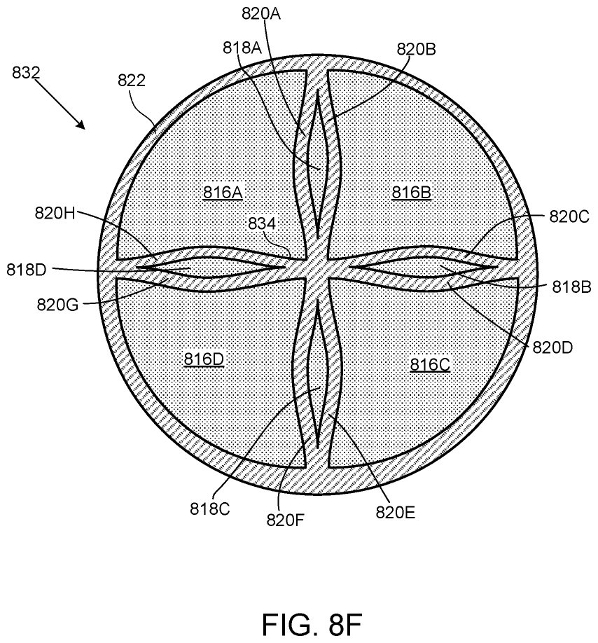

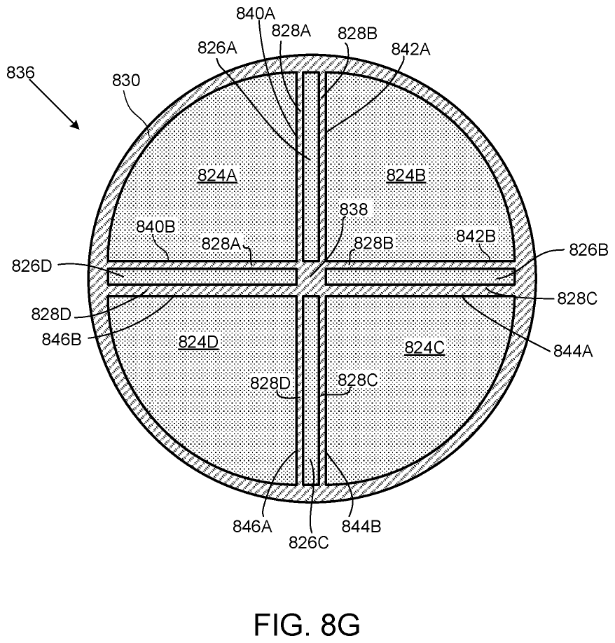

FIGS. 8A-B are example cross sectional views of reinforced carbon fiber structures having different truss arrangements. In the depicted examples, the solid lines correspond to the placement of carbon fiber using the processes described throughout this document, and the spaces between the solid lines correspond to expanding foam sections. The mandrels depicted in FIGS. 8A-B depict structures having round cross sections (e.g., cross sections of a tube or mandrel). In other implementations, rectangular or other shaped mandrels can have similar or same truss structures. The chosen truss structure for a mandrel can depend on expected load to any particular portion of the mandrel and/or desired strength, support, durability, optimization, and/or performance of any particular portion of the mandrel. As described herein, the mandrel can include multiple different portions where each portion consists of different truss structures. Therefore, in some implementations, the mandrel can have a combination of one or more of the truss structures depicted in FIGS. 8A-B. Mandrels can have layered truss structures, lattice structures, and other design structures. One or more of the structures can also be designed and created using 3D printing techniques. For example, the foam material can be 3D-printed into one or more complex or simple design structures and carbon fiber can be wrapped around such structures. As another example, carbon fiber layers can be 3D-printed into one or more complex or simple design structures and the foam material can be wrapped around such structures. When heat is applied, the foam material can expand and engulf the 3D-printed carbon fiber structure(s).

FIG. 8C depicts components used in creating a tubular mandrel 800 with dual expansion foam. As depicted, the mandrel 800 can be made of dual expansion foam as described herein. A carbon fiber layer 802 and a carbon fiber layer 804 can be cut and formed to desired shapes or sizes to wrap the foam mandrel 800. The mandrel 800 can be cut into six symmetrical or asymmetrical pieces 800A-F and wrapped (806). For example, the carbon fiber layer 804 can be wrapped around each of the pieces 800A-F. The wrapped pieces 800A-F can then be placed within the carbon fiber cutout layer 802. When heat is applied to the mandrel 800, the foam pieces 800A-F can expand outwards in x, y, and z directions against the carbon fiber layers 804 and 802, thereby causing consolidation of the layers 804 and 802 into consolidated carbon fiber layers 804′ and 802′.

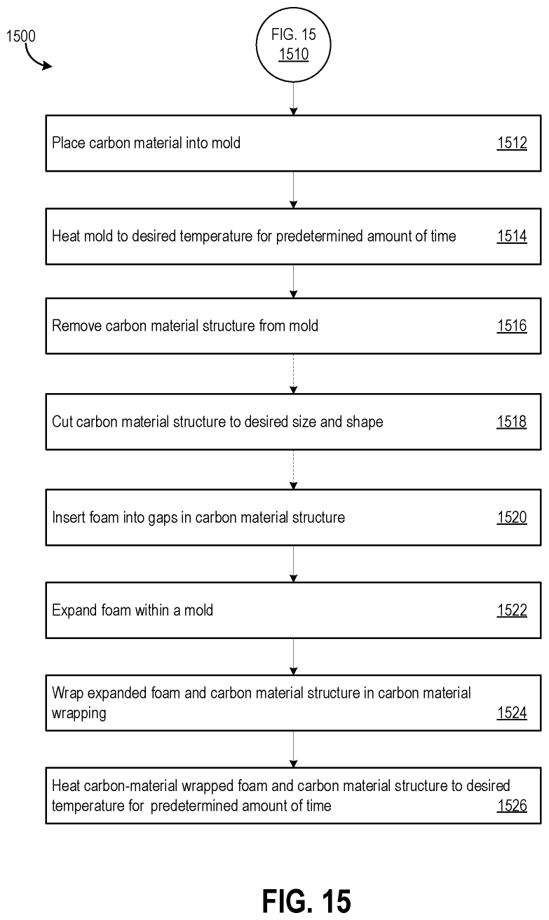

FIG. 8D depicts example cross sectional views of carbon fiber structures having different truss arrangements. The mandrels depicted in FIG. 8D can be rectangular or tubular structures. In other implementations, other shaped mandrels can have similar or same truss structures. The chosen truss structure for a mandrel can depend on expected load to any particular portion of the mandrel and/or desired strength, support, durability, optimization, and/or performance of any particular portion of the mandrel. As described herein, the mandrel can include multiple different portions where each portion consists of different truss structures. Therefore, in some implementations, the mandrel can have a combination of one or more of the truss structures depicted in FIG. 8D and/or one or more structures depicted in FIGS. 8A-B. Mandrels can have layered truss structures, lattice structures, and other design structures. One or more of the structures can also be designed and created using 3D printing techniques. For example, the foam material can be 3D-printed into one or more complex or simple design structures and carbon fiber can be wrapped around such structures. As another example, carbon fiber layers can be 3D-printed into one or more complex or simple design structures and the foam material can be wrapped around such structures. When heat is applied, the foam material can expand and engulf the 3D-printed carbon fiber structure(s) (e.g., refer to FIGS. 15A-B).

FIG. 8E is a conceptual diagram of creating a mandrel by removing dual expansion foam therein. In some implementations, a mandrel can be formed with dual expansion foam and some or all of that foam can be cored out of a resulting mandrel. One or more chemical processes and/or tools can be used to remove the foam. This process can be advantageous to reduce any amount of weight that the foam may add to the resulting mandrel. This process can be advantageous to remove any additional foam that was added for constructing the resulting mandrel but not required for providing support, strength, or durability to the resulting mandrel. This process can also be advantageous to form desired channels, shapes, or other gaps or cavities within the resulting mandrel without compromising on strength of the resulting mandrel.

As depicted in FIG. 8E, the mandrel can be made up of four dual expansion foam pieces 810A-D. The foam pieces 810A-D can be wrapped in carbon fiber 812, as described throughout this disclosure. Heat can be applied to the foam pieces 810A-D wrapped in carbon fiber 812 (A). In some implementations heat can be applied during one expansion process. In other implementations, heat can be applied during two expansion processes, where a first expansion process is to achieve a near net shape of the mandrel and a second expansion process is to achieve a full shape of the mandrel. Once heat is applied and the foam pieces 810A-D expand to a desired shape (e.g., near net or full shape), one or more of the foam pieces 810A-D can be drilled out from the resulting mandrel (B). The resulting mandrel can have the carbon fiber 812 in a shape that the carbon fiber 812 was wrapped around the foam pieces 810A-D and then consolidated to from expansion of the foam pieces 810A-D. Once the foam pieces 810A-D are removed, cavities 814A-D are formed in the resulting mandrel.

In some implementations, the cavities 814A-D can extend a length of the mandrel (e.g., from a first end to a second end). Therefore, the resulting mandrel can have channels therein that can be used to thread or run wires, cables, or other materials through. In other implementations, the cavities 814A-D can extend along only a length of the mandrel (e.g., from one end of the mandrel to a halfway point in the mandrel). One or more other configurations can be realized based on a desired weight of the mandrel, expected load or force on one or more portions of the mandrel, one or more different truss structures or shapes within the mandrel, and/or a desired performance, optimization, strength, and/or support in one or more portions of the mandrel. FIG. 8F depicts an example cross sectional view of a mandrel 832 having a truss structure 834 reinforced with layers of dual expansion foam 818A-D. The mandrel 832 includes dual expanding foam structures 816A-D. The truss structure 834 of the mandrel 832 can be formed by layering carbon fiber layers with dual expanding foam between such layers. Thus, the truss structure 834 can form sandwich panels for added reinforcement, strength, and durability of the resulting mandrel 832.

For example, to form the truss structure 834, a first carbon fiber layer 820A can be layered with a second carbon fiber layer 820B. Between the layers 820A and 820B, a piece of dual expanding foam 818A, which has already undergone an initial expansion, can be positioned. Similarly, a third carbon fiber layer 820C can be layered with a fourth carbon fiber layer 820D and a second dual expanding foam structure 818B positioned therebetween. A fifth carbon fiber layer 802E can be layered with a sixth carbon fiber layer 802F with a third dual expanding foam structure 818C positioned therebetween. A seventh carbon fiber layer 820G can be layered with an eighth carbon fiber layer 820H and a fourth dual expanding foam structure 818D positioned therebetween.

In some instances, the truss structure 834 collectively and/or its individual components (e.g., carbon fiber layer 820A-B and foam 818A) can be initially formed and cured in an truss form—resulting in sandwich panel-type trusses that can be placed within other carbon fiber structures that are formed, as described throughout this document. In other instances, the uncured carbon fiber layers 820A-H, with foam 818A-D sandwiched between them, can be placed between and/or around the near net shaped dual expanding foam structures 816A-D, which may be collectively wrapped together by an uncured carbon fiber outer layer 822. Heat can be applied such that the dual expanding foam structures 816A-D and the foam 818A-D can expand, applying pressure to position the carbon fiber layers 818A-D and 822 as they achieve the full shape of the resulting mandrel 832 and harden during the curing process.

FIG. 8G depicts another example cross sectional view of a mandrel 836 having a truss structure 838 reinforced with dual expansion foam 826. The mandrel 836 includes dual expanding foam structures 824A-D. The truss structure 838 of the mandrel 836 can be formed by layering carbon fiber layers with dual expanding foam between such layers, thereby creating sandwich panels. As shown, the dual expanding foam layered between the carbon fiber layers can extend across an entirety of the truss structure 838. The truss structure 838 can form sandwich panels for added reinforcement, strength, and durability.

To form the truss structure 838, a first carbon fiber layer 828A can be layered with a second carbon fiber layer 828B along a first side 840A of the first carbon fiber layer 828A and a first side 842A of the second carbon fiber layer 828B. The second carbon fiber layer 828B can also be layered with a third carbon fiber layer 828C along a second side 842B of the second carbon fiber layer 828B and a first side 844A of the third carbon fiber layer 828C. The third carbon fiber layer 828C can also be layered with a fourth carbon fiber layer 828D along a second side 844B of the third carbon fiber layer 828C and a first side 846A of the fourth carbon fiber layer 828D. Finally, the fourth carbon fiber layer 828D can be layered with the first carbon fiber layer 828A along a second side 846B of the fourth carbon fiber layer 828D and a second side 840B of the first carbon fiber layer 828A.

Dual expanding foam 826A can be sandwiched or otherwise positioned/placed between the carbon fiber layers 828A and 828B, dual expanding foam 826B can be positioned between the carbon fiber layers 828B and 828C, dual expanding foam 826C can be positioned between the carbon fiber layers 828C and 828D, and dual expanding foam 826D can be positioned between the carbon fiber layers 828D and 828A. In some implementations, one or more fewer or additional dual expanding foam pieces can be positioned between any of the carbon fiber layers 828A-D to form sandwich panels.

The truss structure 838 can be formed using the heating process(es) described in reference to FIG. 8F.

The truss structures 834 and 838 described in reference to FIGS. 8F-G can provide additional strength to the resulting mandrels 832 and 836. Separating carbon fiber layers with dual expanding foam structures can provide for the additional strength. In some implementations, doubling a volume between carbon fiber layers and filling that volume with dual expanding foam can quadruple the strength of the resulting mandrel. Moreover, the truss structures 834 and 838 can further reduce vibrations throughout the mandrels 832 and 836, provide for better transfer of load and weight, reduce likelihood of catastrophic failures, and provide for lighter weight mandrels 832 and 836.

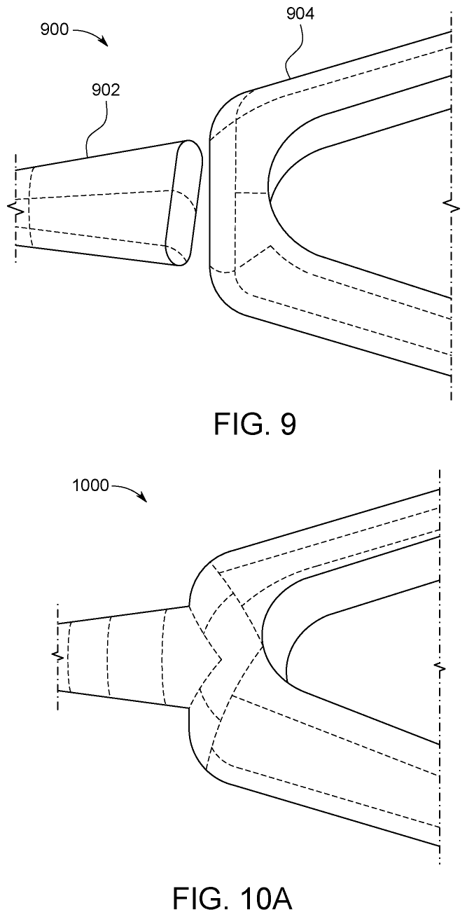

FIG. 9 depict example mandrel pieces having different dual expansion foam segments. A final mandrel structure 900 can be a fork for a bicycle frame. The mandrel structure 900 can be made up of two smaller mandrels 902 and 904. The mandrel structure 900 can be made up of one or more additional mandrels. The smaller mandrels 902 and 904 can be formed separately and then coupled or attached to each other to form the final mandrel structure 900. For example, each of the mandrels 902 and 904 can be individually formed to near net shape, cut into pieces that are individually wrapped in carbon fiber, then wrapped collectively in carbon fiber. Each of the mandrels 902 and 904 can be heated individually to form near net shapes and/or full shapes. The mandrels 902 and 904 can then be attached to each other to form the final mandrel structure 900. In some implementations, each of the smaller mandrels 902 and 904 can be formed to near net shape. Once attached to each other, the full mandrel structure 900 can be wrapped in one or more layers of carbon fire. Heat can then be applied to the full mandrel structure 900 such that the full mandrel structure 900 can expand to a full shape.

As depicted in FIG. 9, each of the smaller mandrels 902 and 904 can be cut into different shapes or pieces to form trusses from carbon fiber surrounding or affixed to the segments, as demarcated by the dashed lines. Once cut into the different pieces, each of the pieces can be individually wrapped with carbon fiber along the dashed lines. In other implementations, the carbon fiber can be sandwiched or placed between each of the pieces of the mandrels 902 and 904 along the dotted lines.

Forming the mandrel structure 900 from two smaller mandrel pieces 902 and 904 can be advantageous when different carbon fiber truss structures are desired. For example, the mandrel 902 can be cut up into a plurality of lateral segments. Each of those lateral segments can be individually wrapped one or more times in carbon fiber to provide corresponding carbon fiber truss structures. This formation of the mandrel 902 can be beneficial because the mandrel 902 may have significant load or force exerted thereon. The mandrel 904, on the other hand, may not have significant load or force exerted thereon. Therefore, a different foam section and carbon fiber truss structure can be desired for the mandrel 904 in comparison to the mandrel 902. Forming the mandrels 902 and 904 with different carbon fiber truss structures, volumes of dual expansion foam, and/or quantities of carbon fiber can help distribute weight evenly throughout the overall mandrel structure 900 and/or where force or load is expected to be the greatest.

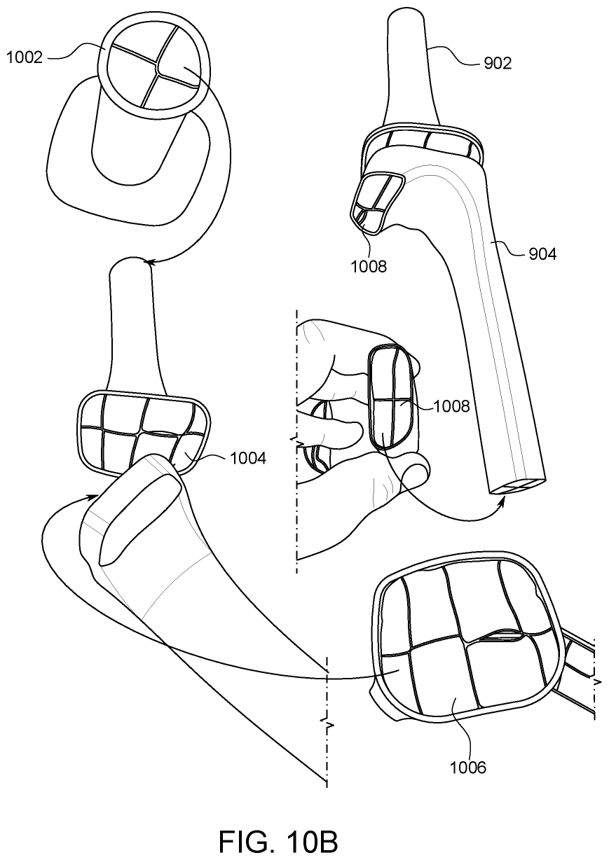

FIG. 10A is an example unitary mandrel 1000 having different dual expansion foam segments. In comparison to the mandrel 900 in FIG. 9, the mandrel 1000 is a unitary structure. In other words, the mandrel 1000 can be formed from one piece of dual expansion foam material. For example, the foam can be expanded into a near net shape of the final mandrel 1000 using a heating process as described herein. The mandrel 1000 can then be cut into one or more foam segments, as demarcated by the dashed lines in FIG. 10. Each of the cut foam segment can be individually wrapped in carbon fiber. In other implementations, carbon fiber can be sandwiched or placed between each of the cut foam segments of the mandrel 1000. Another layer of carbon fiber can wrap around the mandrel 1000. Heat can be applied to the mandrel 1000 to expand the mandrel 1000 to its full shape, as described herein. One or more other processes described herein can be used to form the unitary mandrel 1000.

FIG. 10B is an example mandrel separated into pieces having different dual expansion foam segments. In FIG. 10B, the smaller mandrel pieces 902 and 904 of FIG. 9 are depicted. The mandrel 902 can be a fork crown 902 for a bicycle frame structure. The mandrel 904 can be a fork blade 904 for the bicycle frame structure. Each of the fork crown 902 and the fork blade 904 can have an external carbon fiber wrap. Moreover, the fork crown 902 and the fork blade 904 can be in their full shapes. In other implementations, the fork crown 902 and the fork blade 904 can be in their near net shapes.

The fork crown 902 can have different carbon fiber truss structures therein. For example, a top end of the crown 902 and a portion of the fork crown 902 can have a first truss arrangement 1002 in which the foam segments are cut into quarters. Further down the fork crown 902 and closer to an end where the crown 902 is attached to the fork blade 904, the crown 902 can have a second truss arrangement 1004. In this example, the second truss arrangement 1004 can have the foam segments cut into 8 pieces that are surrounded by carbon fiber to provide the depicted truss arrangement. One or more other structures can be realized and implemented for the fork crown 902.

The fork blade 904 can also have different carbon fiber truss structures therein. For example, a top end of the fork blade 904 where the blade 904 attaches to the fork crown 902 can have a third truss arrangement 1006. In FIG. 10B, the third truss arrangement 1006 is the same as the second truss arrangement 1004. This can be advantageous to ensure that when the crown 902 and blade 904 are attached, the resulting mandrel is structurally strong at that attachment point. The resulting mandrel may not fracture or break at the attachment point when force or load is applied there. In other implementations, the third truss arrangement 1006 can be any other desired structure. The fork blade 904 can also have a fourth truss arrangement 1008. The fourth truss arrangement 1008 can extend through one or more portions of the fork blade 904 and/or down to an end of the blade 904 opposite the end that attaches to the fork crown 902. In the example of FIG. 10B, the fourth truss arrangement 1008 has foam segments cut in blocks or quarters.

In some implementations, the fork crown 902 and the fork blade 904 can be formed from a unitary mandrel structure. After a first heating expansion process, the unitary mandrel structure can be cut into the fork crown 902 and the fork blade 904. Each of the crown 902 and blade 904 can be cut further into foam sections, as described herein, and molded to their full shapes. The full shaped crown 902 and blade 904 can then be attached together to form the final mandrel structure (e.g., a bicycle fork). One or more other processes, as described herein, can be performed to create the fork crown 902, the fork blade 904, and/or the final fork structure.

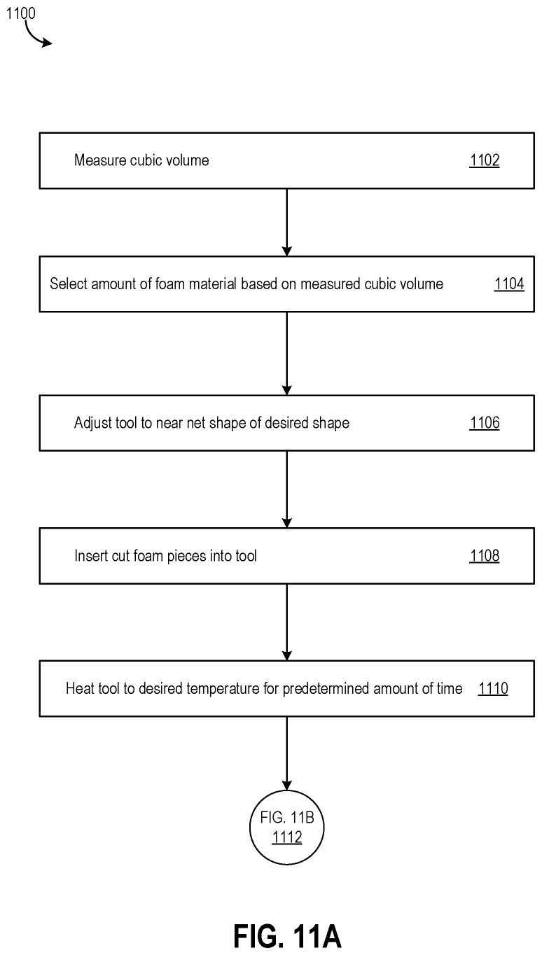

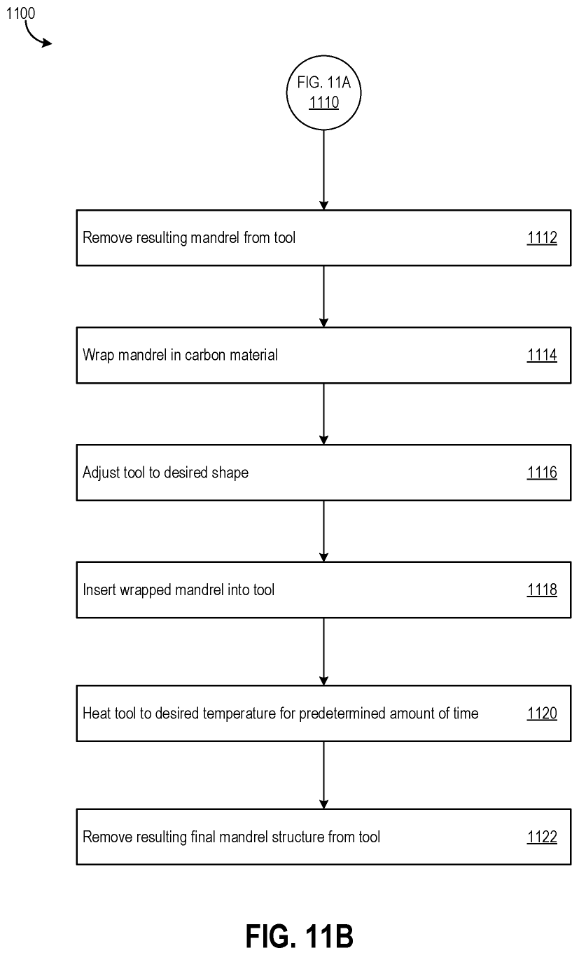

FIGS. 11A-B is a flowchart of a process 1100 for building a reinforced carbon fiber structure with dual expansion foam segments. Referring to both FIGS. 11A-B, a cubic volume of the mandrel can be determined and measured in 1102. An amount of pre-expanded foam material as described herein can be selected based on the measured cubic volume in 1104. For example, the foam material can be cut up into multiple pieces that, when combined and heated, will form the full shaped foam mandrel.

A mold or tool, as described herein, can be adjusted to a near net shape of the desired shape for the mandrel in 1106. The cut pieces of foam can then be inserted into the tool in 1108. In some implementations, the tool can be set to a near net shape for one of the cut pieces of foam. In other implementations, the tool can be set to the near net shape for the final mandrel.

Heat can be applied to the tool in 1110. This can be a first expansion process. A desired temperature can be used for a predetermined amount of time. The temperature can be a lower temperature that provides for the foam pieces to expand without expanding a maximum amount that the foam pieces are able to expand to. Therefore, during a second expansion process, the temperature can be higher than the temperature of the first expansion process such that the foam pieces can expand their maximum amount.

Once heat is applied and the foam pieces expand within the tool to the near net shape, the resulting mandrel can be removed from the tool in 1112. Because of the application of heat in 1110, the foam pieces can mold or blend into each other to form a unitary mandrel structure. This unitary mandrel structure can be wrapped in a carbon fiber material in 1114.

The tool can be adjusted to the desired shape for the final mandrel structure in 1116. The desired shape can be a full shape of the final mandrel. In some implementations, a different mold or tool can be used and/or set to the desired shape for the final mandrel structure.

The wrapped mandrel can be inserted into the tool in 1118. Heat can then be applied to the tool in 1120. As mentioned above, this can be the second expansion process. A desired temperature can be used for a predetermined amount of time. The temperature for the second expansion process can be higher than the temperature for the first expansion process. Therefore, the foam within the carbon fiber wrap can expand to its maximum amount within the carbon fiber wrap and fill out any cavities or gaps therein. Once the foam expands within the carbon wrap, the resulting final mandrel structure can be removed from the tool in 1122.

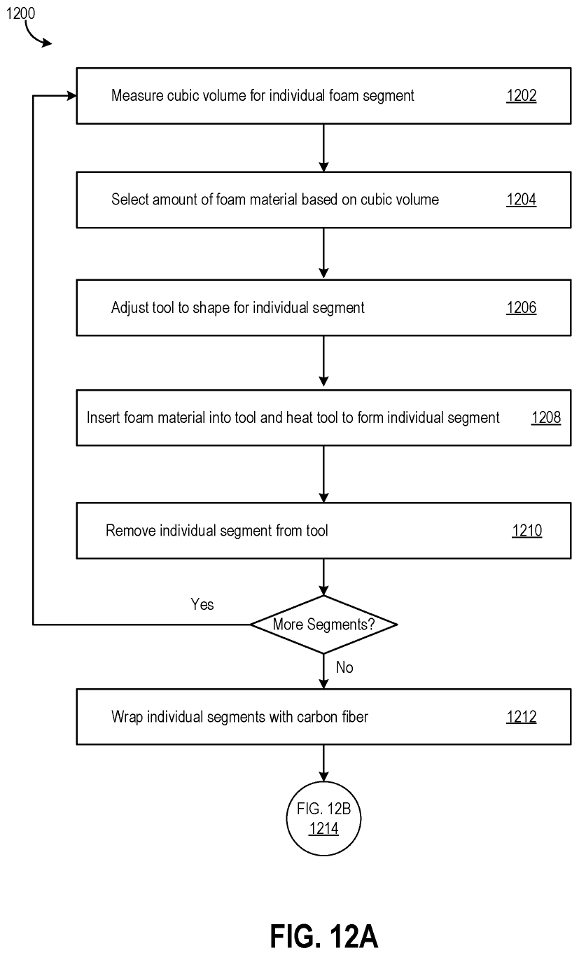

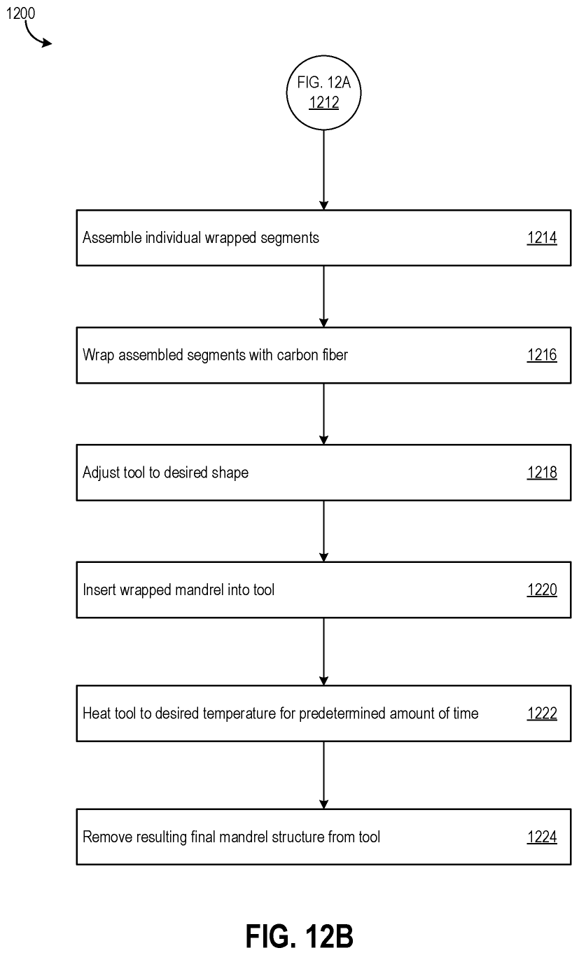

FIGS. 12A-B is a flowchart of another process 1200 for building a mandrel with dual expansion foam segments that are individually formed and wrapped in carbon fiber. Referring to both FIGS. 12A-B, a cubic volume can be determined and measured for each individual foam segment in 1202. An amount of foam material can be selected based on the measured cubic volume in 1204. A tool or mold can be adjusted to a shape for an individual foam segment in 1206. The foam material for the individual segment can be added to the tool and heat can be applied to the tool in 1208. A first target temperature can be used for a predetermined amount of time to cause a first expansion of the foam. The individual foam segment can then be removed from the tool 1210. If more individual segments still need to be performed, the steps 1202-1210 can be repeated for each individual foam segment.

Once all of the individual foam segments have been generated, they can each be individually wrapped (or otherwise have carbon fiber applied to a portion of their outer surface) at 1212. Referring to FIG. 12B, the wrapped individual foam segments can then be assembled into a combined superstructure (1214) that is then wrapped with carbon fiber (1216). The tool can be adjusted to the desired shape in 1218. The desired shape can be the full shape of the final shape for the reinforces carbon fiber structure. In some implementations, a different tool or mold can be used in 1218. The wrapped mandrel can be inserted into the tool in 1220.

Heat can be applied for a second time to the tool in 12222. A second temperature can be used for a predetermined amount of time, and the second temperature can be hotter than the first temperature for the first expansion. As described herein, this can be a second expansion of the foam that causes the individual foam segments to further expand within the individual carbon wraps and the exterior carbon wrap. The resulting final mandrel structure can be removed from the tool in 1224, once the foam pieces have expanded a maximum amount to fill out any cavities or gaps between the foam pieces, the individual carbon wraps, and/or the external carbon wrap.

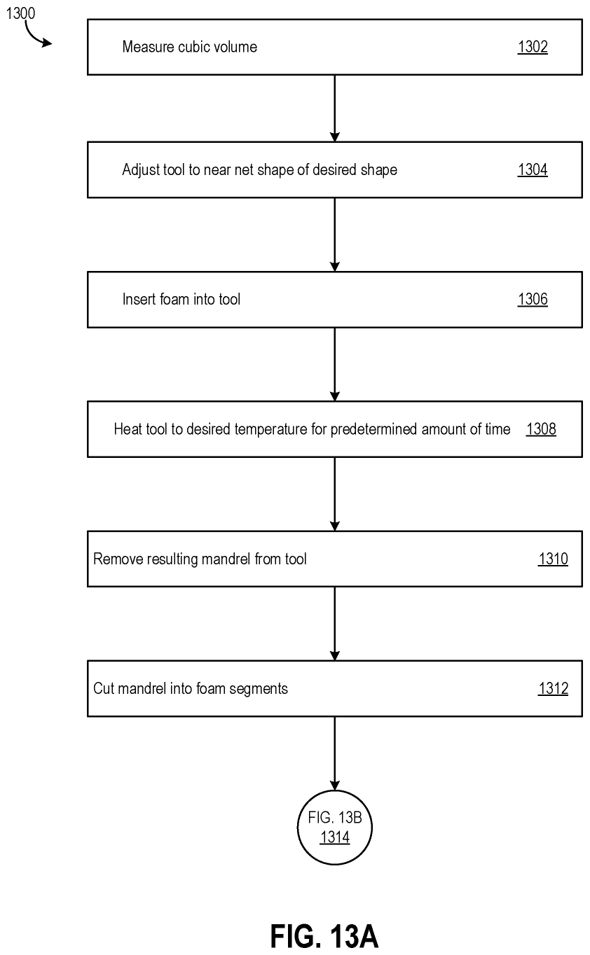

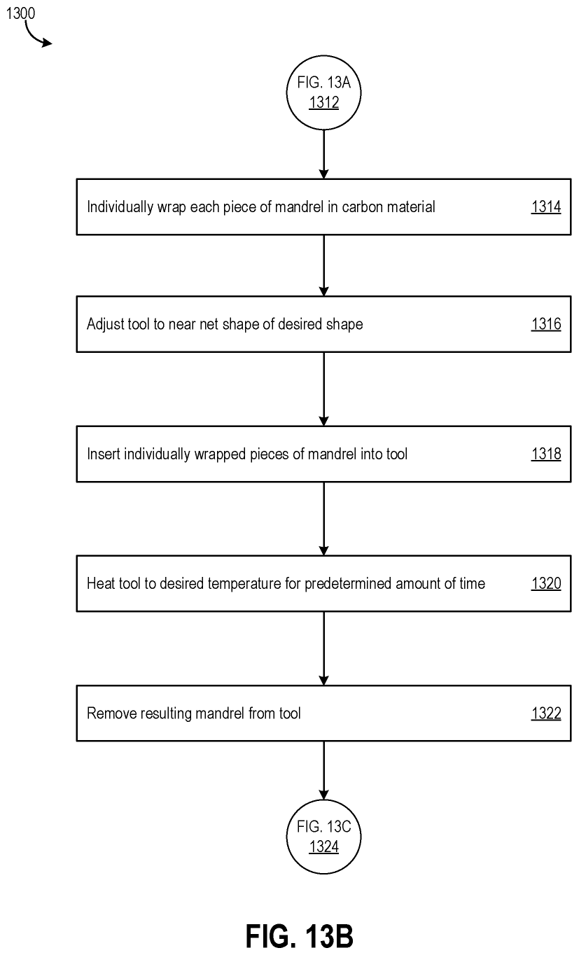

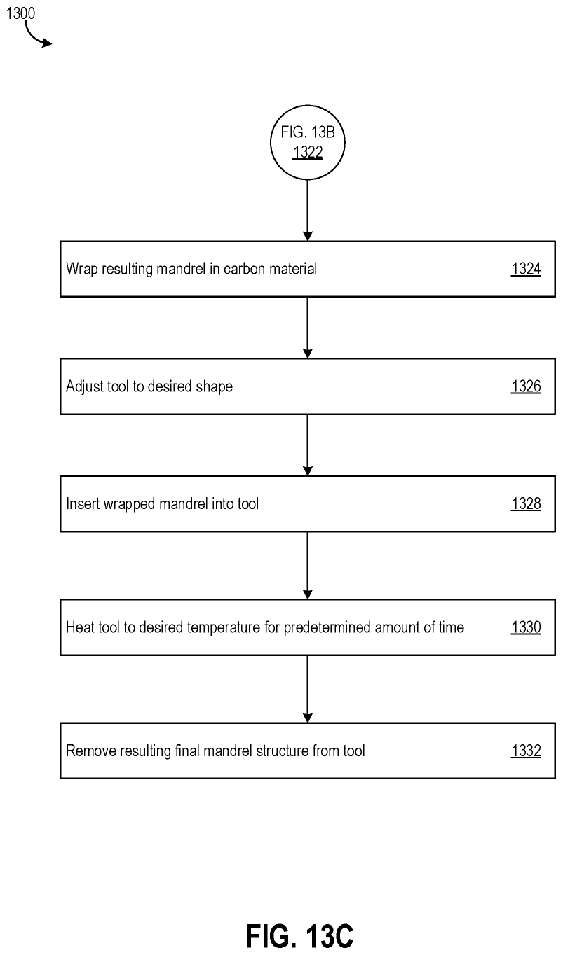

FIGS. 13A-C is a flowchart of another process 1300 for building a mandrel with dual expansion foam segments. The process 1300 can be used to form a near net shape mandrel, which can then be cut into separate pieces. Referring to FIGS. 13A-C, a desired cubic volume can be determined and measured in 1302. A tool can be adjusted to a near net shape of a desired shape in 1304. This shape adjustment can be made based on the determined cubic volume. A pre-expanded foam material can be inserted into the tool in 1306. Heat can be applied to the tool at a desired temperature for a predetermined amount of time in 1308. The foam material can expand to fill out the near net shape of the tool. Once the foam is expanded to the near net shape, a near net shape mandrel is formed. This resulting mandrel can be removed from the tool in 1310.

The mandrel can then be cut into individual foam segments in 1312. One or more different cuts or foam segments can be chosen for the mandrel based on a desired strength, durability, stability, and/or expected load or force on one or more portions of the mandrel. Each of the cut pieces can be individually wrapped in carbon fiber material in 1314.

The tool can then be adjusted to a near net shape of the desired shape in 1316. The individually wrapped pieces of the mandrel can be inserted into the tool in 1318. Heat can be applied to the tool at a desired temperature for a predetermined amount of time in 1320. The foam pieces can expand within their individual wraps to the near net shape, then the resulting mandrel can be removed from the tool in 1322. In some implementations, 1316-1322 can be skipped.

The resulting mandrel can be wrapped in a carbon fiber material in 1324. For example, where 1316-1322 are skipped, the individually wrapped foam pieces can be grouped together and collectively wrapped in the carbon fiber material. Where 1316-1322 are performed, the mandrel resulting from the foam expanding within their individual wraps to the near net mandrel shape can be wrapped in the carbon fiber material.

The tool can be set to the desired shape for the final mandrel structure in 1326. The wrapped mandrel can then be inserted into the tool in 1328. Heat can be applied to the tool at a desired temperature for a predetermined amount of time in 1330. The foam pieces can therefore expand to fill any cavities or gaps between the foam pieces, the individually wrapped carbon, and the exterior carbon wrap around the mandrel. Once the foam pieces are fully expanded to a maximum amount or the desired shape, the final mandrel structure can be removed from the tool in 1332.

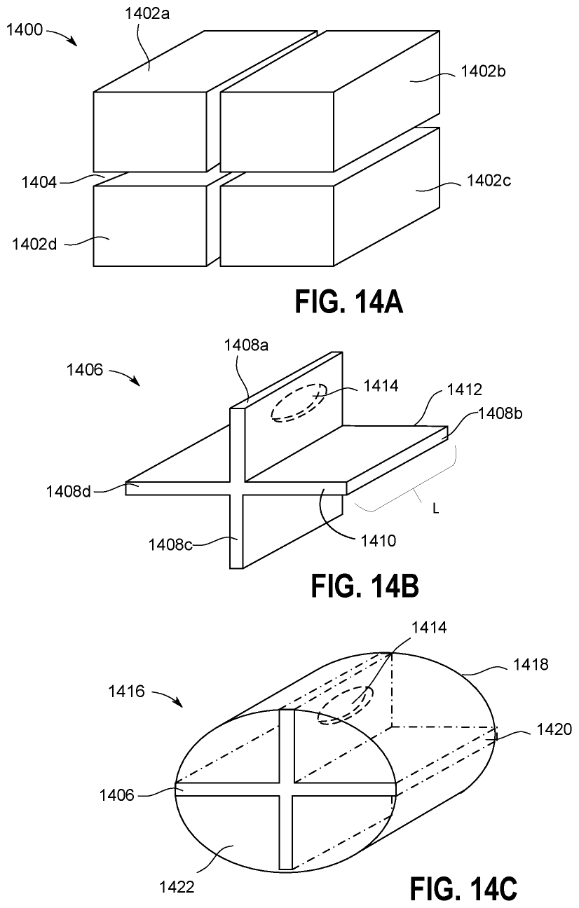

An alternative method of manufacturing internal carbon fiber support structures within a carbon fiber wrapping is illustrated in FIGS. 14A-C. FIG. 14A shows an example mold 1400 formed from four rectangular tubes 1402a-d. The rectangular tubes 1402a-d are spaced apart from one another to form a negative space 1404, shaped as a cross or T structure in this illustrative example. The rectangular tubes 1402a-d can be hollow or solid, and may be arranged to form alternative shapes in the negative space between them. Carbon fiber in its pre-preg form (mixed with epoxy or another material) can be inserted into the negative space 1404 between the rectangular tubes 1402a-d. The mold and carbon fiber can then be heated to a predetermined temperature for a predetermined length of time to cure the carbon fiber structure, causing it to take the shape of the negative space 1404 formed between the rectangular tubes 1402a-d. The size, shape and texture of the four rectangular tubes 1402a-d can be varied in order to produce carbon fiber support structures with different parameters. The distance between the four rectangular tubes 1402a-d forming the negative space 1404 can be varied to alter the thickness of the resulting carbon fiber support structure. In some implementations, the four rectangular tubes 1402a-d are spaced apart so as to produce a carbon fiber support structure having a thickness of one of 0.5 mm, 0.75 mm, 1 mm, 1.25 mm, 1.5 mm, 1.75 mm, 2 mm, 2.25 mm, 2.5 mm, 3 mm, 5 mm, or any other suitable thickness. In some implementations, the four rectangular tubes 1402a-d are spaced apart so as to produce a carbon fiber support structure having a thickness that varies along a length of the structure. In some implementations, the four rectangular tubes 1402a-d are positioned so as to produce a carbon fiber support structure having one or more arms of different thickness than another arm of the structure.

An example of the carbon fiber support structure 1406 produced by the mold of FIG. 14A is shown in FIG. 14B. The cured carbon fiber takes on the shape of the negative space between the rectangular tubes 1402a-d of the mold 1400 through the heating process and can then be used as a support structure within carbon fiber tubing, or in other uses. The example carbon fiber support structure 1406 is X-shaped and has arms 1408a-d. The carbon fiber support structure 1406 also has a front edge 1410 and a back edge 1412, and a length L between the front edge 1410 and the back edge 1412. The carbon fiber support structure 1406 optionally includes one or more apertures 1414 through one or more of the arms 1408a-d.

As described above, the shape of the carbon fiber support structure can be altered by changing the shape of the negative space of the mold, for example forming a structure which is H-shaped or T-shaped, or any other desired structure. In some implementations, the mold can be designed to provide a lattice type carbon fiber support structure. In some implementations, a web-like carbon fiber support structure can be obtained by the use of a mold or by injection molding techniques. In some implementations, the mold of FIG. 14A can be used to create carbon fiber support structures of a predetermined length which can then be cut down to a desired size in length L of the structure from the front edge 1410 to the back edge 1412, or in the relative lengths of the arms of the structure. In some implementations, the mold of FIG. 14A is sized and shaped so as to create a carbon fiber support structure having the desired length L without cutting. The mold can also include additional features to be transferred to the carbon fiber support structure, such as apertures 1414 in the arms, threading on or within the structure, or other features as will be described below. In some implementations, features such as apertures, holes, texture, and threading are added to the structure after the carbon fiber support structure 1406 is formed in the mold. The aperture 1414 in the arm of the carbon fiber support structure 1406 can decrease a weight of a final component created using the carbon fiber support structure 1406, can allow tubing, wires, or other objects to be inserted or threaded through the carbon fiber support structure 1406, or can allow foam to be inserted about the structure as a continuous and unitary foam structure rather than in discrete cavities about the carbon fiber support structure 1406. The presence of a unitary foam structure within the final component provides additional strength to the component and reduces risk of failure of the component. Additionally, the unitary foam structure can serve to dampen vibrations through the carbon fiber structure or reduce the accumulation and/or presence of debris (and in some cases, moisture) within the carbon fiber structure.

FIG. 14C is an example of an internally supported carbon fiber component 1416 produced using the carbon fiber support structure 1406 of FIG. 14B. A dual-expansion foam 1422 is distributed about the carbon fiber support structure 1406. An initial expansion of the dual-expansion foam 1422 is triggered by heating the foam-wrapped carbon fiber support structure 1406 to a predetermined temperature for a predetermined period of time. The initial expansion of the dual expansion foam 1422 may occur within a mold to guide the shape of the expanded foam. The dual expansion foam 1422 can be added around the carbon fiber support structure 1406 in discrete portions, such as those divided by the arms 1408a-d, or can be added as a continuous foam structure by including apertures such as aperture 1414. Providing a continuous and unitary foam structure may increase the strength and stability of the resulting internally supported carbon fiber component 1416, as described above.

The foam-wrapped carbon fiber support structure 1406 is wrapped in a layer of pre-preg carbon-fiber 1418, and the carbon-fiber wrapped structure is placed into a mold and cured by exposure to a predetermined temperature for a predetermined period of time. The elevated temperature triggers a second expansion of the dual-expansion foam 1422 which pushes the pre-preg carbon fiber 1418 wrapping outward toward the interior walls of the mold and into its final shape forming the exterior of the internally supported carbon fiber component 1416. To ensure a good connection between the internal carbon fiber support structure 1406 and the exterior carbon fiber wrapping 1418, the foam may be scraped away where it may have covered the edge 1420 of the arms of the carbon fiber support structure 1406. The edge 1420 is then exposed to the exterior carbon fiber wrapping 1418 where the carbon fiber can form a strong bond when heated. Additionally or alternatively, additional carbon fiber or bonding agent can be deposited on the foam structure at the edge 1420 to encourage good bonding between the internal carbon fiber support structure 1406, the surrounding dual expansion foam 1422, and the exterior carbon fiber wrapping 1418.

In some implementations, the carbon fibers in the pre-preg used in formation of the carbon fiber support structure and/or the carbon fiber wrapping are oriented to produce beneficial strain patterns depending on the intended purpose of the internally supported carbon fiber component 1416. As described above, the shape of the internally supported carbon fiber component 1416 can be altered by changing one or more of the initial mold 1400 forming the internal carbon fiber support structure 1406, cutting the internal carbon fiber support structure 1406, altering the shape of the mold in which the foam undergoes its first or second expansion, or cutting the internally supported carbon fiber component 1416 after it has been produced. Different internal and external shapes of the internally supported carbon fiber component 1416 may be beneficial depending on the strains and stresses expected to be incident on the component in its intended use. For example, the internal shapes described above in FIGS. 8A-8B could be used in the production of an internally supported carbon fiber component 1416 for various uses based on an analysis of the forces the internally supported carbon fiber component 1416 is expected to undergo (e.g., different directional forces, different types of forces, such as torsional forces, tensile forces, compressive forces, etc.). The formation of pre-cured crossbeams or other support structures using a mold as described in FIG. 14A can enable efficient production of a variety of components that can be incorporated into a final device, such as a bicycle.

FIG. 15 is a flowchart of a process 1500 for producing a supported carbon fiber object. The process begins at step 1510 with the determination of the type of internally supported carbon fiber object to be produced. At step 1512, pre-preg carbon fiber material is placed into a mold suited to the final type of type of internally supported carbon fiber object to be produced. In some implementations, the mold is specific to the type of object being produced, and may include not only a negative space in which the carbon fiber material is inserted, but additional features to be imparted to the carbon fiber structure, such as features designed to produce apertures in the carbon fiber structure or to impart texture to the structure. In some implementations, the mold is generic and is used to efficiently mass produce carbon structures which can then be sized or otherwise altered to suit their intended purpose.

At step 1514, the mold is heated to a desired temperature for a predetermined amount of time. The time and temperature which may be appropriate are discussed in detail above. At step 1516, the carbon material structure is removed from the mold. The carbon material structure (also called internal supporting structure, truss, or truss structure herein) can be formed in a variety of shapes depending on the forces that the final component is expected to encounter. Optionally, at step 1518, the carbon material structure is cut to the desired shape and size for the final component. Additional alterations may be made to the carbon material structure at this point, including the addition of apertures, texturing, or shaping of the carbon material structure. The carbon fiber structure can be cut to the desired length, shape, or size using a high-powered water jet, CNC machine, or other apparatus for cutting.

At step 1520, foam is inserted into the gaps in the carbon material structure. The foam can be a dual-expansion foam, as described in detail above. The foam can be inserted into the gaps in the structure as discrete foam pieces, or in a continuous unitary foam structure which extends through apertures in the structure. At step 1522, the foam undergoes a first expansion event by heating the foam wrapped structure to a predetermined temperature for a predetermined period of time. The foam expands to fill the structure. If desired, prior to heating the foam and structure, the foam-wrapped structure is inserted into a mold which guides the expansion of the foam into a desired shape. The initial expansion of the foam around the carbon material structure provides the mandrel or near-net shape as described above.

At step 1524, the foam and carbon material structure is wrapped in a carbon material wrapping. The carbon material wrapping may be a single layer of carbon fiber material, or more layers of carbon fiber material. The carbon fibers may be positioned in the material with a particular orientation so as to provide enhanced support and strength in response to various forces on the final structure, for example directional forces, torsional forces, tensile forces, and compressive forces. In some implementations, to improve bonding between the carbon material structure and the carbon fiber wrapping, the foam is removed from the edges of the carbon material structure so that it is exposed to the carbon fiber wrapping. This can be accomplished by carving foam away to expose the edges of the structure, or by otherwise preventing foam from covering the ends. Alternatively or additionally, pre-preg carbon fiber or epoxy can be added as a layer between the carbon material structure and the carbon fiber wrapping to encourage bonding between the structure and the carbon fiber wrapping.

At step 1526, the carbon-material wrapped foam and carbon material structure is heated to a desired temperature for a predetermined period of time. The carbon-material wrapped foam and carbon material structure can be inserted into a mold prior to this step. The second heating step causes a second expansion event of the foam, expanding the foam outward and pushing the carbon fiber wrapping into the shape of the mold to create the final carbon fiber component. The expanding foam provides the outward pressure to form the carbon fiber structure and adhere the carbon fiber wrapping to the shape of the mold. The method illustrated in FIGS. 14 and 15 is applicable to the manufacture of any of the components described above and those that will be described in the following.

While two expansion events of the foam are described above, in some implementations the foam is heated and expanded only after the foam and internal carbon structure are wrapped in the carbon fiber wrapping. In this way, various types of expanding foam can be used in the manufacturing process, including dual-expansion foam types as well as single-expansion foam.

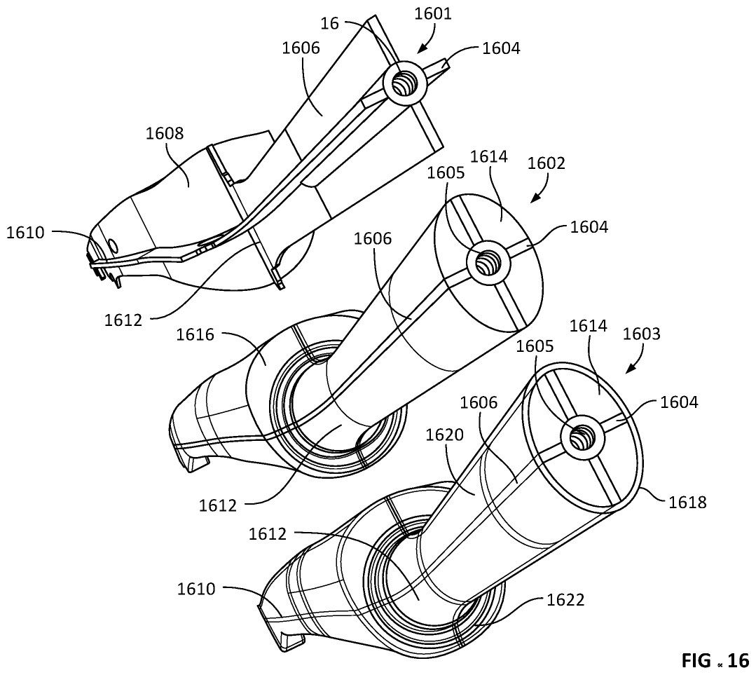

FIG. 16 depicts the application of the above-described process to the formation of a product, illustrating the stages of the process for production of an internally supported carbon fiber bicycle fork. FIG. 16 shows the bicycle fork in a first stage of production 1601 in which the carbon fiber internal support structure is produced, a second stage of production 1602 in which foam is added to the support structure, and a third stage of production 1603 in which the foam and carbon support structure are wrapped in the carbon fiber wrapping.

The first stage of production 1601 is the formation of the internal carbon fiber support structure 1604. The carbon fiber support structure 1604 for the bicycle fork is shaped as an X-shape with arms of varying extension along the length which extends to form the steerer tube 1606 of the fork. The carbon fiber support structure 1604 includes a threaded cavity 1605 to allow easy attachment of the star nut to attach the fork to the headset. The carbon fiber support structure 1604 further includes an X-shaped portion forming the crown 1608 with longitudinal truss 1610 extending down the fork legs toward the dropouts where the wheel will be connected. As illustrated, the carbon fiber support structure 1604 can include support sections which are straight, such as the steerer tube section, as well as more complex shapes such as the crown and fork leg sections. The connection 1612 at the crown between the steerer tube section and the fork leg section is shown here to illustrate the underlying carbon fiber internal support structure 1604 of the bicycle fork in its entirety, though the pieces may be separately formed and attached later in the process or may be formed as a unitary article. The size of the longitudinal support trusses or arms of the carbon fiber support structure 1604 can be adjusted to the shape of the bicycle section, and to the forces and directional stresses the bicycle component undergoes during use.

The second stage of production 1602 is the addition of foam 1614 to the carbon fiber internal support structure 1604. The foam 1614 surrounds the carbon fiber internal support structure 1604 in discrete portions between the arms of the carbon fiber internal support structure 1604. The foam 1614 extends down the steerer tube to the connection 1612 between the steerer tube section and the fork legs. The foam 1614 is also distributed on the carbon fiber internal support structure and longitudinal truss 1610 forming the fork legs. As described above, the foam may be a dual-expansion foam which is inserted into the gaps in the carbon fiber internal support structure 1604 and expanded by heating to a predetermined temperature for a predetermined time while inside of a mold to guide the first expansion of the foam into a desired shape. The threaded cavity 1605 is maintained through the addition of the foam 1614 by preventing foam from covering the threaded cavity 1605, or by removing foam that covers the threaded cavity 1605 during processing. As described above, the edges of the carbon fiber internal support structure 1604 may be exposed by scraping away foam after expansion, or be protected from being covered by the foam during the expansion event in order to preserve the carbon fiber internal support structure 1604 edges for bonding with the carbon fiber wrapping.

The third stage of production 1603 is the wrapping of the foam 1614 and carbon fiber support structure 1604 in a carbon fiber wrapping 1618. The edges of the carbon fiber internal support structure 1604 arms extending down the steerer tube 1606 are exposed and in contact with the carbon fiber wrapping 1618. The carbon fiber wrapping 1618 extends the length of the steerer tube 1620 to cover the entire component. After the carbon fiber wrapping 1618 is wrapped about the foam 1614 and carbon fiber support structure 1604, and inserted into a mold to guide the shaping of the component, the carbon fiber wrapped component is heated to a predetermined temperature for a predetermined amount of time. The exposure to heat causes a second expansion event of the foam 1614 which expands the carbon fiber wrapping 1618 with an outward force into the interior walls of the mold to shape the component. The exposed edges of the carbon fiber internal support structure 1604 bond with the carbon fiber wrapping 1618 to produce an internally strengthened carbon fiber component, for example the steerer tube. The threaded cavity 1605 in the top of the steerer tube is preserved throughout these stages to enable easy coupling to other components.

Alternatively, the threaded cavity 1605 can be formed from a metal, polymer or other material, and the carbon fiber wrapping 1618 can be formed around the threaded cavity 1605, rather than forming the threaded cavity from carbon fiber during the shaping of the internal support structure 1604. The threaded cavity 1605 can be coupled to the carbon fiber internal support structure 1604, or can be separate from the carbon fiber internal support structure 1604 and held in place by foam 1614 and surrounded by carbon fiber wrapping 1618. The production of a carbon fiber component including a threaded cavity of a different material can be beneficial because it allows the component to be joined with another that would otherwise risk adding too much torque or force to a solely carbon fiber component. In the example shown here, the carbon fiber steerer tube could be formed with a threaded cavity to accept a screw to couple the steertube to the headset by including a threaded pipe inside the carbon fiber steerer tube and surrounded by the carbon fiber wrapping 1618. The positioning of the threaded pipe reduces stress from forming in the carbon fiber headtube during the attachment of the headset and reduces risk of failure. In some implementations, the threaded pipe, washer or other component is injection molded before incorporation into the carbon fiber component.

Similarly, in some implementations, the foam covered carbon fiber support structure 1610 forming the crown and fork legs is wrapped in the carbon fiber wrapping, inserted into a mold, and exposed to heat to produce the internally supported carbon fiber crown and fork legs. The internally supported carbon fiber crown and fork legs can be coupled to the steerer tube following these procedures, or can be coupled during the second heating procedure. In some implementations, the crown, fork legs, and steerer tube are formed together from a unitary carbon fiber support structure, or from individual structures that are bonded together before wrapping in foam and carbon fiber wrapping.

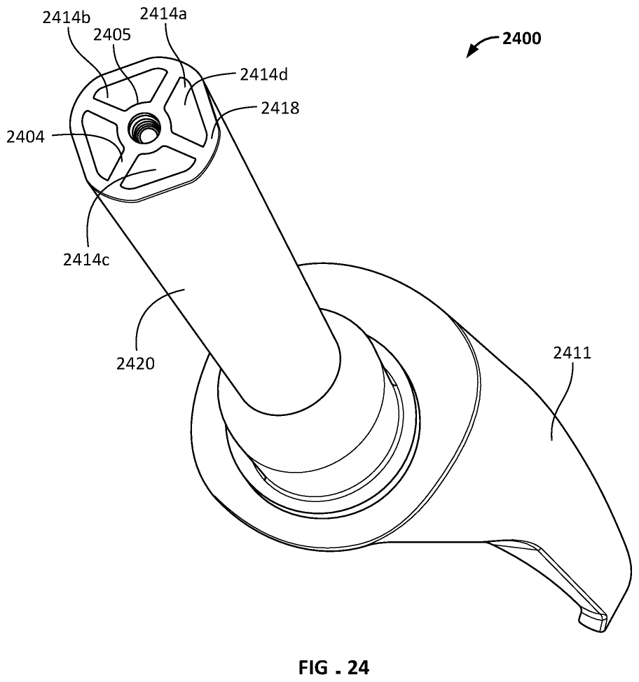

In some implementations, a similar steerer tube structure including a threaded component for coupling to the handlebars can be manufactured using an alternative method. Referring to FIG. 24, a bicycle fork 2400 can include fork legs or blades 2411, and a steerer tube 2420 including a threaded component 2405. The steerer tube 2420 with threaded component 2405 can be manufactured by forming near net shape structures from foam, wrapping each near net structure in carbon fiber individually, and then combining the wrapped structures and curing together as one unit. For example, the steerer tube can be formed in multiple sections, for example four quarters cut vertically through the tube 2414a-d. In some implementations, the near net shapes are produced using molds. In other implementations, the near net shapes are produced by cutting or otherwise separating a foam structure into multiple pieces. Each of the multiple sections 2414a-d can then be individually wrapped in a pre-preg carbon fiber material, and then placed together to be cured into one structure. In some implementations, the pre-preg carbon fiber may be a woven carbon fiber fabric, which can include chopped pieces of carbon fibers. Upon curing, the pre-preg carbon material forms the internal support structure 2404, and the carbon material surrounding the four multiple sections 2414a-d forms the carbon fiber wrapping 2418.

The threaded component 2405 can be a pre-made injection molded composite piece designed to enable another component to be coupled to the carbon fiber component. The threaded component 2405 is formed from carbon fiber, such as chopped carbon fiber, and can be formed as a bracket, a threaded or non-threaded hole, or another coupling mechanism for attaching components to one another. Though here the threaded component 2405 is described with respect to the steerer tube 2420, threaded components 2405 can be incorporated into other components of the bicycle, for example the downtube for coupling a water bottle cage, the bottom bracket cups for accepting a bottom bracket hub.

For example, the threaded component 2405 is formed as a threaded cavity for coupling the steerer tube 2420 of the form 2400 to the handlebars. The threaded component 2405 can be inserted between the four multiple sections 2414a-d (or “sandwiched” between them) prior to wrapping of the entire structure in carbon fiber wrapping 2418, such that when the structure is cured, the injection molded carbon fiber threaded component 2405 is coupled to the internal support structure 2404 and/or to the carbon fiber wrapping 2418. The threaded component 2405 is bonded to the carbon fiber making up the exterior structure of the frame (the carbon wrapping 2418). The threaded component 2405 can be incorporated into the structures of any of FIG. 8A-D or 23, and as described above with respect to the use of injection molded components for coupling water bottle cages or bottom bracket components, can also be integrated into a side or wall of the carbon fiber structure, rather than a top. For example, a bracket for attachment of a water bottle cage can be included as an injection molded carbon fiber piece with two threaded cavities for the attachment of bolts. In a first implementation, the bracket can be sandwiched between two halves of a downtube formed of foam wrapped in carbon fiber, with or without an internal carbon core structure. The bracket can be bonded to the carbon fiber surrounding the foam pieces and/or to the external wrapping of carbon core fiber. In a second implementation, the bracket can be sandwiched between the two foam pieces of the downtube, without wrapping of the foam components individually in carbon fiber. The bracket in this case is not bonded to an internal structure, but is embedding in the foam and maintained in position by bonding with the exterior carbon fiber wrapping. The holes in the bracket can be maintained through the foam and carbon fiber structure during curing by a bolt or other component, so that the bolt locates the threaded position in the component.

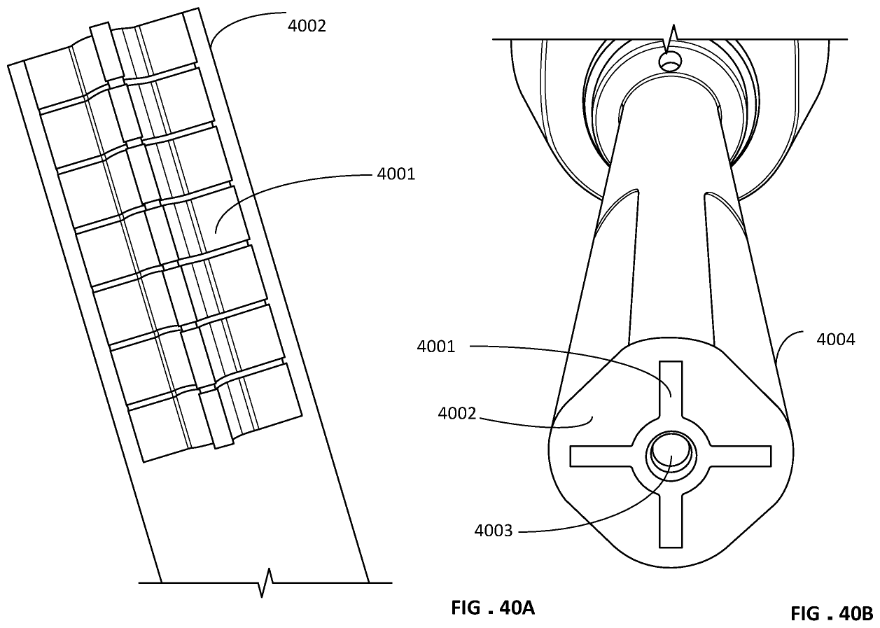

In some implementations, the threaded component can be incorporated into the foam and carbon fiber structure without being coupled to the external carbon fiber walls. Referring to FIG. 40A-B, an internal carbon fiber structure 4001 can be incorporated into a foam structure 4002 prior to curing. The internal carbon fiber structure 4001 can include a threaded portion 4003 for coupling to another component. As illustrated in FIG. 40B, the internal carbon fiber structure 4001 can in some cases be entirely surrounded by foam 4002, such that after curing, the internal carbon fiber structure 4001 does not contact the outer carbon fiber wall 4004, and is held in place by the surrounding foam 4002 only. In some implementations, the internal carbon fiber structure 4001 is held in place within the foam 4002 prior to curing by one or more structures which may be removable or sacrificial. In some implementations, the internal structure 4001 is made of a material other than carbon fiber, for example, a metal, a metallic alloy, a polymer, or another suitable material. In some implementations, the internal structure has a cross or x-shaped cross-section. In some implementations, the internal structure has a cross-section formed as a bar, a circle, or any other suitable shape. In some implementations, the internal structure extends a full length of the bicycle component in which it is embedded, and in other implementations, the internal structure extends for only a portion of the length of the component,

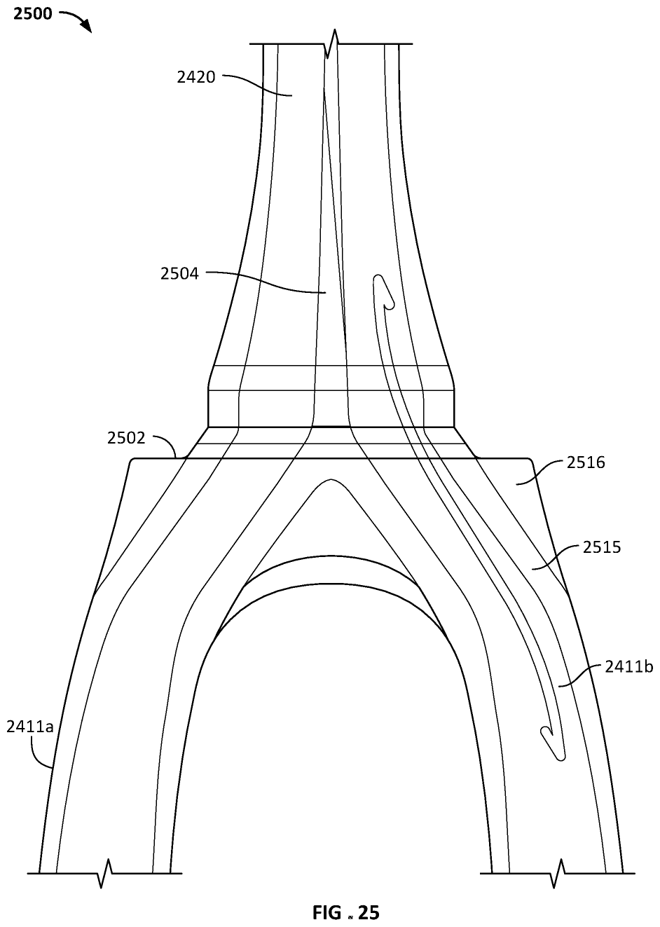

In some implementations, additional carbon fiber layers can be added to an initial carbon fiber and foam structure. For example, FIG. 25 shows a front view of a bicycle fork 2500 including a steerer tube 2520, crown 2502, and blades 2411a-b. The bicycle fork 2500 can be formed from a first structure 2515 that can include multiple foam near net structures joined by carbon fiber wrapping to provide continuous carbon fiber paths for structural integrity and strength. The bicycle fork 2500 can further include additional carbon fiber layers 2516 to build up the first structure 2515, for example in the area surrounding the crown 2502. Packing carbon fiber into sharp corners, such as those around the crown 2502 can be difficult to achieve by hand layup, can add weight to the design, and may mitigate the carbon fiber's strength as a continuous path structure. By first manufacturing a first structure 2515 which may include internal support structures 2504 along load paths that are designed to bear the loads usually experienced by the bicycle component during use, and then adding features which are of less structural importance or decorative in nature, less carbon fiber can be used to achieve a lighter, stronger frame than by conventional methods.

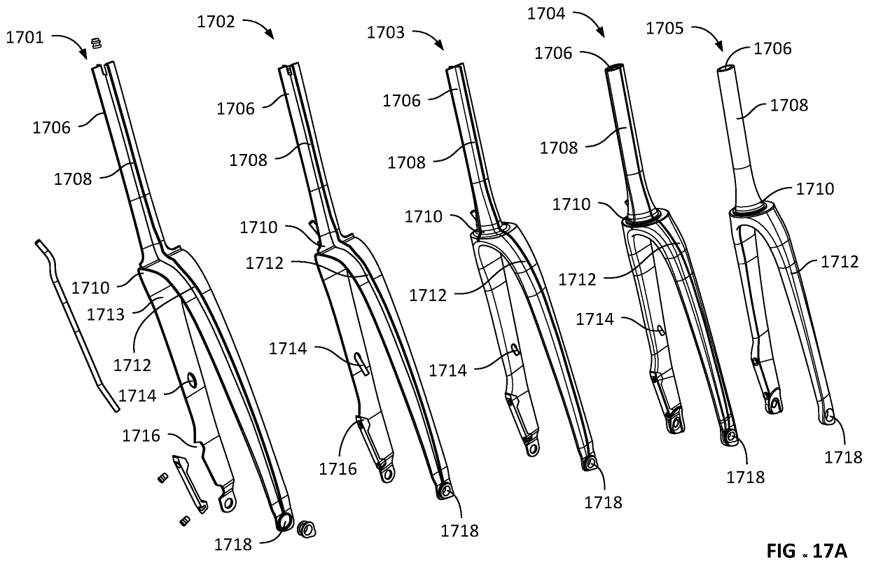

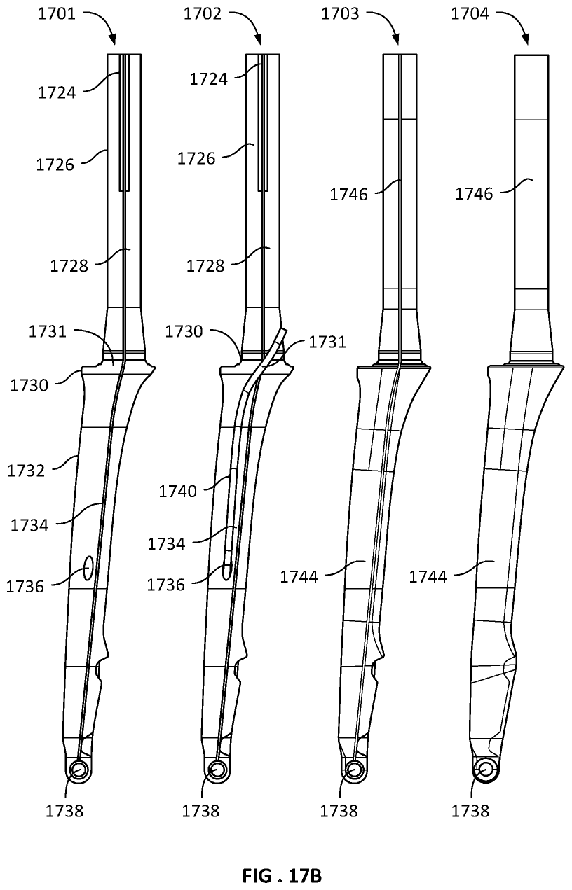

FIGS. 17A and 17B illustrate the process of FIG. 16 with an angled side view of the steerer tube and fork bicycle component. FIG. 17A depicts a side-angled view of the stages of production of an internally supported carbon fiber bicycle fork. Fork 1701 shows the internal carbon fiber support structure which includes an elongated steerer tube 1706 having arms, longitudinal trusses, or fins 1708, the steerer tube 1706 coupled at connection 1710 to fork legs 1713 which include a longitudinal truss 1712 on an exterior portion but not on an interior portion of the fork legs 1713. The fork legs 1713 also include an aperture 1714 on the left fork leg to provide for internal wiring of the bicycle's front brake cable, a cut out portion 1716 that allows the coupling of an additional component or brace, and apertures 1718 at the bottom portion of the legs as drop-outs for the placement of the wheel. Fork 1701 illustrates the ways in which the carbon fiber internal support structure can be shaped and altered prior to covering with foam and carbon fiber wrapping to support the intended purpose of the component. The carbon fiber internal support structure can be shaped and sized to produce an intended component, for example the X-shaped internal support structure of the steerer tube provides support that can withstand the vertical and torsional forces incident on the steerer tube during use of a bicycle. The internal support structure of the fork legs and crown support the shape of the crown and provide additional strength along the lengths of the legs to withstanding the bending force at the dropouts 1718 at the bottom of the fork, as well as the stress concentration at the crown during braking and deceleration. The internal support structures are formed as vertical substructures that are oriented to be perpendicular to the walls of the carbon fiber wrapping when applied and to follow the shape of the component to provide enhanced strength. The shape of the components, as well as the shape of the internal support structures supporting the components may be varied depending on the type of bicycle the component will be used in and the expected forces associated with the component. For example, a fork of a mountain bike may need to withstand different and greater forces during normal use than the fork of a road bike. By changing the internal support structure shape, these forces and stresses can be accommodated.

Fork 1702 shows the internal support structure of fork 1701 with the addition of the brake cable wiring conduit and the brace at the bottom of the fork. The brake cable wiring conduit extends through aperture 1714 so that the pathway for the brake cable can be preserved during the rest of the manufacturing steps for ease of assembly. The brake cable wiring conduit may be formed from a carbon fiber conduit, a conduit of another material (a hard sleeve or a straw), or as a solid silicon cord or wire which can be melted out to expose the wiring path after manufacturing is complete.

Fork 1703 shows fork 1702 with surrounding foam structure. The internal support structure of fork 1702 is surrounded by dual expansion foam and inserted into a mold. The application of heat to a predetermined temperature for a predetermined length of time causes a first expansion event of the foam within the mold. The wiring path through the aperture 1714 is preserved by the brake cable wiring conduit during this step. Fork 1704 shows fork 1703 with carbon fiber wrapping applied. After the first expansion event of the foam, the foam-covered internal support structure is then wrapped in a carbon fiber wrapping, inserted into a second mold and heated again to trigger the second expansion event of the foam which pushes the carbon fiber wrapping outward into the interior surfaces of the mold to form the final component. As described above, in order to ensure that the internal support structure is bonded with the carbon fiber exterior wall formed by the wrapping, the edges of the internal support structure must be exposed to the wrapping by removing foam that covers the edges and/or adding additional carbon fiber or epoxy material to ensure a good bond. Fork 1705 shows the final stage of manufacturing, in which the components are joined and painted or additional coatings are added.

FIG. 17B depicts a side-view of the stages of production of an example internally supported carbon fiber bicycle fork. Fork 1701 includes an internal support structure forming steerer tube 1726, including an arm, longitudinal truss, or support fin 1728. The internal support structure forming the steerer tube 1726 includes a threaded cavity or recess 1724 extending into the internal support structure from the top of the steerer tube. The steerer tube 1726 is coupled to the fork legs 1732 at connection 1730 (at the crown of the bicycle). The internal support structure forming the fork leg 1732 includes an arm 1734 on the exterior side of the fork leg 1732 (facing into the page). In FIG. 17B, the apertures of fork 1701 are illustrated as first aperture 1731 at the connection between the steerer tube 1726 and the fork leg 1732, and second aperture 1736 in the fork leg 1732. The first aperture 1731 and second aperture 1736 provide a pathways for routing a brake cable along the internal support structure of the fork leg. A third aperture 1738 provides for the dropouts that allow attachment of the wheel. Fork 1702 illustrates the internal support structure of fork 1701 with a channel inserted through first aperture 1731 and second aperture 1736 to preserve the pathway for the routing of cables within the bicycle. The channel can be formed from silicon cord, wire, or tubing that can be melted out at the end of the manufacturing process to allow the bike to be internally cabled, from a hard sleeve or straw of another material that can be encapsulated in foam to preserve the cabling channel, or from a carbon fiber conduit that is incorporated into the structure. Any of the silicon cord, hard sleeve, or carbon fiber conduit can be used to provide a smooth passageway through the internal structure of the component to allow for ease of cabling and wiring when the bicycle is assembled. The passageway formed from these materials can be sized to allow the passage of the necessary cables and wiring but to reduce vibration of the cables within the frame.

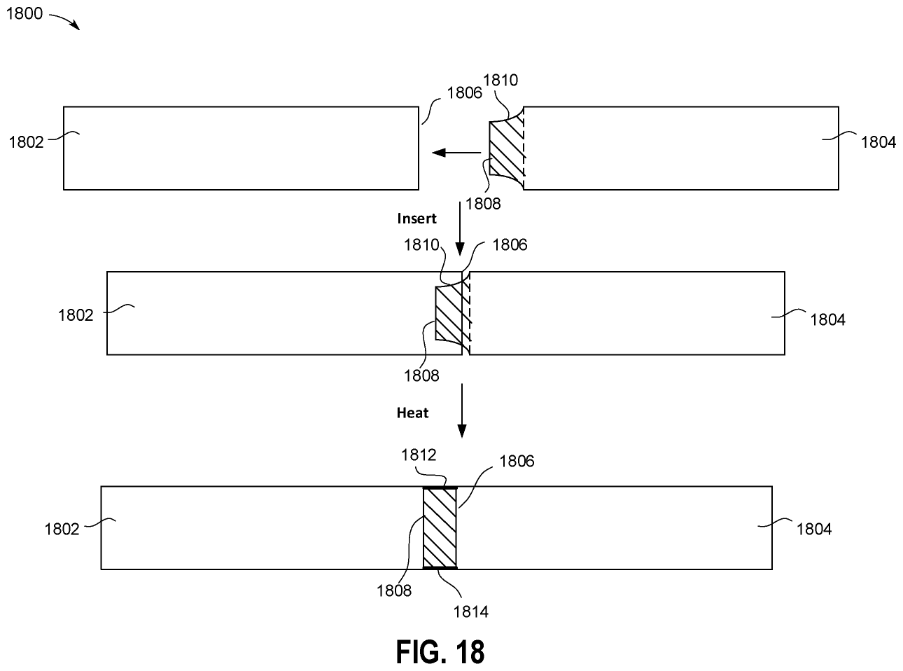

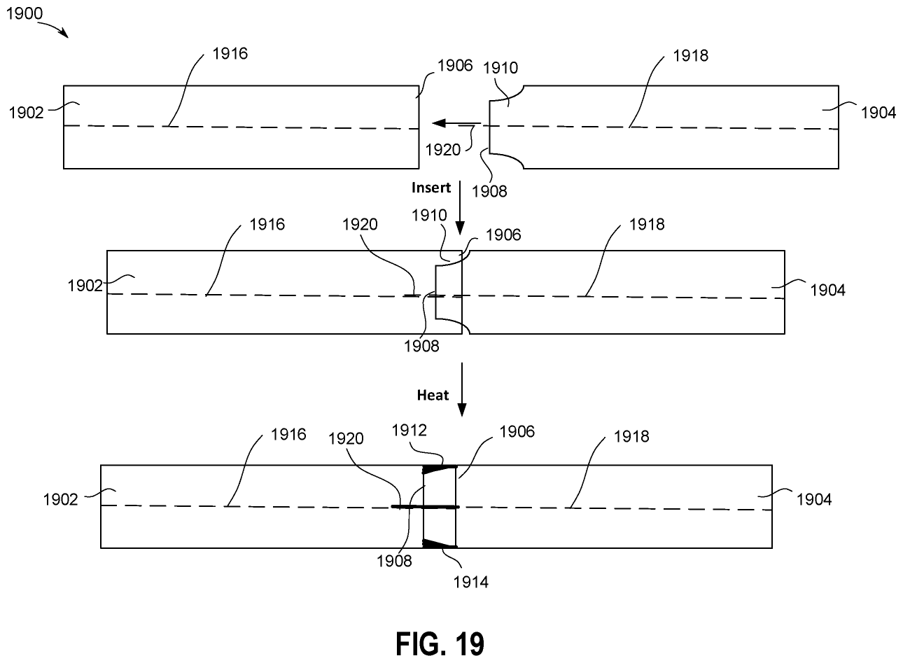

Fork 1703 shows the incorporation of foam surrounding the internal support structure, and fork 1704 illustrates the wrapping of the foam and support structure in a carbon fiber wrapping to provide an internally supported carbon fiber component. Forks 1703 and 1704 include the steerer tube 1746 and the fork legs 1744. As described above, these components can be joined in the first step of manufacturing of the internal support structures, or can be assembled separately according to the same steps and joined together after the carbon fiber wrapping has been applied. FIGS. 18 and 19 illustrate example methods of joining such structures.

FIG. 18 depicts a method 1800 of joining carbon fiber structures. First carbon fiber structure 1802 and second carbon fiber structure 1804 may be structures as described above that are formed as tubes having an internal carbon fiber support structure surrounded by foam and covered by a carbon fiber wrapping. Alternatively, first carbon fiber structure 1802 and second carbon fiber structure 1804 may be hollow carbon fiber tubes without internal support structures. One tube can be structured at an end as a “male” fitting and the other tube can be structured at the end as a “female” fitting, such that the male fitting end can be inserted into the female fitting end. The method described in FIG. 18 can apply to either internally supported or non-internally supported carbon fiber tubes. The first carbon fiber structure 1802 has a first end 1806 (“female” end). The second carbon fiber structure 1804 has an end 1808 (“male” end) and a foam section 1810 adjacent to edge 1808 (indicated by the cross-hatching). In the foam section 1810, an unexpanded foam covers the end of the second carbon fiber structure 1804. The foam may be a dual-expansion foam or another foam that undergoes an expansion event when heated. The foam may be covered by pre-preg carbon fiber or another material chosen to bond with the carbon fiber interior of the first carbon fiber structure 1802. First carbon fiber structure 1802 forms an internal cavity at least at the end 1806. The face of end 1808 has a smaller cross-sectional area or diameter than the face of end 1806 and end 1808 can be inserted into end 1806. Optionally, the foam section 1810 of the second carbon fiber structure 1804 has an angled or curved edge section 1810.

After end 1808 is inserted into end 1806, heat is applied to trigger an expansion event of the foam forming foam section 1810. The foam section 1810 expands within the first carbon fiber structure 1802 such that pre-preg carbon fiber coating the foam section 1810 is incident on the internal walls of the first carbon fiber structure 1802. The heating cures the pre-preg carbon fiber, forming a bond between the carbon fiber wrapping of the first carbon fiber structure 1802 and the second carbon fiber structure 1804. Using this method, carbon fiber components can be manufactured separately and bonded together to form larger and more complex structures.

FIG. 19 depicts a method of joining tubular internally supported carbon fiber structures. First internally supported carbon fiber structure 1902 and second internally supported carbon fiber structure 1904 are formed as carbon fiber tubes having an internal carbon fiber support which runs through a length of the carbon fiber tubes. First internally supported carbon fiber structure 1902 includes end 1906 and internal support structure 1916. Second internally supported carbon fiber structure 1904 includes an end 1908, an section of reduced tube diameter 1910 adjacent to end 1908, internal support structure 1918 which runs along a length of second internally supported carbon fiber structure 1904, and protruding internal support structure 1920 which extends beyond the end 1908 of the carbon tube. The protruding internal support structure 1920 which extends beyond the end 1908 of the carbon tube is coated in pre-preg carbon fiber wrapping. The section of reduced tube diameter 1910 adjacent to end 1908 is also covered with pre-preg carbon fiber wrapping. The section of reduced tube diameter 1910 adjacent to end 1908 can have a stepped, angled, or curved surface between the full diameter of the second internally supported carbon fiber structure 1904 and the reduced tube diameter 1910 at end 1908. Ideally, the section of reduced tube diameter 1910 results in a tube diameter only slightly smaller than a tube diameter of the end 1906 of the first internally supported carbon fiber structure 1902 to ensure a good bonding. The reduced tube diameter allows end 1908 to be inserted into end 1906. The end 1906 of the first internally supported carbon fiber structure 1902 must include no foam or the foam in this section must have been removed in order to accommodate the end 1908.

After insertion of end 1908 into end 1906, the carbon fiber tubes are heated to cure the pre-preg carbon fiber wrapping that covers the protruding internal support structure 1920 and the section of reduced tube diameter 1910 within the end 1906 of the first internally supported carbon fiber structure 1902. The pre-preg carbon fiber wrapping of the section of reduced tube diameter 1910 bonds to the interior wall of the first internally supported carbon fiber structure 1902. The pre-preg carbon fiber coating of the protruding internal support structure 1920 bonds to the internal support structure 1916. The components can be separately produced with internal structures, and can be bonded at both the external wall and at the internal support structure with the application of heat. By bonding both the carbon fiber walls and the carbon fiber internal support structure, the strength of the components is maintained throughout the joint.

FIGS. 20A and 20B show a bicycle bottom bracket shell with internal support structure. FIG. 20A shows the internal carbon fiber support structure of the bottom bracket shell. The bottom bracket is positioned at the connection of the down tube, seat tube, and chain stay, and many forces are concentrated in the bottom bracket because of its positioning and because of the forces applied by the user to turn the cranks. The bottom bracket shell 2000 of FIG. 20A includes a cavity 2002 for the bottom bracket, a carbon fiber seat tube support structure 2004 extending from the bottom bracket cavity 2002 toward the seat tube, a carbon fiber down tube support structure 2006 extending from the bottom bracket cavity 2002 toward the down tube, and a carbon fiber chain stay support structure 2008 extending from the bottom bracket cavity 2002 toward the chain stays. The carbon fiber seat tube support structure 2004 includes a fin-like support structure 2010 formed as a vertical substructure oriented perpendicular to the plane of the support structure 2004. Similarly, carbon fiber down tube support structure 2006 includes fin-like support structure 2012, and carbon fiber chain stay support structure 2008 includes fin-like support structure 2014. These substructures provide additional strength to the components and are oriented and shaped based on the forces the components will undergo during use. For example, the fin-like support structure 2010 of the carbon fiber seat tube support structure 2004 extends further closer to the bottom bracket cavity 2002 and is much shorter further along the carbon fiber seat tube support structure 2004. Bottom bracket shell 2000 also includes conduits 2016 to preserve internal cable routing pathways or channels and can also include other features like mounting brackets for mounting the front derailleur, if desired.

FIG. 20B shows the internal carbon fiber structure of FIG. 20A with dual expansion foam segments providing the shape of the bicycle bottom bracket shell 2001. As illustrated in FIG. 20B, the foam segments surround the carbon fiber seat tube support structure 2004, carbon fiber down tube support structure 2006, and carbon fiber chain stay support structure 2008. The foam is expanded by heating within a mold to give shape to the bottom bracket shell 2001. The foam can provide additional strength to the component, and can also form aesthetic or design aspects that are not captured by the internal carbon fiber structure, for example the sweep at the splitting of the chain stays 2018 from the bottom bracket shell.

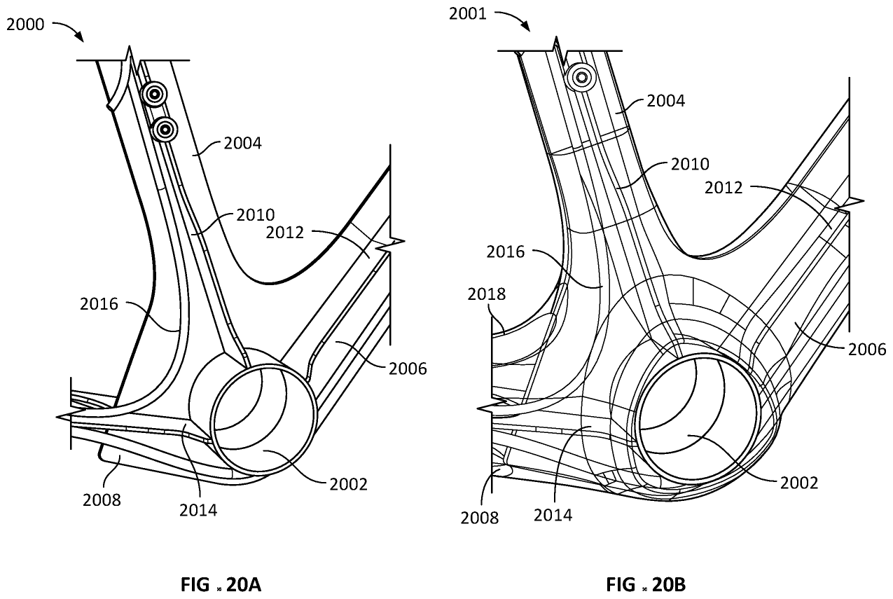

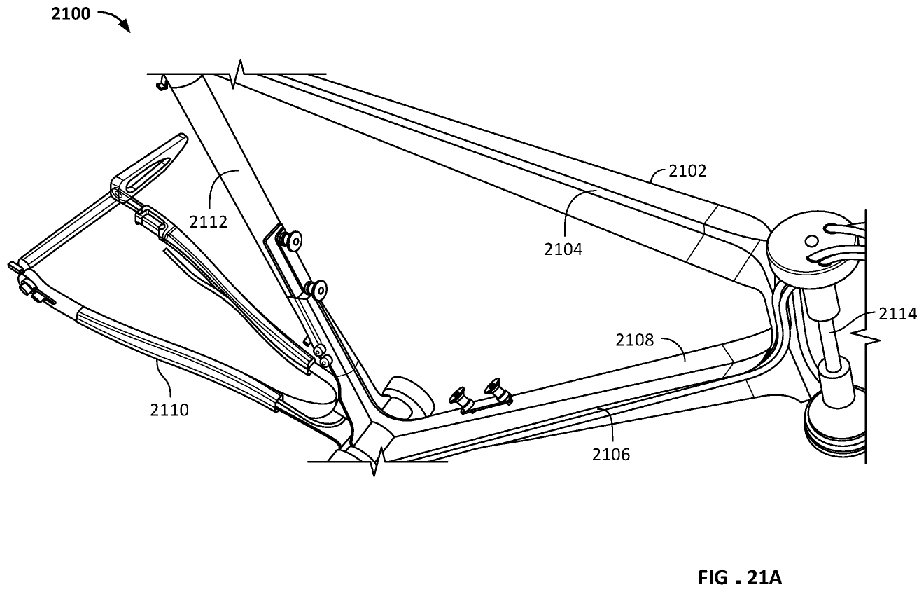

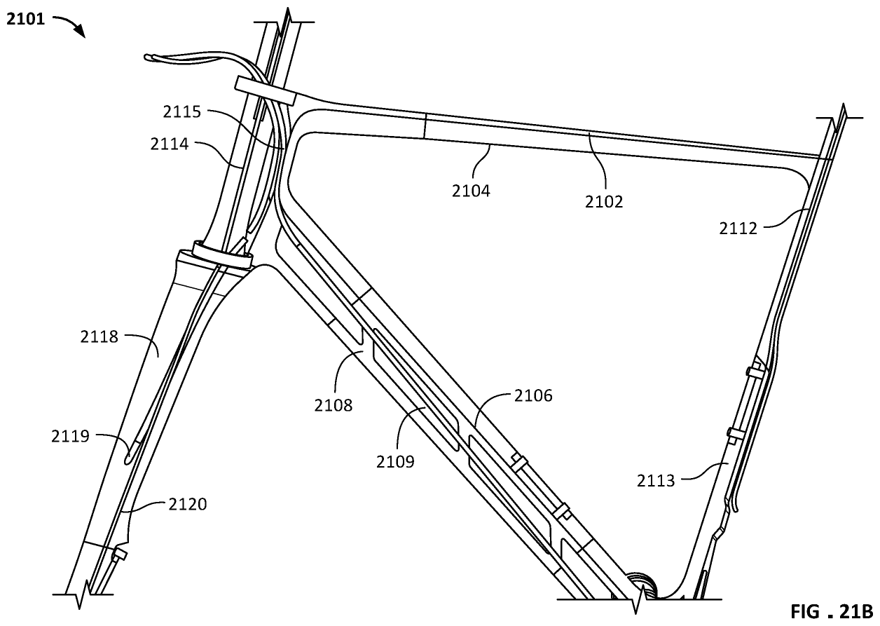

FIGS. 21A and 21B illustrate views of internal support structures forming components in a road bicycle frame. FIG. 21A depicts an angled top-view of an example support structure providing an internal support for a carbon fiber bicycle frame 2100. The bicycle frame 2100 has an internal support structure for a top tube including horizontal support 2102 and vertical support 2104. The internal top tube support structure is shaped as an X-shaped structure with horizontal support 2102 and vertical support 2104 arranged so as to be perpendicular to one another, providing support in both the X- and Y-directions. The bicycle frame 2100 has an internal support structure for a down tube which also includes a horizontal support 2106 and vertical support 2108 arranged so as to be perpendicular to the horizontal support 2106. The bicycle frame 2100 has a seat tube 2112 and chain stay 2110. These components and possible internal support structures for these components have been described previously.

FIG. 21B depicts a side-view 2101 of the example support structure providing an internal support for a carbon fiber bicycle frame of FIG. 21A. The bike frame 2101 includes the internal support structure for a top tube including horizontal support 2102 and vertical support 2104, and shows the vertical support 2108 and horizontal support 2106 of the downtube. Additionally, the vertical support 2108 of the downtube includes cut-outs 2109 where carbon fiber has been removed from the support. The cut-outs 2109 are formed through an approximate center of the vertical support 2108 as parallelograms having rounded corners, with two opposite side substantially parallel to the edges of the vertical support 2108 of the downtube. The curved corners help to minimize weakening of the structure at the corners of the cut-outs, allowing the structure to maintain its strength and to support the carbon fiber walls despite the removal of material. Multiple cut-outs 2109 are shown, though any number of cut-outs can be made. Though cut-outs 2109 are shown in the vertical support 2108 of the downtube, cut-outs can be made to vertical or horizontal supports of any frame components as desired. The removal of carbon fiber through the use of cut outs can serve multiple purposes, including decreasing the weight of the bicycle frame by removing material and enabling a continuous and unitary foam structure to surround the supports, thereby increasing the strength of the component as compared to discrete segments of foam positioned about the support.

Bike frame 2101 also includes steerer tube 2114, crown 2116, and fork leg 2118. Fork leg 2118 includes a vertically oriented support 2120 and wiring channel 2115 which runs down steerer tube 2114 and fork leg 2118, and through aperture 2119. Wiring channel 2115 preserves the pathway for internal cabling of the bicycle brakes, shifting, and/or lights. Wiring channel 2115 can be formed from a carbon fiber conduit, a hard conduit or sleeve formed from another material to preserve the pathway through the foam, or a silicon conduit (such as a straw, cord, or wire) that can be removed from the foam by melting to allow cabling of the bicycle.

Each of the components can be manufactured separately according to one or more of any of the methods described above and joined together to form the bicycle according to one or more of the techniques described in FIGS. 18 and 19 or any other suitable technique. By forming the components separately, the manufacturing process is simplified as small and less complex molds are used to produce each individual component.

While FIGS. 21A and 21B show a road bike frame, the manufacturing techniques, designs, and features described with reference to these figures, as well as the other figures described above, are not limited to road bikes, but can be used in the manufacture of other types of bikes (racing bikes, triathlon bikes, mountain bikes, electric or electric-assist bikes, BMX bikes, touring bikes, randonneuring bikes, cargo bikes, tandem bicycles, recumbent bicycles, etc.) and to other types of frames which may benefit from the use of carbon fiber frames reinforced by internal carbon fiber support structures, such as components of an automobile, an airplane, a motorized boat, an unmanned aerial vehicle, a helicopter, or another motorized or non-motorized vehicle. Additionally, the carbon fiber support structures described herein can be used in the production of other sporting equipment, such as camping equipment like tent poles, hiking or skiing equipment such as poles or racing equipment, or other equipment.

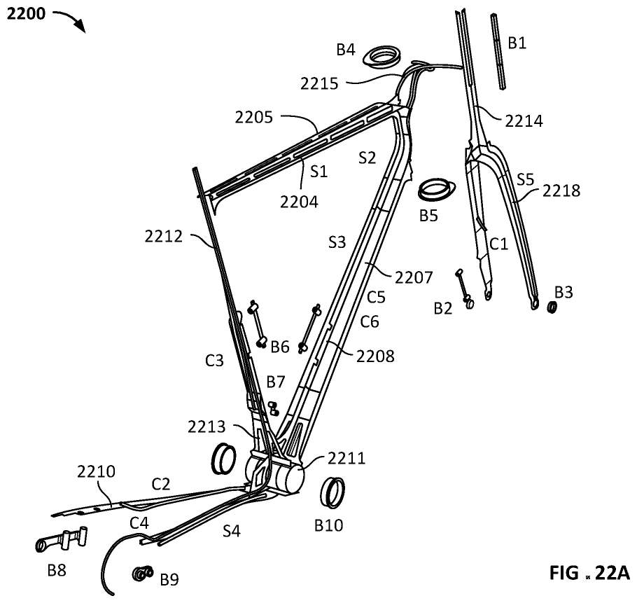

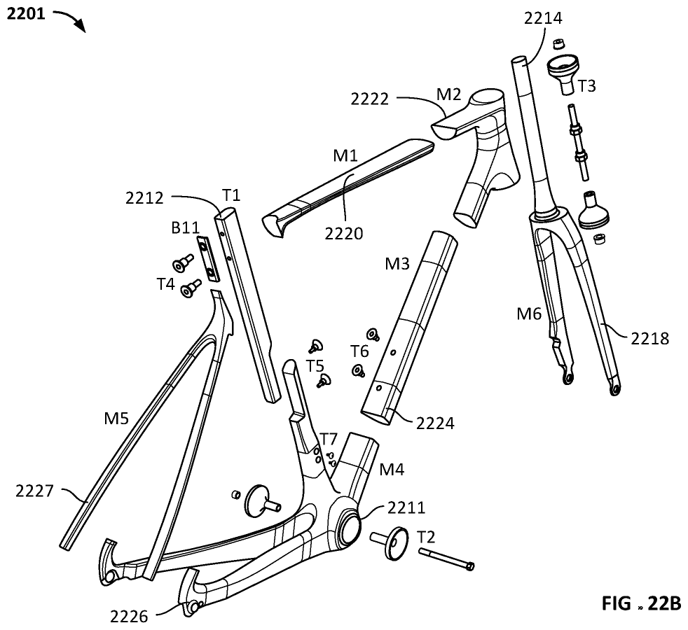

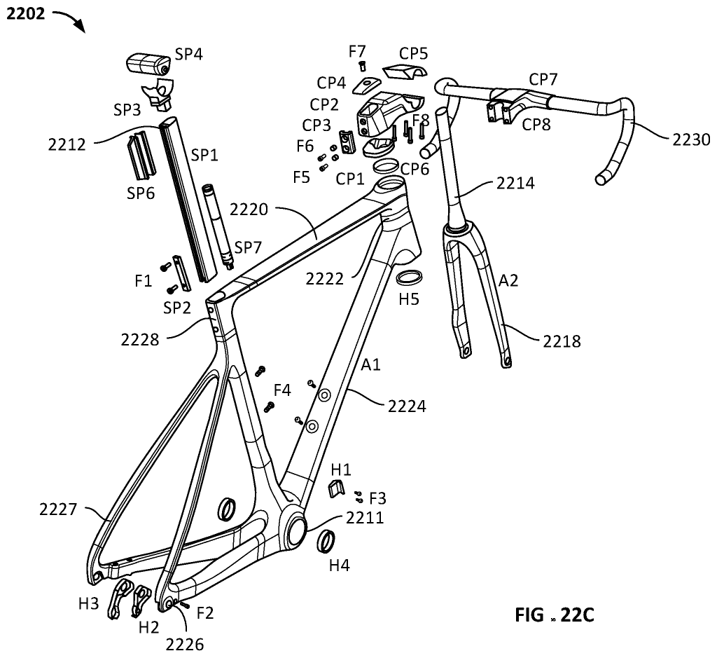

FIG. 22A depicts an exploded view of carbon fiber support structure components of a road bicycle 2200 and additional bicycle components. The view of the road bicycle support structure components 2200 includes vertical top tube support structure 2204 and horizontal top tube support structure 2205, steerer tube support structure 2214, fork legs support structures 2218, down tube vertical support structure 2208 and down tube horizontal support structure 2207, bottom bracket shell 2211, seat tube support structure 2213 and chain stay support structure 2210. Additionally, an upper seat tube support 2212 and cabling conduit 2215 are depicted. Each of these components is discussed in detail above, and, as also described above, can be manufactured as separate components and coupled together later in the assembly process. Each component can include support structures that are designed to withstand the particular forces incident on the component during use of the bicycle. Support structure shape, thickness, size, length, and orientation can be varied to improve the strength of the component under normal or occasional forces and stresses. These parameters can be varied depending on the particular component or the bicycle or other device being assembled, and the type of bicycle being assembled and the forces that can be expected to act on the bicycle during use. For example, components can be designed to withstand typical forces experienced by racing bikes, triathlon bikes, mountain bikes, electric or electric-assist bikes, BMX bikes, touring bikes, randonneuring bikes, cargo bikes, tandem bicycles, recumbent bicycles, or other types of bicycles.

FIG. 22B depicts an exploded view of the support structure components of FIG. 22A with dual expansion foam covering 2201 and additional bicycle components. The view of the road bicycle support structures with foam covering 2201 illustrates the individual components that may be prepared separately and later joined. Road bicycle foam covered components 2201 include top tube 2220, steerer tube 2214, fork legs 2218, head tube 222, downtube 2224, bottom bracket shell assembly 2211, chain stay 2226, seat stay 2227, and seat post insert 2212. Additional components which are not formed from the carbon support structures and foam wrapping include head tube assembly, seat post assembly and bolts, and bottom bracket assembly tools and bolts. By wrapping the components in an expandable foam, additional definition and strength is given to the components, and the resulting foam and support structure is substantially the size and shape of the final components with the carbon fiber wrapping.

FIG. 22C depicts an exploded view of the dual expansion foam covered support structure of FIG. 22B coated with a carbon fiber wrapping 2202 and additional bike components. Wrapping the expanded foam in carbon fiber wrapping and bonding the wrapping to the underlying support structure gives the component additional strength to withstand expected forces during use. The road bike with carbon fiber wrapping 2202 depicted here also shows the components of FIG. 22B joined into a unitary bicycle frame and other components. The components of FIG. 22B can be joined by any of the techniques described above, or any other suitable technique. The unitary bicycle frame includes the top tube 2220, head tube 2222, down tube 2224, bottom bracket assembly 2211, chain stay 2226, seat stay 2227, and seat tube 2228. The fork including steerer tube 2214 and fork legs 2218 is maintained as a separate component, as it must be able to pivot within the head tube 2222 to allow steering of the bicycle. The handlebars and stem are also maintained as a separate component to allow for interchange of different setups. The seat post 2212 is a separate component that interfaces with the seat tube 2228 to allow for adjustment of the seat. Washers, bolts, and other assemblies are not specifically called out here, but may be used in the final bicycle set up.

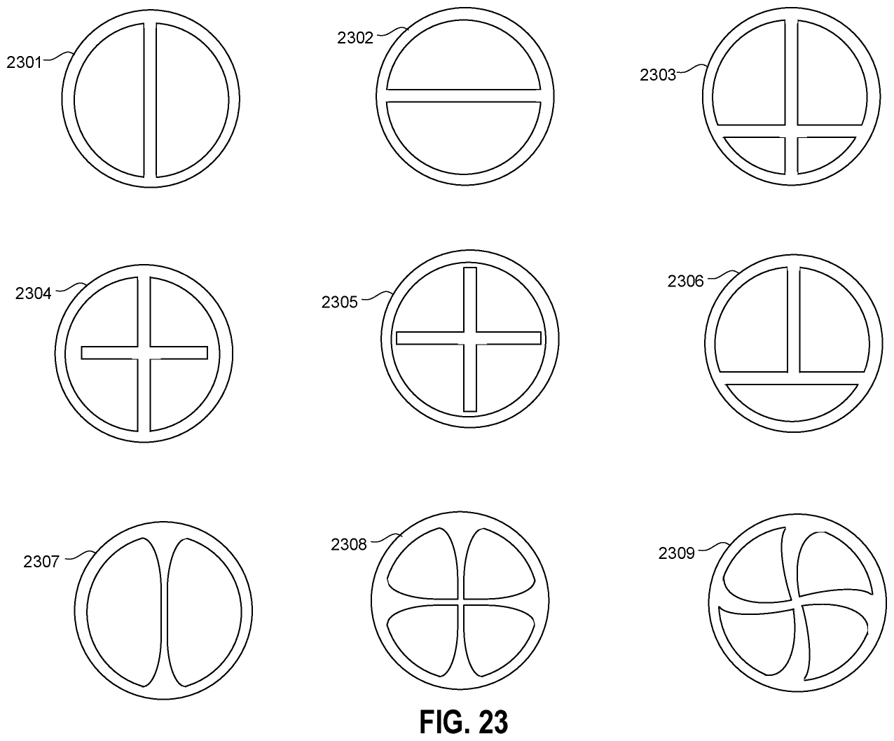

FIG. 23 depicts various internal truss structures that can be used in bicycle components. As described above, there may be advantages to incorporating various internal truss structures in the manufacture of components of a bicycle frame to compensate for forces the component is likely to undergo during use. FIG. 23 shows various internal truss structures, which, in addition to truss structures illustrated above including in FIGS. 8A-D and others, may provide internal structural support to bicycle components or other components formed according to the manufacturing methods described herein. For example, structure 2301 shows a single vertical support structure, structure 2302 shows a single lateral support structure, and 2303 shows a vertical support structure bisecting the carbon fiber conduit with a lateral support structure offset from a middle of the vertical support. While internal support structures 2301-2303 are shown with vertical supports bisecting the carbon fiber conduit from top to bottom, and lateral supports bisecting the conduit from side to side, the support structures can be incorporated into the conduits at any angle. Further, though internal support structure 2303 shows a vertical and horizontal support structure which are perpendicular to one another, the support structures can be positioned at any angle relative to one another and relative to the internal walls of the conduit.

As additional examples, structure 2304 shows a vertical support structure bisecting the carbon fiber conduit with lateral support fins positioned at the midway point of the vertical support not in contact with the internal wall of the conduit. Structure 2305 shows an internal support structure with a vertical support and lateral support in which neither the vertical nor lateral supports are in contact with the internal walls of the conduits. One or more internal support structures of any of the structures described herein may be formed as a fin which is not coupled to the internal wall of the conduit. Structure 2306 shows an internal support structure with a lateral support structure extending between internal walls of the conduit with a vertical support structure extending from an internal wall of the conduit to the lateral support structure. As depicted by structure 2306, a vertical support structure need not extend from an internal wall of the conduit to another internal wall, but can be instead coupled to another support structure.

While structures 2301-2306 and other support structures and trusses described above are depicted as extending perpendicularly to an internal wall of the conduit, any of the support structures can be formed with fluted or angled connections to the internal wall of the conduit so as to distribute stresses and forces over a larger portion of the conduit. Structure 2307 shows an internal support structure having a vertical support structure extending between internal walls of the conduit and coupled to the internal walls by fluted ends. Structure 2308 shows an internal support structure having vertical and lateral support structures with fluted couplings to the internal walls of the conduit. Finally, 2309 shows an internal support structure having vertical and lateral support structures which intersect with the internal walls of the conduit at an angle. The structures 2301-2309 are examples of possible support structures, and are not exhaustive of the possible structures that could be used to provide support to components of a bicycle frame or other item. Other structures and combinations of structures will be apparent to a person of skill based on the examples given herein.

Each of the structures 2301-2309 described above, the truss structures described with reference to FIG. 8, and other structures described above can be used in one or more bicycle components including a fork, a top tube, a down tube, a head tube, a seat tube, a bottom bracket, a seat stay, a chain stay, handlebars, or any other bicycle component. Each bicycle component may include more than one of the truss structures coupled to one another or formed as a unitary structure which transforms from one support structure to another over a length. For example, a top tube may include a vertical support structure such as 2301 which transitions to a lateral support structure such as 2302 halfway along a length of the top tube. The transition may be at a juncture between the vertical support structure and the lateral support structure, or may be formed as a twist from vertical to lateral over any reasonable distance.

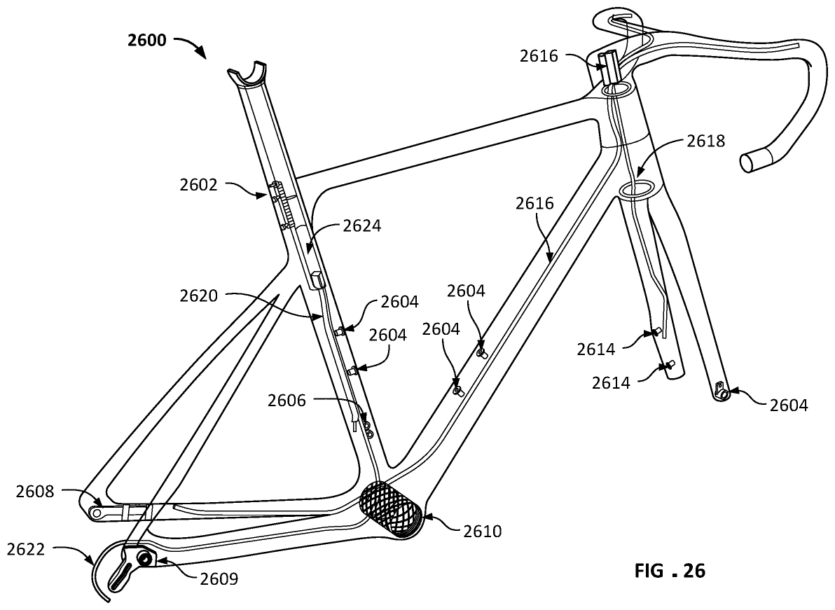

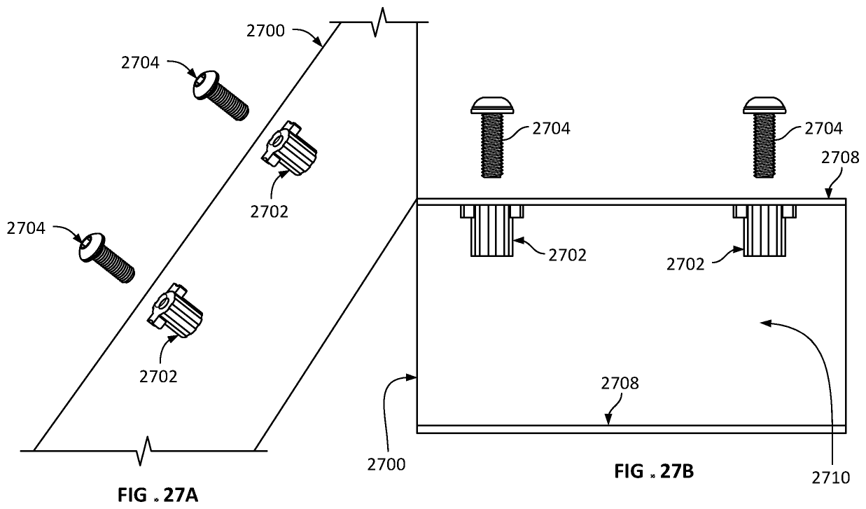

Each bicycle component may include any of the truss structures in any orientation in order to compensate for forces experienced by the component and to allow for internal routing of cables, wiring, and lights. Any bicycle components may include one or more truss structures described herein which terminate before an end of the bicycle component. Additionally and/or alternatively, the bicycle components may be formed from one or more solid materials, such as resins, plastics, metals, and/or other suitable materials, which may be strengthened through the use of carbon fibers that are embedded within and/or wrapped around one or more portions of the components. The components may be formed via any of the processes described throughout this document, as well as through other processes, such as injection molding, machining, and/or other techniques. For example, FIG. 26 illustrates example components 2602-2622 for an example bicycle 2600, which can be produced using the techniques described throughout this document. The example components 2602-2622 can be non-metal, for example, and can permit the bicycle 2600 to have a fully composite frame and fork, which can include the core structure (described above) as well as non-metal fittings, such as non-metal threaded water bottle bosses 2604, brake bosses 2608 and 2614, derailleur bosses 2606 and 2608, bottom bracket 2610, dropouts 2608-2609 and 2612, steerer tube threading 2616, and seat post locking mechanism 2602. These components 2602-2622 can be made, at least in part, of carbon fiber and can include no metal fittings, which may oxidize over time. Some or all of the components 2602-2622 can be formed within the foam (e.g., the foam may be expanded around the components 2602-2622) and/or can be bonded to one or more portions of the carbon fiber structure of the bicycle 2600, such as bonding to an external carbon fiber skin layer and/or to an internal carbon fiber truss of the bicycle 2600. An example of such a configuration of a component being formed within foam and bonded to carbon fiber layers of the bicycle 2600 is depicted and described below with regard to FIGS. 27A-B.

The bicycle 2600 also includes one or more hose/cable/wire pathways that are formed within the bicycle 2600 to permit the passage of brake lines 2616-2618 and electrical wires 2620-2622, which can be connected to a battery 2624 and controller that can be used, for example, to provide wireless shifting for the bicycle 2600. The pathways can generally follow any of a variety of routes through the bicycle 2600, and can be defined by reinforced structures (e.g., carbon fiber tubes) that define passageways for hoses, cables, and/or wires. The reinforced structures can, similarly, be defined and formed when the foam is expanded, and can provide for more easy and ready routing of cables, hoses, and/or wires through the bike frame, which may be, at least partially, filled with foam and/or carbon fiber reinforcement structures.

Referring to FIGS. 27A-B, which depict example water bottle mounting boss components 2702 formed in an example bicycle tube 2700 (e.g., down tube, seat tube). FIG. 27A shows a perspective view and FIG. 27B shows a cross-sectional view. The components 2702 can be embedded within a foam layer 2710 and bonded to an external carbon fiber skin 2708 for the tube 2700. The components 2702 can have one or more flange surfaces that expand laterally outward to increase the surface area and support for the bonded region between the components 2702 and the carbon fiber layer 2708. The components 2702 can be positioned in 3D space when the foam 2710 is initially formed, such as through the use of one or more mounting pins or bolts to which the components 2702 can be affixed as the foam 2710 is initially expanded to form a near net shape for the tube 2700. The carbon fiber layer 2708 can then be wrapped around the foam 2710 and bonded to the components 2702, which can provide a more secure and robust mounting structure for items affixed or connected to the tube 2700, such as items held in place by screws 2704 (e.g., water bottle holders, lights, derailleurs). The components 2702 can be formed such that a portion of the component extends upward from the lateral flanges and through the carbon fiber layer 2708, which can permit for the end surface of the component 2702 to be flush with and/or adjacent to the outer surface of the carbon fiber layer 2708. The structure, mounting process, and/or features of the components 2702 can be applied to other components described throughout this documents, such as the components 2602-2622.

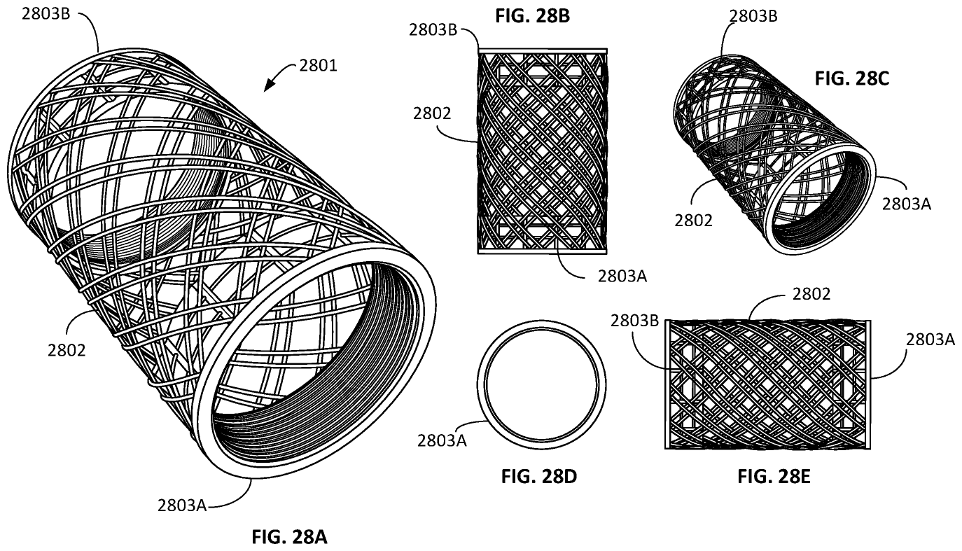

FIGS. 28A-E depict views of an example bottom bracket, such as the bottom bracket 2610 described above with regard to FIG. 26. The example bottom bracket can address the long-standing issue of creaky, ill-fitting press fit bottom brackets. The depicted bottom bracket shell 2801 includes a lattice construction technique that locks in place molded carbon fiber threads 2802. The carbon fiber threads can extend between one or more rings 2803A-B, which may be carbon fiber or another material. In some implementations, the carbon fiber threads can be helically wound, braided, or extend linearly from one ring to another, or a combination of techniques. In some implementations, the carbon fiber strands in the lattice construction have a thickness between 0.5 mm and 3 mm, for example 0.5 mm, 1 mm, 1.5 mm, 2 mm, 2.5 mm, or 3 mm in thickness. In some implementations, the carbon fiber outer wall of a component has a thickness between 0.8 mm and 5 mm, for example 0.8 mm, 1 mm, 1.5 mm, 2 mm, 2.5 mm, 3 mm, 3.5 mm, 4 mm, 4.5 mm, or 5 mm. In some implementations, internal support or truss structures formed of carbon fiber have a thickness between 0.5 mm and 3 mm, for example, 0.5 mm, 1 mm, 1.5 mm, 2 mm, 2.5 mm, or 3 mm. This ultra-strong web-like cylinder can be co-cured into the frame for a unibody construction with immense lateral stiffness. The bottom bracket housing can be used, for example, to provide a threaded bottom bracket and all of its associated benefits without the weight penalty of a traditional bottom bracket housing.

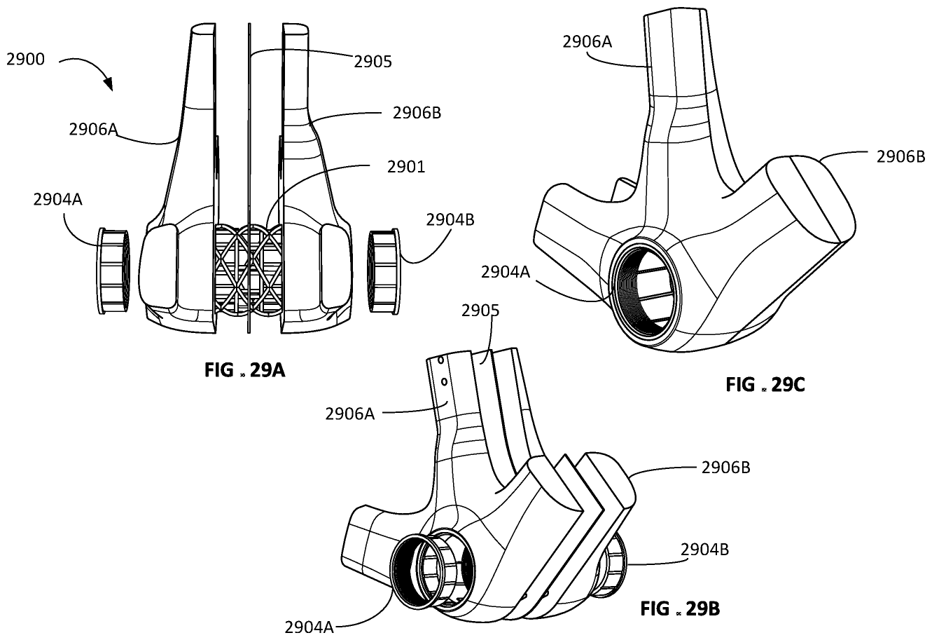

FIGS. 29A-C, 30A-B, 31A-B, 32A-C, 33A-B, 34A-B, 35A-B, 36A-C, 37A-D, 38A-C, and 39A-B, illustrate bicycle components having carbon fiber truss components as described herein. The components are illustrated as foam components and the internal truss structures that can be formed by the wrapping of individual foam segments in carbon fiber (pre-preg) and subsequent curing of the segments together. Any of the foam and carbon fiber components illustrated in the figures can be combined together to form a bicycle, and individual truss structures and configurations of foam and carbon fiber may be desirable for use in a bicycle based on the expected forces on the bicycle components based on the intended or envisioned use of the bicycle.

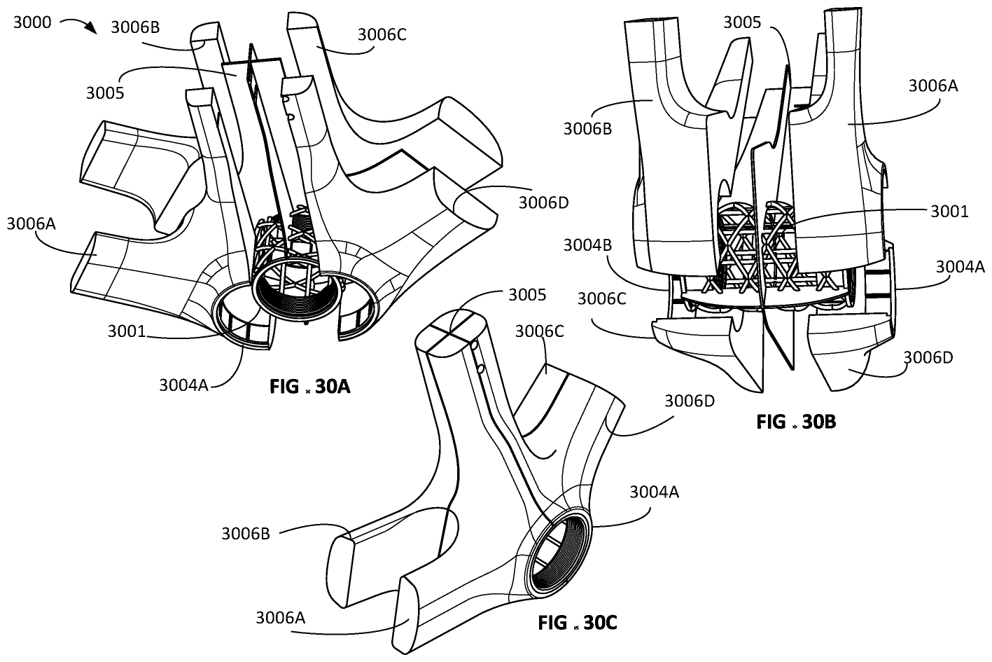

In particular, FIGS. 29A, 29B, and 29C show views of an example bottom bracket component 2900 including the example helical lattice type bottom bracket 2901 as described in FIG. 28. FIGS. 30A, 3B, and 30C show views of another example bottom bracket component including the bottom bracket of FIG. 28. The bottom bracket component 2900 of FIGS. 29A, 29B, and 29C illustrates the incorporation of the helical lattice truss 2901 between the bottom bracket cups 2904A-B by the use of two separate foam sections, which creates a vertical internal carbon fiber truss 2905. The bottom bracket component 3000 of FIGS. 30A, 30B, and 30C illustrates the incorporation of the helical lattice truss 3001 between the bottom bracket cups 3004A-B by the use of four separate foam sections 3006A-D, creating an internal carbon fiber truss 3005 that extends through the component. The bottom bracket of a bicycle can experience large forces due to pedaling the bicycle by the rotating cranks. By incorporating a helical lattice truss 3001 structure to stabilize the bottom bracket cups 3004A-B, the forces are better accommodated and the cups 3004A-B are maintained in alignment.

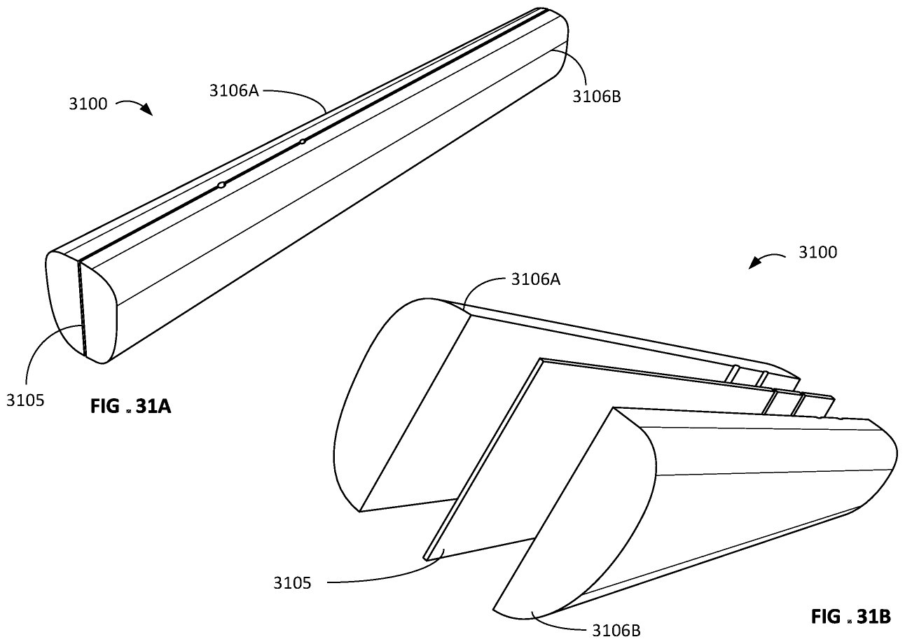

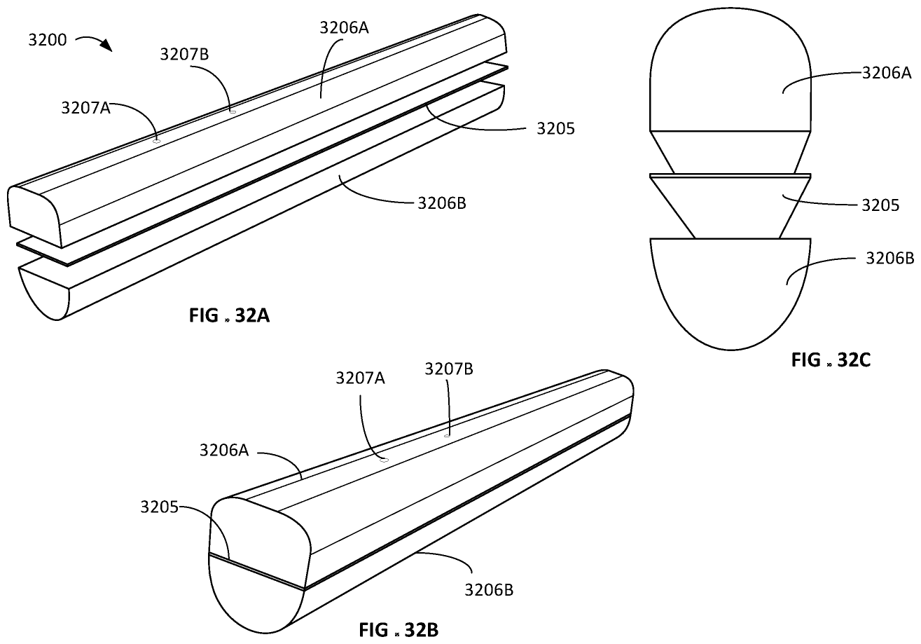

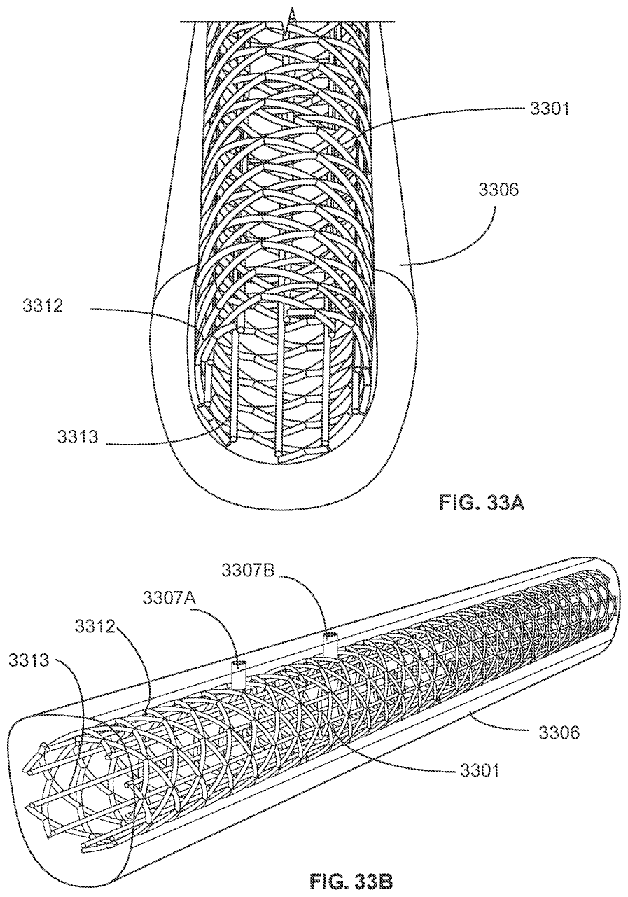

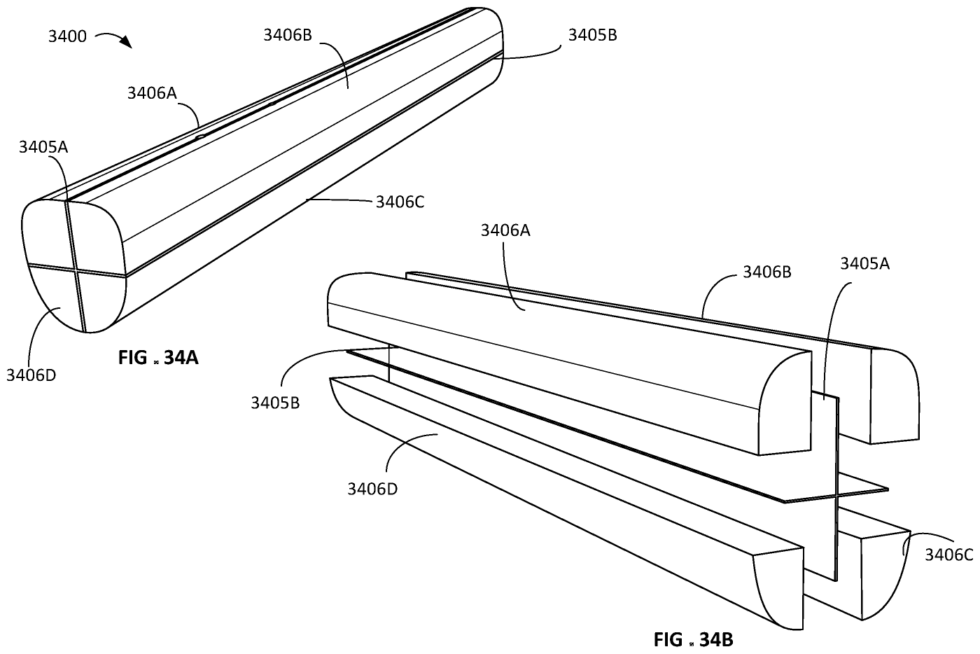

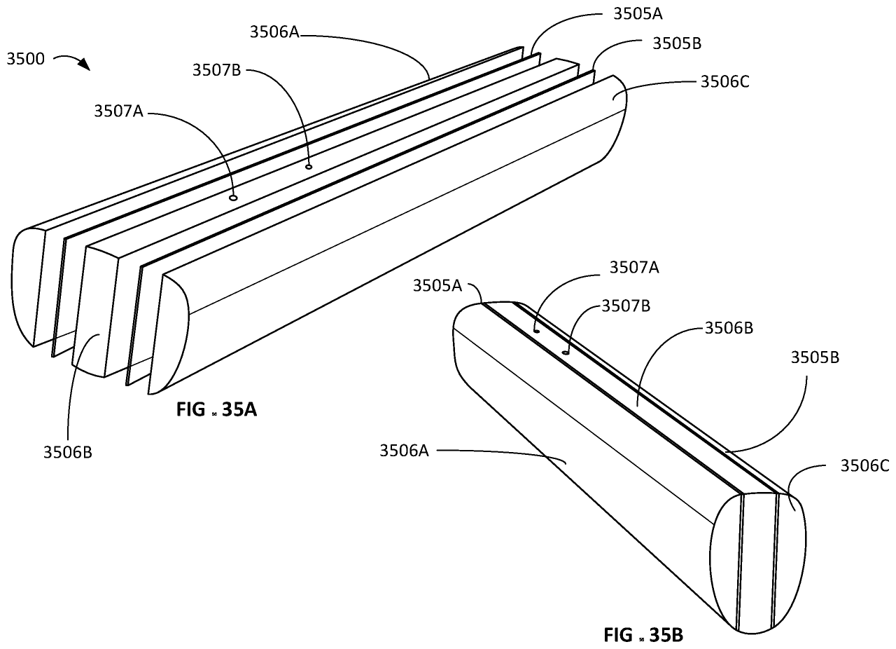

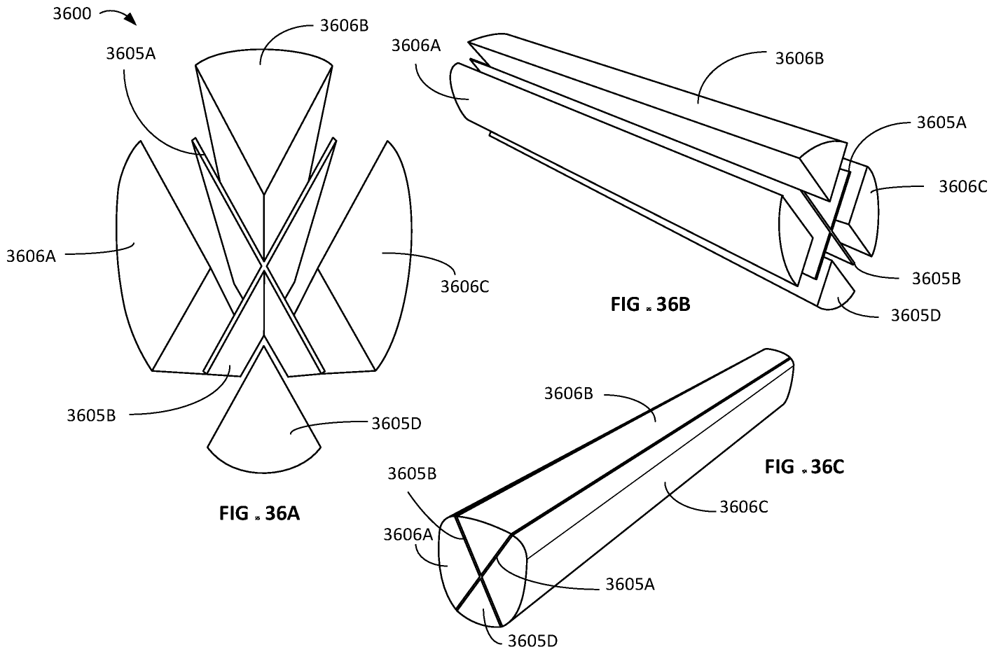

FIGS. 31A-B, 32A-C, 33A-B, 34A-B, 35A-B, and 36A-C illustrate variations in the internal truss structure that can be achieved in a bicycle downtube by segmenting the downtube into multiple segments or sections of foam and wrapping the segments individually before curing together. As described above, each of the illustrated truss structures may be appropriate for particular uses of a bicycle which result in forces and stresses being applied to the downtube. The implementation of a particular internal truss structure can improve the strength of the bicycle downtube and ability to resist fracture, as well as provide adequate damping of vibrations to improve the rider experience. In particular, FIGS. 31A and 31B show views of an example downtube 3100 including a vertical truss 3105 formed between two foam portions 3106A-B. FIGS. 32A, 32B, and 32C show views of an example downtube including a horizontal truss 3205 formed between two foam portions 3206A-B. Apertures 3207A-B are formed through at least one of the foam portions (and would also extend through a carbon fiber shell or skin which is not shown). The apertures 3207A-B can be used to couple additional components or accessories to the downtube. FIGS. 33A and 33B show views of an example downtube including a helical lattice truss 3301 with foam 3306 surrounding the helical lattice truss 3301. FIG. 33A illustrates a helical lattice truss 3301 having long straight threads 3313 that run the length of the helical lattice truss 3301, as well as wrapped helical threads 3312 that connect the long straight threads 3313. In some implementations, the helical lattice truss can be woven or braided using the long straight threads 3313 as ‘warp’ threads with the wrapped helical threads acting as ‘weft’ threads. The straight threads 3312 and wrapped threads 3313 are also visible in FIG. 33B. FIG. 33B also illustrates two apertures 3307A and 3307B which extend through the foam to the helical lattice truss 3301. The apertures 3307A-B can be threaded connector cavities for coupling the downtube to an accessory (e.g., a water bottle cage or hand pump holder). Alternatively or additionally, the apertures 3307A-B can be used to hold the helical lattice truss 3301 in place in the foam during curing. FIGS. 34A and 34B show views of an example downtube 3400 including vertical 3405A and horizontal 3405B trusses formed between four foam portions 3406A-D. FIGS. 35A and 35B show views of an example downtube 3500 including multiple vertical trusses 3505A-B formed between foam portions 3506A-C. Apertures 3507A-B are formed through at least one of the foam portions (and would also extend through a carbon fiber shell or skin which is not shown). The apertures 3507A-B can be used to couple additional components or accessories to the downtube. FIGS. 36A, 36B, and 36C show views of an example downtube 3600 including diagonal trusses 3605A-B formed between foam portions 3606A-D. While each of FIGS. 31A-B, 32A-C, 33A-B, 34A-B, 35A-B, and 36A-C illustrate the truss structure formed between foam portions, the final component may also include a carbon fiber outer shell (not shown) which in some implementations can include one or more lugs or coupling structures which extend through the carbon fiber outer shell.

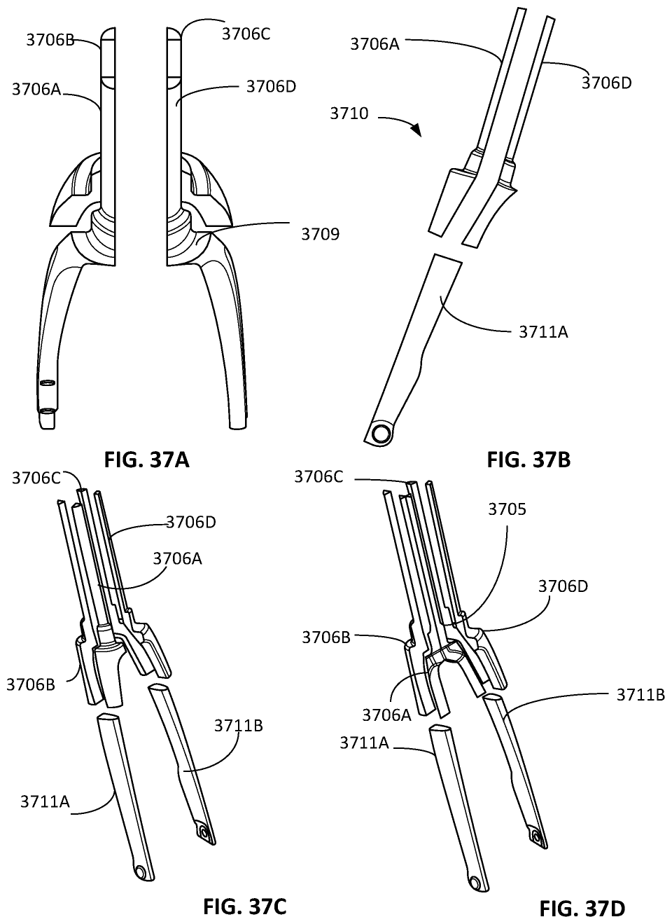

FIGS. 37A, 37B, 37C, and 37D show views of an example steerer tube 3700 formed from four foam components 3706A-D. The resulting internal truss structure 3705, illustrated in FIG. 37D provides additional strength to the steerer tube 3708 and crown 3709 of the fork 3710. As described above, the fork legs 3711A-B (also referred to as blades) can include additional truss structures which are not shown here.

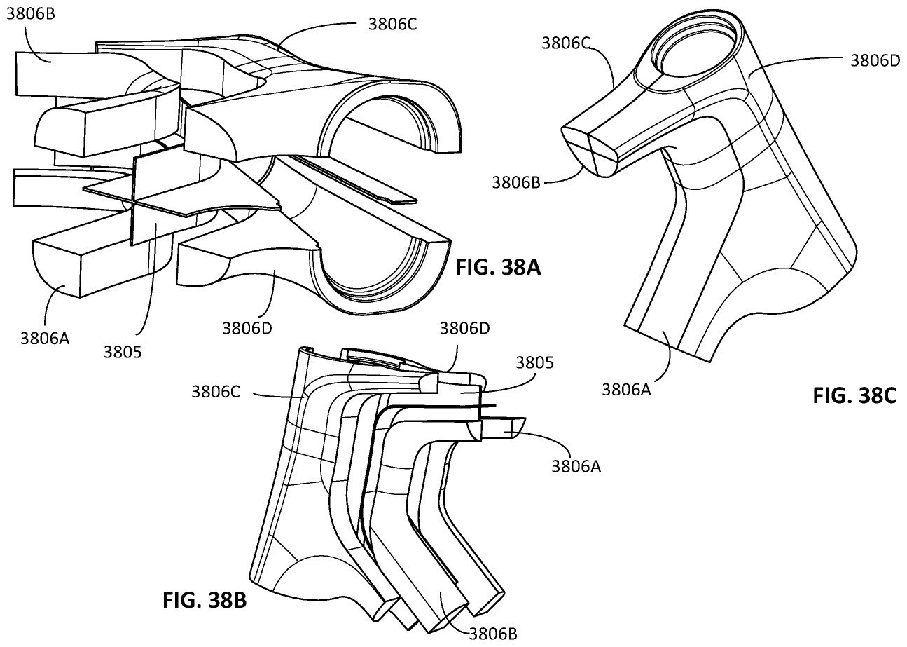

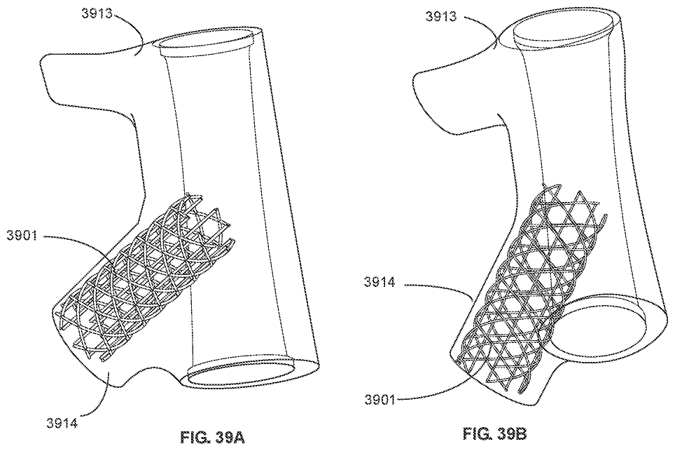

FIGS. 38A-C and FIGS. 39A-B illustrate example truss structures that can be formed in the headtube of the bicycle. In particular, FIGS. 38A, 38B, and 38C show views of an example headtube formed from four foam components 3806A-D and having internal truss structure 3805. FIGS. 39A and 39B show views of an example headtube 3913 including a helical lattice truss 3901 extending toward the downtube 3914. The headtube 13913 of the bicycle can experience particular forces as a result of steering the bicycle by the handlebars and impacting various obstacles in the riding surface. The incorporation of internal truss structures, such as those illustrated in FIGS. 38A-C and 39A-B provide improved strength of the component despite the forces that are incident on the component.

Any of a variety of additional and/or alternate features can be used to produce the reinforced carbon fiber structures. For example, 3D printing of one or more rigid carbon fiber structures (e.g., cured carbon fiber structures) can be performed to generate one or more of the truss or other reinforcement structures within a reinforced carbon fiber structure. For example, a carbon fiber lattice can be 3D printed and added into a mold when an initial foam shape is being generated from unexpanded foam material, similar to the manner in which foam is described as expanding around the conduit in FIG. 2D. For instance, a carbon fiber lattice (or other 3D printed carbon fiber structure) can be inserted into a mold with unexpanded foam material and then, during the first foam expansion event, the foam can expand around, throughout, and envelope the carbon fiber lattice so that it is encased within the foam segment. That foam segment may then be wrapped in carbon fiber and cured to form a reinforced carbon fiber structure by itself, or may be combined with other individual segments (which may or may not also include enclosed lattice structures) that are collectively wrapped in carbon fiber and cured. Any of a variety of different 3D printed carbon fiber structures are also possible and can be used as part of the disclosed innovation.

Any of a variety of additional and/or alternative expansion foam materials can be used to produce the reinforced carbon fiber structure described herein. For example, the expansion foam material can be XENECORE foam. The expansion foam materials that are used can have densities ranging from 1.6-2.8 lbs/ft³, 9.3-12.5 lbs/ft³, 9.4-2.18 lbs/ft³, and 18.7-37.5 lbs/ft³. The expansion foam materials that are used can also have greater or lesser densities. A density can depend on application and/or use of the expansion foam materials, a number of carbon fiber layers that are used, a desired final reinforced carbon fiber structure, and/or a design or arrangement of the expansion foam materials and the carbon fiber layers. The expansion foam materials can also have different thicknesses, ranging from 0.6-0.7 mm, 0.2-0.3 mm, 2.5-3.3 mm, and 4.0-8.0 mm. The expansion foam materials can have one or more different ranges of thickness as described above in reference to the density. The expansion foam materials can also expand at different temperature values. For example, the expansion foam materials can expand within a temperature range of 80-230° C., can have density ranges from 1.2-56.2 lbs/ft³, and can expand by a ratio of up to 100:1. The expansion foam materials can expand within different temperature ranges based on one or more factors, as described above in reference to the density. One or more other factors can influence selection of a type of expansion foam material used, the density, the thickness, and/or the temperature range for expansion.

While this specification contains many specific implementation details, these should not be construed as limitations on the scope of the disclosed innovation or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

### ILLUSTRATIVE EMBODIMENTS

Aspects of the processes, systems, and methods described above may be illustrated in one or more of the following embodiments:

Embodiment 1: A process for manufacturing reinforced carbon fiber structures, the process including forming a plurality of foam substructures, wherein the foam substructures are made of heat expanding foam that is configured to further expand when heated to at least a first threshold temperature; positioning carbon fiber on at least a portion of surfaces of the foam substructures; assembling the plurality of foam substructures with the carbon fiber into a superstructure; wrapping an outer surface of the superstructure with additional carbon fiber to form a wrapped superstructure; and heating the wrapped superstructure to at least the first threshold temperature within a first mold to form a reinforced carbon fiber structure, wherein heating the wrapped superstructure causes the foam substructures to further expand so that the additional carbon fiber adopts and retains a shape of the first mold.

Embodiment 2: The process of embodiment 1, wherein forming the plurality of foam substructures includes cutting an initial foam structure into at least a portion of the plurality of foam substructures.

Embodiment 3: The process of embodiment 1 or 2, wherein forming the plurality of foam substructures further includes heating unexpanded foam material to form the initial foam structure.

Embodiment 4: The process of any of embodiments 1-3, wherein the unexpanded foam material is configured to undergo multiple heat-based expansions when heated to different threshold temperatures, the unexpanded foam material is heated to a second threshold temperature to form the initial foam structure, and the second threshold temperature is different from the first threshold temperature.

Embodiment 5: The process of any of embodiments 1-4, wherein the second threshold temperature is lower than the first threshold temperature.

Embodiment 6: The process of any of embodiments 1-5, wherein the unexpanded foam material includes double expanding foam material.

Embodiment 7: The process of any of embodiments 1-6, wherein the unexpanded foam material is heated within the first mold to form the initial foam structure, and the initial foam structure has a near net shape of the reinforced carbon fiber structure.

Embodiment 8: The process of any of embodiments 1-7, wherein the initial foam structure has less volume than the reinforced carbon fiber structure.

Embodiment 9: The process of any of embodiments 1-8, wherein the initial foam structure is formed in the first mold without the presence of any carbon fiber materials.

Embodiment 10: The process of any of embodiments 1-9, wherein the initial foam structure is formed in the first mold with one or more carbon fiber substructures being included in the first mold.

Embodiment 11: The process of any of embodiments 1-10, wherein the one or more carbon fiber substructures comprise rigid carbon fiber structures configured to retain a three-dimensional shape within first mold as the unexpanded foam material expands around and throughout the three-dimensional shape during expansion of the unexpanded foam material.

Embodiment 12: The process of any of embodiments 1-11, wherein the one or more carbon fiber substructures includes a lattice structure made of carbon fiber.

Embodiment 13: The process of any of embodiments 1-12, wherein the unexpanded foam material is heated within a second mold to form the initial foam structure, the second mold is different from and defines a smaller volume structure than the first mold, and the initial foam structure has a near net shape of the reinforced carbon fiber structure.

Embodiment 14: The process of any of embodiments 1-13, wherein forming the plurality of foam substructures includes separately forming at least a portion of the plurality of foam substructures from one or more second molds that are different from the first mold.

Embodiment 15: The process of any of embodiments 1-14, wherein separately forming the plurality of foam substructures further includes heating unexpanded foam material in the one or more second molds to form the at least a portion of the plurality of foam substructures.

Embodiment 16: The process of any of embodiments 1-15, wherein the unexpanded foam material is configured to undergo multiple heat-based expansions when heated to different threshold temperatures, the unexpanded foam material is heated to a second threshold temperature to form the at least a portion of the plurality of foam substructures, and the second threshold temperature is different from the first threshold temperature.

Embodiment 17: The process of any of embodiments 1-16, wherein the second threshold temperature is lower than the first threshold temperature.

Embodiment 18: The process of any of embodiments 1-17, wherein the unexpanded foam material includes double expanding foam material.

Embodiment 19: The process of any of embodiments 1-18, wherein the at least a portion of the plurality of foam substructures are formed in the one or more second molds without the presence of any carbon fiber materials.

Embodiment 20: The process of any of embodiments 1-19, wherein the at least a portion of the plurality of foam substructures are formed in the one or more second molds with one or more carbon fiber substructures being included in the one or more second molds.

Embodiment 21: The process of any of embodiments 1-20, wherein the one or more carbon fiber substructures comprise rigid carbon fiber structures configured to retain a three-dimensional shape within one or more second molds as the unexpanded foam material expands around and throughout the three-dimensional shape during expansion of the unexpanded foam material.

Embodiment 22: The process of any of embodiments 1-21, wherein the one or more carbon fiber substructures includes a lattice structure made of carbon fiber.

Embodiment 23: The process of any of embodiments 1-22, wherein positioning the carbon fiber on at least the portion of the foam substructures includes wrapping one or more of the foam substructures with the carbon fiber.

Embodiment 24: The process of any of embodiments 1-23, wherein positioning the carbon fiber on at least a portion of the foam substructures includes affixing the carbon fiber to the portion of the surfaces of the foam substructures.

Embodiment 25: The process of any of embodiments 1-24, wherein the carbon fiber is affixed to surfaces of the foam substructures so that, when the foam substructures are assembled into the superstructure, the carbon fiber extends through the superstructure from a first outer surface of the superstructure to a second outer surface of the superstructure.

Embodiment 26: The process of any of embodiments 1-25, wherein the first outer surface of the superstructure is an opposing surface of the second outer surface of the superstructure.

Embodiment 27: The process of any of embodiments 1-26, wherein the plurality of foam substructures are configured to each include one or more mating surfaces that are contoured to mate with one or more surfaces of others of the plurality of foam substructures, and assembling the plurality of foam substructures into the superstructure includes pairing mating surfaces of the plurality of foam substructures with the carbon fiber.

Embodiment 28: The process of any of embodiments 1-28, wherein the carbon fiber is retained between the foam substructures in a particular arrangement, and the particular arrangement of the carbon fiber is retained in and provides, at least in part, reinforcement for the reinforced carbon fiber structure.

Embodiment 29: The process of any of embodiments 1-28, wherein the foam substructures that expanded to form the reinforced carbon fiber structure are retained within the reinforced carbon fiber structure.

Embodiment 30: The process of any of embodiments 1-29, wherein the foam substructures that expanded to form the reinforced carbon fiber structure are configured to provide additional reinforcement for the reinforced carbon fiber structure.

Embodiment 31: The process of any of embodiments 1-30, further including positioning, as part of the assembling of the foam substructures into the superstructure, one or more additional structures within the superstructure.

Embodiment 32: The process of embodiment 31, wherein the one or more additional structures include a tube that defines a channel extending through, at least a part, of the superstructure.

Embodiment 33: The process of embodiment 32, wherein the tube includes a carbon fiber tube.

Embodiment 34: The process of embodiment 33, wherein the carbon fiber tube is rigid and preconfigured before being placed into the superstructure.

Embodiment 35: The process of embodiment 34, wherein the carbon fiber tube is formed by wrapping carbon fiber around a removable media that is configured to be removed from the reinforced carbon fiber structure.

Embodiment 36: The process of any of embodiments 31-35, wherein the one or more additional structures include a wire or a cable.

Embodiment 37: The process of any of embodiments 1-36, wherein at least a portion of the foam substructures include one or more additional structures.

Embodiment 38: The process of embodiment 37, wherein the one or more additional structures include a tube that defines a channel extending through, at least a part, of the foam substructures.

Embodiment 39: The process of embodiment 38, wherein the tube includes a carbon fiber tube.

Embodiment 40: The process of embodiment 39, wherein the carbon fiber tube is rigid and preconfigured before being placed into the foam substructures.

Embodiment 41: The process of embodiment 38 or 39, wherein the carbon fiber tube is formed by wrapping carbon fiber around a removable media that is configured to be removed from the reinforced carbon fiber structure.

Embodiment 42: The process of any of embodiments 1-41, wherein the reinforced carbon fiber structure includes at least a portion of a sporting equipment product.

Embodiment 43: The process of embodiment 42, wherein the sporting equipment product includes a bike and the reinforced carbon fiber structure includes a component of the bike.

Embodiment 44: The process of any of embodiments 1-43, wherein the reinforced carbon fiber structure includes a component of an automobile, an airplane, or another motorized vehicle.

Embodiment 45: A process for manufacturing reinforced carbon fiber structures to include one or more embedded structures, the process including forming a foam structure that includes an embedded structure that extends, at least partially, though the foam structure, wherein the foam structure is made of heat expanding foam that is configured to further expand when heated to at least a first threshold temperature; wrapping an outer surface of the foam structure with carbon fiber to form a wrapped foam structure; and heating the wrapped foam structure to at least the first threshold temperature within a first mold to form a reinforced carbon fiber structure, wherein heating the wrapped foam structure causes the foam structure to further expand so that the carbon fiber adopts and retains a shape of the first mold.

Embodiment 46: The process of embodiment 45, wherein forming the foam structure includes positioning the embedded structure in a particular arrangement in three-dimensional space using one or more positioning structures; positioning unexpanded foam material around the embedded structure and the one or more positioning structures; and heating the unexpanded foam material to form the foam structure.

Embodiment 47: The process of embodiment 46, wherein the unexpanded foam material is configured to undergo multiple heat-based expansions when heated to different threshold temperatures, the unexpanded foam material is heated to a second threshold temperature to form the initial foam structure, and the second threshold temperature is different from the first threshold temperature.

Embodiment 48: The process of embodiment 47, wherein the second threshold temperature is lower than the first threshold temperature.

Embodiment 49: The process of any of embodiments 46-48, wherein the unexpanded foam material includes double expanding foam material.

Embodiment 50: The process of any of embodiments 45-49, wherein the embedded structure is positioned in the particular arrangement in the first mold; the unexpanded foam material is positioned around the embedded structure and the one or more positioning structures in the first mold; and the unexpanded foam material is heated within the first mold to form the foam structure.

Embodiment 51: The process of embodiment 50, wherein the foam structure has a near net shape of the reinforced carbon fiber structure.

Embodiment 52: The process of any of embodiments 45-51, wherein the foam structure has less volume than the reinforced carbon fiber structure.

Embodiment 53: The process of any of embodiments 45-51, wherein the embedded structure is positioned in the particular arrangement in a second mold, wherein the second mold is different from and defines a smaller volume than the first mold; the unexpanded foam material is positioned around the embedded structure and the one or more positioning structures in the second mold; and the unexpanded foam material is heated within the second mold to form the foam structure.

Embodiment 54: The process of embodiment 53, wherein the foam structure has a near net shape of the reinforced carbon fiber structure.

Embodiment 55: The process of any of embodiments 45-54, wherein the one or more positioning structures comprise one or more stands that are configured to retain the embedded structure in the particular arrangement during expansion of the unexpanded foam material.

Embodiment 56: The process of any of embodiments 46-55, wherein the particular arrangement includes the embedded structure being spaced apart from one or more outer surfaces of the foam structure.

Embodiment 57: The process of embodiment 55, wherein the one or more stands are made of carbon fiber.

Embodiment 58: The process of any of embodiments 45-57, wherein the embedded structure includes a tube that defines a channel extending through, at least a part, of the foam structure.

Embodiment 59: The process of embodiment 58, wherein the tube includes a carbon fiber tube.

Embodiment 60: The process of embodiment 59, wherein the carbon fiber tube is rigid and preconfigured before being placed into the foam structures.

Embodiment 61: The process of embodiment 58 or 59, wherein the carbon fiber tube is formed by wrapping carbon fiber around a removable media that is configured to be removed from the foam structure.

Embodiment 62: The process of any of embodiments 45-61, wherein the reinforced carbon fiber structure includes at least a portion of a sporting equipment product.

Embodiment 63: The process of embodiment 62, wherein the sporting equipment product includes a bike and the reinforced carbon fiber structure includes a component of the bike.

Embodiment 64: The process of any of embodiments 45-61, wherein the reinforced carbon fiber structure includes a component of an automobile, an airplane, or another motorized vehicle.

Embodiment 65: A reinforced carbon fiber structure providing additional reinforcement against external forces, the structure including an outer carbon fiber housing with one or more carbon fiber walls that enclose an interior volume, the carbon fiber walls including outer surfaces and inner surfaces that define the interior volume; one or more carbon fiber trusses that are positioned within the interior volume, wherein each of the carbon fiber trusses is connected to one or more of the interior surfaces of the carbon fiber walls and extend through at least a portion of the interior volume; and one or more foam segments that fill the interior volume and that are positioned between the inner surfaces of the carbon fiber walls and the carbon fiber trusses.

Embodiment 66: The reinforced carbon fiber structure of embodiment 65, wherein the foam segments are made of foam configured to undergo multiple heat-based expansions when heated to different threshold temperatures.

Embodiment 67: The reinforced carbon fiber structure of embodiment 65 or 66, wherein the foam includes double expanding foam.

Embodiment 68: The reinforced carbon fiber structure of any of embodiments 65-67, wherein the outer carbon fiber housing has a longitudinal dimension that is greater than a lateral dimension, and at least a portion of the carbon fiber trusses comprise one or more lateral carbon fiber trusses that extend between the interior surfaces along the lateral dimension.

Embodiment 69: The reinforced carbon fiber structure of embodiment 68, wherein the one or more lateral carbon fiber trusses include a plurality of lateral carbon fiber trusses that are spaced apart along the longitudinal dimension.

Embodiment 70: The reinforced carbon fiber structure of any of embodiments 65-69, wherein the outer carbon fiber housing has a longitudinal dimension that is greater than a lateral dimension, and at least a portion of the carbon fiber trusses comprise one or more longitudinal carbon fiber trusses that extend between the interior surfaces along the longitudinal dimension.

Embodiment 71: The reinforced carbon fiber structure of embodiment 70, wherein the one or more longitudinal carbon fiber trusses include a plurality of longitudinal carbon fiber trusses that are spaced apart along the lateral dimension.

Embodiment 72: The reinforced carbon fiber structure of embodiment 70, wherein the one or more longitudinal carbon fiber trusses include a plurality of longitudinal carbon fiber trusses that each connect to one or more of the interior surfaces and to one or more others of the plurality of longitudinal carbon fiber trusses.

Embodiment 73: The reinforced carbon fiber structure of embodiment 72, wherein the plurality of longitudinal carbon fiber trusses connect to each other at or near a lateral center point along the lateral dimension.

Embodiment 74: The reinforced carbon fiber structure of embodiment 72 or 73, wherein at least one of the plurality of longitudinal carbon fiber trusses includes an aperture through a surface of the longitudinal carbon fiber truss.

Embodiment 75: The reinforced carbon fiber structure of embodiment 74, wherein the one or more foam segments that fill the interior volume extend through the at least one aperture.

Embodiment 76: The reinforced carbon fiber structure of any of embodiments 70-75, wherein the one or more longitudinal carbon fiber trusses are formed by the foam segments each being wrapped by carbon fiber about the longitudinal dimension and the foam segments being combined within the outer carbon fiber housing.

Embodiment 77: A method for manufacturing reinforced carbon fiber structures having one or more embedded support structures, the method including forming a carbon fiber support structure by curing carbon fiber within a mold; forming a foam structure that includes the carbon fiber support structure that extends, at least partially, though the foam structure, wherein the foam structure is made of heat expanding foam that is configured to further expand when heated to at least a first threshold temperature; wrapping an outer surface of the foam structure with carbon fiber wrapping to form a wrapped foam structure; and heating the wrapped foam structure to at least the first threshold temperature within a first mold to form a reinforced carbon fiber structure, wherein heating the wrapped foam structure causes the foam structure to expand so that the carbon fiber adopts and retains a shape of the first mold.

Embodiment 78: The method of embodiment 77, further including heating the foam structure to a second threshold temperature within a second mold prior to the wrapping step.

Embodiment 79: The method of embodiment 77 or 78, further including removing a portion of the foam structure covering an edge of the carbon fiber support structure to expose the edge of the carbon fiber support structure at an outer surface of the foam structure, wherein exposing the carbon fiber support structure causes the carbon fiber wrapping to contact the edge of the carbon fiber support structure.

Embodiment 80: The method of embodiment 79, further including depositing a material over the exposed edge of the carbon fiber support structure prior to the wrapping step.

Embodiment 81: The method of embodiment 80, wherein the material is pre-cured carbon fiber.

Embodiment 82: The method of any of embodiments 77-81, wherein forming the carbon fiber support structure further includes placing pre-cured carbon material into a mold; heating the mold to a desired temperature for a predetermined amount of time; and removing the carbon material from the mold.

Embodiment 83: The method of embodiment 82, the method further including cutting the carbon fiber support structure to a desired length and/or size.

Embodiment 84: The method of embodiment 82 or 83, wherein forming the carbon fiber support structure further includes forming one or more support trusses extending from a meeting point.

Embodiment 85: The method of any of embodiments 84, wherein forming the foam structure includes depositing foam about the one or more support trusses to form a substantially cylindrical structure.

Embodiment 86: The method of embodiment 84 or 85, wherein forming the foam structure further includes positioning the one or more support trusses to extend longitudinally through the foam structure.

Embodiment 87: The method of any of embodiments 84-86, further including forming at least one aperture through at least one of the support trusses of the carbon fiber support structure.

Embodiment 88: The method of embodiment 87, wherein forming the foam structure further includes placing foam through the at least one aperture.

Embodiment 89: The method of any of embodiments 77-88, further including inserting a conduit adjacent to the carbon fiber support structure prior to forming the foam structure, wherein the inserted conduit preserve a channel through the foam structure.

Embodiment 90: The method of embodiment 89, wherein the conduit is formed from one of a carbon fiber conduit, a silicon tube, or a hard conduit of another material.

Embodiment 91: The method of any of embodiments 77-90, further including exposing a portion of foam at a first end of the reinforced carbon fiber structure, and removing foam from a second end of the reinforced carbon fiber structure to form a cavity, the exposed portion of foam and cavity enabling coupling of the reinforced carbon fiber structure with another structure.

Embodiment 92: A method of joining first and second reinforced carbon fiber structures, the method including exposing a foam outer surface at a first male end of the first reinforced carbon fiber structure; providing a cavity at a first female end of the second reinforced carbon fiber structure, the cavity sized to receive the first male end of the first reinforced carbon fiber structure; inserting the first male end of the first reinforced carbon fiber structure into the first female end of the second reinforced carbon fiber structure, the exposed foam outer surface substantially enclosed within the cavity; heating at least a joining region of the first reinforced carbon fiber structure and the second reinforced carbon fiber structure to a predetermined temperature for a predetermined period of time, the heating causing the foam outer surface at the first male end to expand within the cavity.

Embodiment 93: The method of embodiment 92, further including covering the exposed foam outer surface at the first male end in carbon fiber before the inserting step, wherein the heating step causes the foam outer surface at the first male end to expand, forcing the carbon fiber into contact with an internal wall of the cavity.

Embodiment 94: The method of embodiment 92 or 93, wherein the predetermined temperature is sufficient to expand the foam outer surface and to cure the carbon fiber to provide a bond between the first reinforced carbon fiber structure and the second reinforced carbon fiber structure.

Embodiment 95: The method of any of embodiments 92-94, further including covering an exposed portion of a first internal support structure of the first reinforced carbon fiber structure with carbon fiber; and positioning the exposed first internal support structure adjacent to a second internal support structure of the second reinforced carbon fiber structure, wherein the exposed first internal support structure extends into the cavity and adjacent the second internal support structure when the first female end of the first reinforced carbon fiber structure is inserted into the first male end of the second reinforced carbon fiber structure.

Embodiment 96: A reinforced carbon fiber structure, the structure including an outer carbon fiber housing with one or more carbon fiber walls that enclose an interior volume, the carbon fiber walls including outer surfaces and inner surfaces that define the interior volume; a plurality of carbon fiber trusses positioned within the interior volume, wherein each of the carbon fiber trusses is connected to one or more of the inner surfaces of the carbon fiber walls and extend longitudinally through at least a portion of the interior volume; and one or more foam segments positioned within the interior volume between the inner surfaces of the carbon fiber walls and the carbon fiber trusses.

Embodiment 97: The reinforced carbon fiber structure of embodiment 96, further including at least one aperture formed through at least one of the plurality of carbon fiber trusses.

Embodiment 98: The reinforced carbon fiber structure of embodiment 97, wherein a foam segments extends through the at least one apertures.

Embodiment 99: The reinforced carbon fiber structure of any of embodiments 96-98, wherein at least a portion of the outer carbon fiber housing is substantially cylindrical.

Embodiment 100: The reinforced carbon fiber structure of any of embodiments 96-99, wherein the plurality of carbon fiber trusses are arranged such that at least two carbon fiber trusses are perpendicular to each other.

Embodiment 101: The reinforced carbon fiber structure of any of embodiments 96-100, wherein a first width of a first carbon fiber truss where the first carbon fiber truss is connected to an inner surface is greater than a second width of a second carbon fiber truss where the second carbon fiber truss is connected to the inner surface.

Embodiment 102: The reinforced carbon fiber structure of any of embodiments 92-101, wherein the reinforced carbon fiber structure includes a component of an automobile, an airplane, or another motorized vehicle.

Embodiment 103: The reinforced carbon fiber structure of any of embodiments 92-101, wherein the reinforced carbon fiber structure includes at least a portion of a sporting equipment product.

Embodiment 104: The reinforced carbon fiber structure of embodiment 103, wherein the sporting equipment product includes a bike and the reinforced carbon fiber structure includes a component of the bike.

Embodiment 105: The reinforced carbon fiber structure of embodiment 104, wherein the component of the bike includes one of a head tube, a down tube, a top tube, a headset, a bottom bracket, a chain stay, a fork, or a steerer tube.

Embodiment 106: A method for manufacturing a reinforced carbon fiber bicycle frame, the method including producing one or more bicycle components having an outer carbon fiber housing defining an interior volume and at least one carbon fiber trusses positioned within the interior volume, wherein at least one foam segment is positioned within the interior volume between inner surfaces of the carbon fiber housing and the carbon fiber trusses; assembling the one or more bicycle components together to form the frame; and heating at least one joint between the one or more bicycle components to bond the one or more bicycle components together.

Embodiment 107: The method of embodiment 106, wherein producing the one or more bicycle components further includes establishing a channel through the bicycle components by inserting a conduit adjacent to at least a portion of the at least one carbon fiber trusses to preserve a passage through the at least one foam segment.

Embodiment 108: The method of embodiment 106 or 107, further including coupling a first channel of a first component to a second channel of a second component.

Embodiment 109: The method of embodiment 108, further including routing wire or cable through the first channel and the second channel.

Embodiment 110: The method of any of embodiments 106-109, wherein producing the one or more bicycle components further includes forming a substructure of carbon fiber trusses;

depositing foam surrounding the substructure of carbon fiber trusses to form a foam structure;

placing the foam structure into a first mold; heating the foam within the first mold to a first predetermined temperature, the heating to the first predetermined temperature causing the foam to expand to retain the shape of the first mold; removing a portion of the expanded foam to expose at least one edge of the substructure of carbon fiber trusses; wrapping the expanded foam structure in a carbon fiber wrapping, the carbon fiber wrapping in contact with the at least one edge of the substructure of carbon fiber trusses; placing the carbon fiber wrapped structure into a second mold; and heating the carbon fiber wrapped structure within the second mold to a second predetermined temperature, the heating to the second predetermined temperature causing a second expansion of the foam to force the carbon fiber wrapping to take the shape of the second mold.

Embodiment 111: The method of any of embodiments 106-110, wherein a first component of the one or more bicycle components is a bicycle fork.

Embodiment 112: The method of embodiment 111, wherein forming a substructure of carbon fiber trusses of the bicycle fork includes forming a substructure of carbon fiber trusses including a steerer tube substructure formed from four longitudinal trusses connected at a center point and a leg substructure formed as a first truss forming a horseshoe shape with a second truss extending perpendicularly from the first truss at a center line of the first truss on an exterior surface of the horseshoe shape, wherein the steerer tube substructure and the two leg substructures are connected at a shoulder.

Embodiment 113: The method of embodiment 112, wherein the steerer tube substructure and the two leg substructures are formed as separate structures and are bonded together before the depositing step.

Embodiment 114: The method of embodiment 112, wherein the steerer tube substructure and the two leg substructures are formed as a unitary structure using a mold.

Embodiment 115: The method of embodiment 110, wherein a first component of the one or more bicycle components is one of a top tube, down tube, or head tube.

Embodiment 116: The method of embodiment 115, wherein forming a substructure of carbon fiber trusses includes forming a substructure of carbon fiber trusses formed from two vertically oriented trusses and two horizontally oriented trusses connected at a center point.

Embodiment 117: The method of embodiment 116, further including forming at least one aperture in at least one of the two vertically oriented trusses or two horizontally oriented trusses.

Embodiment 118: The method of embodiment 116, further including forming a plurality of apertures along the length of at least one of the two vertically oriented trusses or two horizontally oriented trusses.

Embodiment 119: A method of forming a reinforced carbon fiber structure including forming a first structure from an expandable foam; separating the first structure into a plurality of foam substructures; wrapping each of the plurality of foam substructures in a carbon fiber material;

positioning the plurality of wrapped foam substructures relative to one another as in the first structure; and curing the plurality of wrapped foam substructures together.

Embodiment 120: The method of embodiment 119, wherein forming the first structure from the expandable foam further includes placing the expandable foam into a mold; and heating the expandable foam within the mold.

Embodiment 121: The method of embodiment 119 or 120, wherein internal trusses are formed at locations where the wrapped carbon fiber material of first and second substructures are in contact.

Embodiment 122: The method of any of embodiments 119-121, wherein the reinforced carbon fiber structure is a component of a bicycle.

Embodiment 123: The method of embodiment 122, wherein the component is one of a steerer tube, a top tube, a downtube, a headtube, a fork, a bottom bracket, a seatpost, and a chain stay.

Embodiment 124: The method of embodiment 122 or 123 wherein the component is a bottom bracket incorporating a helically shaped truss structure.

Embodiment 125: The method of embodiment 124, wherein the first foam structure is a bottom bracket structure, the bottom bracket structure is separated into at least two foam structures, and the helically shaped truss structure is incorporated horizontally through the two foam structures prior to curing to form a truss structure.

Embodiment 126: The method of embodiment 125, wherein the bottom bracket structure is separated vertically into two foam structures, and the truss structure is a vertical truss structure.

Embodiment 127: The method of embodiment 125, wherein the bottom bracket structure is separated into four foam structures by quartering the structure vertically and horizontally, and the truss structure is a vertical truss structure and a horizontal truss structure.

Embodiment 128: The method of embodiment 123 wherein the component is a downtube.

Embodiment 129: The method of embodiment 128, wherein the first foam structure is a downtube structure, the downtube structure is separated into at least two foam structures prior to curing to form a truss structure.

Embodiment 130: The method of embodiment 129, wherein the downtube structure is separated vertically into two foam structures, and the truss structure is a vertical truss structure.

Embodiment 131: The method of embodiment 129, wherein the downtube structure is separated horizontally into two foam structures, and the truss structure is a horizontal truss structure.

Embodiment 132: The method of embodiment 129, wherein the downtube structure incorporates a helically shaped truss structure.

Embodiment 133: The method of embodiment 129, wherein the downtube structure is separated into four foam structures by quartering the structure vertically and horizontally, and the truss structure is a vertical truss structure and a horizontal truss structure.

Embodiment 134: The method of embodiment 129, wherein the downtube structure is vertically separated into three foam structures, and the truss structure is a first vertical truss structure and a second vertical truss structure.

Embodiment 135: The method of embodiment 129, wherein the downtube structure is separated into four foam structures by diagonally separating the downtube structure into quarters, and the truss structure is a first diagonal truss structure and a second diagonal truss structure.

Embodiment 136: The method of embodiment 123, wherein the component is a fork including a steerer tube and two blades.

Embodiment 137: The method of embodiment 136, wherein the first foam structure is a fork structure, the fork structure is separated into at least two foam structures prior to curing to form a truss structure.

Embodiment 138: The method of embodiment 137, wherein the fork structure is separated into first and second blade structures and a steerer tube structure, the steerer tube structure being vertically separated into four foam structures, and the truss structure of the steerer tube is a first vertical truss structure and a second vertical truss structure.

Embodiment 139: The method of embodiment 138, wherein the first vertical truss structure and the second vertical truss structure intersect at a line through a center of the steerer tube structure, and the steerer tube structure includes a coupling cavity formed at a first end of the first vertical truss structure and the second vertical truss structure.

Embodiment 140: The method of embodiment 123, wherein the component is a headtube.

Embodiment 141: The method of embodiment 140, wherein the first foam structure is a headtube structure, the headtube structure is separated into at least two foam structures prior to curing to form a truss structure.

Embodiment 142: The method of embodiment 141, wherein the headtube is vertically separated into two foam structures, and the truss structure is a vertical truss structure.

Embodiment 143: The method of embodiment 141, wherein the headtube is separated into four foam structures by quartering the structure vertically and horizontally, and the truss structure is a vertical truss structure and a horizontal truss structure.

Embodiment 144: The method of embodiment 141, wherein the headtube incorporates a helically shaped truss structure.

Embodiment 145: The method of any of embodiments 123-144, further including assembling one or more components into a bicycle.

1-19. (canceled)

20. A process for manufacturing reinforced carbon fiber structures, the process comprising:
forming a plurality of foam substructures, wherein the foam substructures are made of heat expanding foam that is configured to further expand when heated to at least a first threshold temperature;
positioning carbon fiber on at least a portion of surfaces of the foam substructures;
assembling the plurality of foam substructures with the carbon fiber into a superstructure;
wrapping an outer surface of the superstructure with additional carbon fiber to form a wrapped superstructure; and
heating the wrapped superstructure to at least the first threshold temperature within a first mold to form a reinforced carbon fiber structure, wherein heating the wrapped superstructure causes the foam substructures to further expand so that the additional carbon fiber adopts and retains a shape of the first mold.

21. The process of claim 20, wherein forming the plurality of foam substructures comprises cutting an initial foam structure into at least a portion of the plurality of foam substructures.

22. The process of claim 21, wherein forming the plurality of foam substructures further comprises heating unexpanded foam material to form the initial foam structure.

23. The process of claim 20, wherein positioning carbon fiber on at least a portion of surface of the foam substructures further comprises wrapping the foam substructures in carbon fiber.

24. The process of claim 23, wherein the carbon fiber is affixed to surfaces of the foam substructures so that, when the foam substructures are assembled into the superstructure, the carbon fiber extends through the superstructure from a first outer surface of the superstructure to a second outer surface of the superstructure.

25. The process of claim 20, wherein:
the unexpanded foam material is configured to undergo multiple heat-based expansions when heated to different threshold temperatures,
the unexpanded foam material is heated to a second threshold temperature to form the initial foam structure, and
the second threshold temperature is different from the first threshold temperature.

26. The process of claim 20, wherein the initial foam structure is formed in the first mold with one or more carbon fiber substructures being included in the first mold.

27. The process of claim 26, wherein the one or more carbon fiber substructures comprise rigid carbon fiber structures configured to retain a three-dimensional shape within first mold as the unexpanded foam material expands around and throughout the three-dimensional shape during expansion of the unexpanded foam material.

28. The process of claim 26, wherein the one or more carbon fiber substructures comprises one of a lattice structure made of carbon fiber, a tube defining a channel, and a threaded cavity.

29. The process of claim 28, further comprising assembling a plurality of reinforced carbon fiber structures to form a bicycle frame, wherein each of the plurality of reinforced carbon fiber structures comprises a component of the bicycle frame.

30. The process of claim 29, further comprising forming a steerer tube component by forming four foam substructures each extending a vertical length of the steerer tube and forming a carbon fiber truss structure between the four foam substructures after curing.

31. The process of claim 29, further comprising forming a bottom bracket component by assembling one or more foam substructures about a helical lattice structure positioned between two bottom bracket cups prior to wrapping in carbon fiber and curing.

32. The process of claim 29, further comprising forming a downtube component by assembling at least two foam substructures to form a carbon fiber truss structure between the at least two foam substructures, the carbon fiber truss structure extending through the downtube.

33. The process of claim 39, further comprising forming a lug or threaded cavity in the component, the lug or threaded cavity through at least a portion of the superstructure and protruding through the carbon fiber outer surface.
